(19) United States
(12) Patent Application Publication
(10) Pub. No.: US 2015/0026112 A1
(43) Pub. Date: Jan. 22, 2015

(54) Renormalization-Related deployment of a quantum representation for tracking measurable indications generated by test subjects while contextualizing propositions

(71) Applicant: Invent.ly LLC, Woodside, CA (US)

(72) Inventors: Marek Alboszta, Montara, CA (US); Stephen J. Brown, Woodside, CA (US); Hector H. Gonzalez-Banos, Mountain View, CA (US)

(21) Appl. No.: 14/504,435

(22) Filed: Oct. 2, 2014

(51) Int. Cl. G06N 5/04; G06N 99/00

(52) U.S. Cl. CPC G06N 5/04; G06N 99/002
USPC 706/46

(57) ABSTRACT

The present invention concerns methods and apparatus for determining when it is appropriate to apply a quantum representation to contextualizations of propositions about items as experienced by test subjects. The methods and apparatus also indicate when classical representations are appropriate and under what conditions views of the observed effects or measurable indications are to be modified. Renormalization-related ordering of test subjects along a real scale parameter W and their confinement to a range ΔW of scale values Wᵢ within which the quantum representation can be presumed to be within a range of validity are introduced. The ordering and other renormalization-inspired concepts are used to define important parameters of the representations including first and second-order phase transitions to enhance the application of quantum or classical representations and/or views to be presented to an observer.

of

### RELATED APPLICATIONS

This application is related to U.S. patent application Ser. No. 14/182,281 entitled “Method and Apparatus for Predicting Subject Responses to a Proposition based on a Quantum Representation of the Subject's Internal State and of the Proposition”, filed on Feb. 17, 2014, and to U.S. patent application Ser. No. 14/224,041 entitled “Method and Apparatus for Predicting Joint Quantum States of Subjects modulo an Underlying Proposition based on a Quantum Representation”, filed on Mar. 24, 2014, as well as U.S. patent application Ser. No. 14/324,127 entitled “Quantum State Dynamics in a Community of Subjects assigned Quantum States modulo a Proposition perceived in a Social Value Context”, filed on Jul. 4, 2014 all three of which are incorporated herein by reference in their entirety.

### FIELD OF THE INVENTION

The present invention relates to a method and an apparatus for determining when to deploy a quantum representation in tracking measurable indications that are generated by test subjects as they confront and react to underlying propositions that can be apprehended by them in differing contextualizations. Deployment is based on a renormalization consideration that establishes a range of validity of the quantum representation by using a real scale parameter W and a range ΔW of scale values W₁ associated with the test subjects experiencing the contextualizations.

### BACKGROUND OF THE INVENTION

1. Preliminary Overview

Fundamental and new insights into the workings of nature at micro-scale were captured by quantum mechanics over a century ago. The realizations derived from these insights have forced several drastic revisions to our picture of reality at that scale. A particularly difficult to accept adjustment had to do with quantum's inherently statistical description of events. Many preceding centuries of progress rooted in logical and positivist extensions of the ideas of materialism had biased the human mind against theories that did not offer simple rules for categorizing and quantifying observables. Thus, strong notions about the existence of as-yet-undiscovered and more fundamental fully predictive description(s) of microscopic phenomena are hard to relinquish. Especially when abandoning them in favor of quantum's statistical model for the emergence of fact.

It was not surprising that the empirically driven transition from classical to quantum thinking has provoked strong reactions among numerous groups. Many have spent considerable effort in unsuccessful attempts to attribute the statistical nature of quantum mechanics to its incompleteness. Others still attempt to interpret or reconcile it with entrenched classical intuitions rooted in Newtonian physics. However, the deep desire to contextualize quantum mechanics within a larger and more “intuitive” or even quasi-classical framework has resulted in few works of practical significance.

Meanwhile, quantum mechanics continues to exhibit exceptional levels of agreement with measurable aspects of reality. Its explanatory power within legitimately applicable realms remains unchallenged as it continues to defy all struggles at a classical reinterpretation. Today, quantum mechanics and the consequent quantum theory of fields (its extension and partial integration with relativity theory) have proven to be humanity's best fundamental theories of nature. Sub-atomic, atomic and many molecular phenomena are now studied based on quantum or at least quasi-quantum models.

In a radical departure from classical assumption of perpetually existing and measurable quantities, quantum representation of reality posits new entities called wavefunctions or state vectors. These unobservable components of the new model of reality are prior to the emergence of measured quantities or facts. More precisely, state vectors are related to distributions of probabilities for observing any one of a range of possible experimental results. A telltale sign of the “non-physical” status of a state vector is captured in the language of mathematics, where typical state vectors are expressed as imaginary-valued objects. Further, the space spanned by such state vectors is not classical (i.e., it is not our familiar Euclidean space or even any classical configuration space such as phase space). Instead, state vectors inhabit a Hilbert space of square-integrable functions.

Given that state vectors represent complex probability amplitudes, it is somewhat uncanny that their behavior is rather easily reconciled with previously developed physics formalisms. Indeed, after some revisions the tools of Lagrangian and Hamiltonian mechanics as well as many long-standing physical principles, such as the Principle of Least Action, are found to apply directly to state vectors and their evolution. The stark difference, of course, is that state vectors themselves represent relative propensities for observing certain measurable values associated with the objects of study, rather than these measurable quantities themselves. In other words, whereas the classical formulations, including Hamiltonian or Lagrangian mechanics, were originally devised to describe the evolution of “real” entities, their quantum mechanical equivalents apply to the evolution of probability amplitudes in a “pre-emerged reality”. Apart from that jarring fact, when left unobserved the state vectors prove to be rather well-behaved. Their continuous and unitary evolution in Hilbert space is not entirely unlike propagation of real waves in plain Euclidean space. Thus, some of our intuitions about classical wave mechanics are useful in grasping the behavior of quantum waves.

Of course, our intuitive notions about wave mechanics ultimately break down because quantum waves are not physical waves. This becomes especially clear when considering superpositions of two or more such complex-valued objects. In fact, considering such superpositions helps to bring out several unexpected aspects of quantum mechanics.

For example, quantum wave interference predicts the emergence of probability interference patterns that lead to unexpected distributions of measureable entities in real space, even when dealing with well-known particles and their trajectories. This effect is probably best illustrated by the famous Young's double slit experiment. Here, the complex phase differences between quantum mechanical waves propagating from different space points, namely the two slits where the particle wave was forced to “bifurcate”, manifest in a measurable effect on the path followed by the physical particle. Specifically, the particle is predicted to exhibit a type of self-interference that prevents it from reaching certain places that lie manifestly along classically computed particle trajectories. These quantum effects are confirmed by fact.

Although surprising, wave superpositions and interference patterns are ultimately not the novel aspects that challenged human intuition most. Far more mysterious is the nature of measurement during which a real value of an observable attribute or of an element of reality is actually observed. While the underlying model of pre-emerged reality constructed of quantum waves governed by differential wave equations (e.g., by the Schroedinger equation) and boundary conditions may be at least partly intuitive, measurement itself defies attempts at non-probabilistic description.

According to quantum theory, the act of measurement forces the full state vector or wave packet of all possibilities to “collapse” or choose just one of the possibilities. In other words, measurement forces the normally compound wave function (i.e., a superposition of possible wave solutions to the governing differential equation) to transition discontinuously and manifest as just one of its constituents. Still differently put, measurement reduces the wave packet and selects only one component wave from the full packet that represents the superposition of all component waves contained in the state vector.

In order to properly evaluate the state of the prior art and to contextualize the contributions of the present invention, it will be necessary to review a number of important concepts from quantum mechanics, quantum information theory (e.g., the quantum version of bits also called “qubits” by skilled artisans) and several related fields. For the sake of brevity, only the most pertinent issues will be presented herein. A more thorough review of quantum information theory is found in course materials by John P. Preskill, “Quantum Information and Computation”, Lecture Notes Ph219/CS219, Chapters 2&3, California Institute of Technology, 2013 and references cited therein. Excellent reviews of the fundamentals of quantum mechanics are found in standard textbooks starting with P.A.M. Dirac, “The Principles of Quantum Mechanics”, Oxford University Press, 4^{th} Edition, 1958; L. D. Landau and E. M. Lifshitz, “Quantum Mechanics (Non-relativistic Theory)”, Institute of Physical Problems, USSR Academy of Sciences, Butterworth Heinemann, 3^{rd} Edition, 1962; Cohen-Tannoudji et al., “Quantum Mechanics”, John Wiley & Sons, 1977, and many others including the more modern and experiment-based treatments such as J. J. Sakurai, “Modern Quantum Mechanics”, Addison-Wesley, 2011.

2. A Brief Review of Quantum Mechanics Fundamentals

In most practical applications of quantum models, the process of measurement is succinctly and elegantly described in the language of linear algebra or matrix mechanics (frequently referred to as the Heisenberg picture). Since all those skilled in the art are familiar with linear algebra, many of its fundamental theorems and corollaries will not be reviewed herein. In the language of linear algebra, a quantum wave Ψ is represented in a suitable eigenvector basis by a state vector |ψ [symbol] . To provide a more rigorous definition, we will take advantage of the formal bra-ket notation introduced by Dirac and routinely used in the art.

In the bra-ket convention a column vector a is written as |α [symbol] and its corresponding row vector (dual vector) is written as [symbol] α|. Additionally, because of the complex-valuedness of quantum state vectors, flipping any bra vector to its dual ket vector and vice versa implicitly includes the step of complex conjugation. After initial introduction, most textbooks do not expressly call out this step (i.e., [symbol] α| is really [symbol] α⁺| where the asterisk denotes complex conjugation). The reader is cautioned that many simple errors can be avoided by recalling this fundamental rule of complex conjugation.

We now recall that a measure of norm or the dot product (which is related to a measure of length and is a scalar quantity) for a standard vector \vec{x} is normally represented as a multiplication of its row vector form by its column vector form as follows: d=\vec{x}^{T}\vec{x}. This way of determining norm carries over to the bra-ket formulation. In fact, the norm of any state vector carries a special significance in quantum mechanics.

Expressed by the bra-ket [symbol] α|α [symbol] , we note that this formulation of the norm is always positive definite and real-valued for any non-zero state vector. That condition is assured by the step of complex conjugation when switching between bra and ket vectors. Now, state vectors describe probability amplitudes while their norms correspond to probabilities. The latter are real-valued and by convention mapped to a range between 0 and 1 (with 1 representing a probability of 1 or 100% certainty). Correspondingly, all state vectors are typically normalized such that their inner product (a generalization of the dot product) is equal to one, or simply put: [symbol] α|α= [symbol] β|β [symbol] = . . . =1. This normalization enforces conservation of probability on objects composed of quantum mechanical state vectors.

Using the above notation, we can represent any state vector |ψ [symbol] in its ket form as a sum of basis ket vectors |εⱼ [symbol] that span the Hilbert space [symbol] of state vector |ψ [symbol] . In this expansion, the basis ket vectors |εⱼ [symbol] are multiplied by their correspondent complex coefficients cⱼ. In other words, state vector |ψ [symbol] decomposes into a linear combination as follows:

|ψ [symbol] =Σⱼ₌₁ⁿcⱼ|εⱼ [symbol] Eq. 1

where n is the number of vectors in the chosen basis. This type of decomposition of state vector |ψ [symbol] is sometimes referred to as its spectral decomposition by those skilled in the art.

Of course, any given state vector |ψ [symbol] can be composed from a linear combination of vectors in different bases thus yielding different spectra. However, the normalization of state vector |ψ [symbol] is equal to one irrespective of its spectral decomposition. In other words, bra-ket [symbol] ψ|ψ [symbol] =1 in any basis. From this condition we learn that the complex coefficients cⱼ of any expansion have to satisfy:

pₜₒₜ=1=Σⱼ₌₁ⁿcⱼ*cⱼ Eq. 2

where pₜₒₜ is the total probability. This ensures the conservation of probability, as already mentioned above. Furthermore, it indicates that the probability pⱼ associated with any given eigenvector |εⱼ [symbol] in the decomposition of |ψ [symbol] is the norm of the complex coefficient cⱼ, or simply put:

pⱼ=cⱼ*cⱼ. Eq. 3

In view of the above, it is not accidental that undisturbed evolution of any state vector |ψ [symbol] in time is found to be unitary or norm preserving. In other words, the evolution is such that the norms cⱼ*cⱼ do not change with time.

To better understand the last point, we use the polar representation of complex numbers by their modulus r and phase angle θ. Thus, we rewrite complex coefficient cⱼ as:

cⱼ=rⱼe^{iθ}^{ⱼ}, Eq. 4a

where i=\sqrt{−1} (we will use i rather than j for the imaginary number). In this form, complex conjugate of complex coefficient cⱼ* is just:

cⱼ*=rⱼe^{iθ}^{ⱼ}, Eq. 4b

and the norm becomes:

cⱼ*cⱼ=rⱼe^{-iθ}^{ⱼ}rⱼe^{iθ}^{ⱼ}=rⱼ². Eq. 4c

The step of complex conjugation thus makes the complex phase angle drop out of the product (since e^{-iθ} e^{iθ}=e^{i(θ-θ)}=e⁰=1). This means that the complex phase of coefficient cⱼ does not have any measurable effects on the real-valued probability pⱼ associated with the corresponding eigenvector |εⱼ [symbol] . Note, however, that relative phases between different components of the decomposition will introduce measurable effects (e.g., when measuring in a different basis).

In view of the above insight about complex phases, it is perhaps unsurprising that temporal evolution of state vector |ψ [symbol] corresponds to the evolution of phase angles of complex coefficients cⱼ in its spectral decomposition (see Eq. 1). In other words, evolution of state vector |ψ [symbol] in time is associated with a time-dependence of angles θⱼ of each complex coefficient cⱼ. The complex phase thus exhibits a time dependence e^{iθ}^{ⱼ}=e^{iω}^{ⱼ}^{t}, where the j-th angular frequency ωⱼ is associated with the j-th eigenvector |εⱼ [symbol] and t stands for time. For completeness, it should be pointed out that ωⱼ is related to the energy level of the correspondent eigenvector |εⱼ [symbol] by the famous Planck relation:

Eⱼ=ωⱼ, Eq. 5

where stands for the reduced Planck's constant h, namely:

$$ℏ = \frac{h}{2 π} .$$

Correspondingly, evolution of state vector |ψ [symbol] is encoded in a unitary matrix U that acts on state vector |ψ [symbol] in such a way that it only affects the complex phases of the eigenvectors in its spectral decomposition. The unitary nature of evolution of state vectors ensures the fundamental conservation of probability. Of course, this rule applies when there are no disturbances to the overall system and states exhibiting this type of evolution are often called stationary states.

In contrast to the unitary evolution of state vectors that affects the complex phases of all eigenvectors of the state vector's spectral decomposition, the act of measurement picks out just one of the eigenvectors. Differently put, the act of measurement is related to a projection of the full state vector |ψ [symbol] onto the subspace defined by just one of eigenvectors |εⱼ [symbol] in the vector's spectral decomposition (see Eq. 1). Based on the laws of quantum mechanics, the projection obeys the laws of probability. More precisely, each eigenvector |εⱼ [symbol] has the probability pⱼ dictated by the norm cⱼ*cⱼ (see Eq. 3) of being picked for the projection induced by the act of measurement. Besides the rules of probability, there are no hidden variables or any other constructs involved in predicting the projection. This situation is reminiscent of a probabilistic game such as a toss of a coin or the throw of a die. It is also the reason why Einstein felt uncomfortable with quantum mechanics and proclaimed that he did not believe that God would “play dice with the universe”.

No experiments to date have been able to validate Einstein's position by discovering hidden variables or other predictive mechanisms behind the choice. In fact, experiments based on the famous Bell inequality and many other investigations have confirmed that the above understanding encapsulated in the projection postulate of quantum mechanics is complete. Furthermore, once the projection occurs due to the act of measurement, the emergent element of reality that is observed, i.e., the measurable quantity, is the eigenvalue λⱼ associated with eigenvector |εⱼ [symbol] selected by the projection.

Projection is a linear operation represented by a projection matrix P that can be derived from knowledge of the basis vectors. The simplest state vectors decompose into just two distinct eigenvectors in any given basis. These vectors describe the spin states of spin ½ particles such as electrons and other spinors. The quantum states of twistors, such as photons, also decompose into just two eigenvectors. In the present case, we will refer to spinors for reasons of convenience.

It is customary to define the state space of a spinor by eigenvectors of spin along the z-axis. The first, |ε_{z+} [symbol] is aligned along the positive z-axis and the second, |ε_{z-} [symbol] is aligned along the negative z-axis. Thus, from standard rules of linear algebra, the projection along the positive z-axis (z+) can be obtained from constructing the projection matrix or, in the language of quantum mechanics the projection operator P_{z+} from the z+ eigenvector |ε_{z+} [symbol] as follows:

$${P}_{z +} = \vert {ɛ}_{z +} 〉 〈 {ɛ}_{z +} \vert = {[ \begin{matrix}1 \\ 0\end{matrix} ] [ \begin{matrix}1 & 0\end{matrix} ]}^{*} = [ \begin{matrix}1 & 0 \\ 0 & 0\end{matrix} ] , \qquad Eq . 6$$

where the asterisk denotes complex conjugation, as above (no change here because vector components of |ε_{z+} [symbol] are not complex in this example). Note that in Dirac notation obtaining the projection operator is analogous to performing an outer product in standard linear algebra. There, for a vector \vec{x} we get the projection matrix onto it through the outer product, namely: Pₓ=\vec{x}\vec{x}^{T}.

3. A Brief Introduction to Qubits

We have just seen that the simplest quantum state vector |ψ [symbol] corresponds to a pre-emerged quantum entity that can yield one of two distinct observables under measurement. These measures are the two eigenvalues λ₁, λ₂ of the correspondent two eigenvectors |ε₁ [symbol] , |₂ [symbol] in the chosen spectral decomposition. The relative occurrence of the eigenvalues will obey the probabilistic rule laid down by the projection postulate. In particular, eigenvalue λ₁ will be observed with probability p₁ (see Eq. 3) equal to the probability of projection onto eigenvector |ε₁ [symbol] . Eigenvalue λ₂ will be seen with probability p₂ equal to the probability of projection onto eigenvector |ε₂ [symbol] .

Because of the simplicity of the two-state quantum system represented by such two-state vector |ψ [symbol] , it has been selected in the field of quantum information theory and quantum computation as the fundamental unit of information. In analogy to the choice made in computer science, this system is commonly referred to as a qubit and so the two-state vector becomes the qubit: |qb [symbol] =|ψ [symbol] . Operations on one or more qubits are of great interest in the field of quantum information theory and its practical applications. Since the detailed description will rely extensively on qubits and their behavior, we will now introduce them with a certain amount of rigor.

From the above preliminary introduction it is perhaps not surprising to find that the simplest two-state qubit, just like a simple spinor or twistor on which it is based, can be conveniently described in 2-dimensional complex space called [symbol] ². The description finds a more intuitive translation to our 3-dimensional space, [symbol] ³, with the aid of the Bloch or Poincare Sphere. This concept is introduced by FIG. 1A, in which the Bloch Sphere 10 is shown centered on the origin of orthogonal coordinates indicated by axes X, Y, Z.

Before allowing oneself to formulate an intuitive view of qubits by looking at Bloch sphere 10, the reader is cautioned that the representation of qubits inhabiting [symbol] ² by mapping them to a ball in [symbol] ³ is a useful tool. The actual mapping is not one-to-one. Formally, the representation of spinors by the group of transformations defined by SO(3) (Special Orthogonal matrices in [symbol] ²) is double-covered by the group of transformations defined by SU(2) (Special Unitary matrices in [symbol] ²).

In the Bloch representation, a qubit 12 represented by a ray in [symbol] ² is spectrally decomposed into the two z-basis eigenvectors. These eigenvectors include the z-up or |+ [symbol] _{z} eigenvector, and the z-down or |− [symbol] _{z} eigenvector. The spectral decomposition theorem assures us that any state of qubit 12 can be decomposed in the z-basis as long as we use the appropriate complex coefficients. In other words, any state of qubit 12 can be described in the z-basis by:

|ψ [symbol] _{z}=|qb [symbol] _{z}=α|+ [symbol] _{z}+β|− [symbol] _{z}, Eq. 7

where α and β are the corresponding complex coefficients. In quantum information theory, basis state |+ [symbol] _{z} is frequently mapped to logical “yes” or to the value “1”, while basis state |− [symbol] _{z} is frequently mapped to logical “no” or to the value “0”.

In FIG. 1A basis states |+ [symbol] _{z} and |− [symbol] _{z} are shown as vectors and are written out in full form for clarity of explanation. (It is worth remarking that although basis states |+ [symbol] _{z} and |− [symbol] _{z} are indeed orthogonal in [symbol] ², they fall on the same axis (Z axis) in the Bloch sphere representation in [symbol] ³. That is because the mapping is not one-to-one, as already mentioned above.) Further, in our chosen representation of qubit 12 in the z-basis, the X axis corresponds to the real axis and is thus also labeled by Re. Meanwhile, the Y axis corresponds to the imaginary axis and is additionally labeled by Im.

To appreciate why complex coefficients α and β contain sufficient information to encode qubit 12 pointed anywhere within Bloch sphere 10 we now refer to FIG. 1B. Here the complex plane 14 spanned by real and imaginary axes Re, Im that are orthogonal to the Z axis and thus orthogonal to eigenvectors |+ [symbol] _{z} and |− [symbol] _{z} of our chosen z-basis is hatched for better visualization. Note that eigenvectors for the x-basis |+ [symbol] ₓ, |− [symbol] ₓ as well as eigenvectors for the y-basis |+ [symbol] _{y}, |− [symbol] _{y} are in complex plane 14. Most importantly, note that each one of the alternative basis vectors in the two alternative basis choices we could have made finds a representation using the eigenvectors in the chosen z-basis. As shown in FIG. 1B, the following linear combinations of eigenvectors |+ [symbol] _{z} and |− [symbol] _{z} describe vectors |+ [symbol] ₓ, |− [symbol] ₓ and |+ [symbol] _{y}, |− [symbol] _{y}:

$$\begin{matrix}{\vert + 〉}_{x} = \frac{1}{\sqrt{2}} {\vert + 〉}_{z} + \frac{1}{\sqrt{2}} {\vert - 〉}_{z} & Eq . 8 a \\ {\vert - 〉}_{x} = \frac{1}{\sqrt{2}} {\vert + 〉}_{z} - \frac{1}{\sqrt{2}} {\vert - 〉}_{z} , & Eq . 8 b \\ {\vert + 〉}_{y} = \frac{1}{\sqrt{2}} {\vert + 〉}_{z} + \frac{i}{\sqrt{2}} {\vert - 〉}_{z} , & Eq . 8 c \\ {\vert - 〉}_{y} = \frac{1}{\sqrt{2}} {\vert + 〉}_{z} - \frac{i}{\sqrt{2}} {\vert - 〉}_{z} . & Eq . 8 d\end{matrix}$$

Clearly, admission of complex coefficients α and β permits a complete description of qubit 12 anywhere within Bloch sphere 10 thus furnishing the desired map from [symbol] ² to [symbol] ² for this representation. The representation is compact and leads directly to the introduction of Pauli matrices.

FIG. 1C shows the three Pauli matrices σ₁, σ₂, σ₃ (sometimes also referred to as σₓ, σ_{y}, σ_{z}) that represent the matrices corresponding to three different measurements that can be performed on spinors. Specifically, Pauli matrix σ₁ corresponds to measurement of spin along the X axis (or the real axis Re). Pauli matrix σ₂ corresponds to measurement of spin along the Y axis (or the imaginary axis Im). Finally, Pauli matrix σ₃ corresponds to measurement of spin along the Z axis (which coincides with measurements in the z-basis that we have selected). The measurement of spin along any of these three orthogonal axes will force projection of qubit 12 to one of the eigenvectors of the corresponding Pauli matrix. Correspondingly, the measurable value will be the eigenvalue that is associated with the eigenvector.

To appreciate the possible outcomes of measurement we notice that all Pauli matrices σ₁, σ₂, σ₃ share the same two orthogonal eigenvectors, namely |ε₁ [symbol] =[1,0] and |ε₂ [symbol] =[0,1]. Further, Pauli matrices are Hermitian (an analogue of real-valued symmetric matrices) such that:

σₖ=σₖ^{†}, Eq. 9

for k=1, 2, 3 (for all Pauli matrices). These properties ensure that the eigenvalues λ₁, λ₂, λ₃ of Pauli matrices are real and the same for each Pauli matrix. In particular, for spin ½ particles such as electrons, the Pauli matrices are multiplied by a factor of ^{}/2 to obtain the corresponding spin angular momentum matrices Sₖ. Hence, the eigenvalues are shifted to

$${λ}_{1} = \frac{ℏ}{2}$$

$$and$$

$${λ}_{2} = - \frac{ℏ}{2}$$

(where is the reduced Planck's constant already defined above). Here we also notice that Pauli matrices σ₁, σ₂, σ₃ are constructed to apply to spinors, which change their sign under a 2π rotation and require a rotation by 4π to return to initial state (formally, an operator S is a spinor if S(θ+2π)=−S(θ)).

As previously pointed out, in quantum information theory and its applications the physical aspect of spinors becomes unimportant and thus the multiplying factor of ^{}/2 is dropped. Pauli matrices σ₁, σ₂, σ₃ are used in unmodified form with corresponded eigenvalues λ₁=1 and λ₂=−1 mapped to two opposite logical values, such as “yes” and “no”. For the sake of rigor and completeness, one should state that the Pauli matrices are traceless, each of them squares to the Identity matrix I, their determinants are −1 and they are involutory. A more thorough introduction to their importance and properties can be found in the many foundational texts on Quantum Mechanics, including the above mentioned textbook by P.A.M. Dirac, “The Principles of Quantum Mechanics”, Oxford University Press, 4^{th} Edition, 1958 in the section on the spin of the electron.

Based on these preliminaries, the probabilistic aspect of quantum mechanics encoded in qubit 12 can be re-stated more precisely. In particular, we have already remarked that the probability of projecting onto an eigenvector of a measurement operator is proportional to the norm of the complex coefficient multiplying that eigenvector in the spectral decomposition of the full state vector. This rather abstract statement can now be recast as a complex linear algebra prescription for computing an expectation value [symbol] O [symbol] of an operator matrix O for a given quantum state |ψ [symbol] as follows:

[symbol]

O [symbol] _{ψ}= [symbol] ψ|O|ψ [symbol] , Eq. 10a

where the reader is reminded of the implicit complex conjugation between the bra vector [symbol] ψ| and the dual ket vector |ψ [symbol] . The expectation value [symbol] O [symbol] _{ψ} is a number that corresponds to the average result of the measurement obtained by operating with matrix O on a system described by state vector |ψ [symbol] . For better understanding, FIG. 1C visualizes the expectation value [symbol] σ₃ [symbol] for qubit 12 whose ket in the z-basis is written as |qb [symbol] _{z} for a measurement along the Z axis represented by Pauli matrix σ₃ (note that the subscript on the expectation value is left out, since we know what state vector is being measured).

Although the drawing may suggests that expectation value [symbol] σ₃ [symbol] is a projection of qubit 12 onto the Z axis, the value of this projection is not the observable. Instead, the value [symbol] σ₃ [symbol] is the expectation value of collapse of qubit 12 represented by ket vector |qb [symbol] _{z}, in other words, a value that can range anywhere between 1 and −1 (“yes” and “no”) and will be found upon collecting the results of a large number of actual measurements.

In the present case, since operator σ₃ has a complete set of eigenvectors (namely |+ [symbol] _{z} and |− [symbol] _{z}) and since the qubit |qb [symbol] _{z} we are interested in is described in the same z-basis, the probabilities are easy to compute. The expression follows directly from Eq. 10a:

[symbol]

σ₃ [symbol] _{ψ}=Σⱼλⱼ| [symbol] ψ|εⱼ [symbol] |², Eq. 10b

where λⱼ are the eigenvalues (or the “yes” and “no” outcomes of the experiment) and the norms | [symbol] ψ|εⱼ [symbol] |² are the probabilities that these outcomes will occur. Eq. 10b is thus more useful for elucidating how the expectation value of an operator brings out the probabilities of collapse to respective eigenvectors |εⱼ [symbol] that will obtain when a large number of measurements are performed in practice.

For the specific case in FIG. 1C, we show the probabilities from Eq. 10b can be found explicitly in terms of the complex coefficients α and β. Their values are computed from the definition of quantum mechanical probabilities already introduced above (see Eqs. 2 and 3):

p₁=p_{“yes”}=| [symbol] qb|ε₁ [symbol] |²=|(α* [symbol] +|+β* [symbol] −|)|+ [symbol] _{z}|²=α*α

p₂=p_{“no”}=| [symbol] qb|ε₂ [symbol] |²=|(α* [symbol] +|+β* [symbol] −|)|− [symbol] _{z}|²=β*β

p₁+p₂=p_{“yes”}+p_{“no”}=α*α+β*β=1

These two probabilities are indicated by visual aids at the antipodes of Bloch sphere 10 for clarification. The sizes of the circles that indicate them denote their relative values. In the present case p_{“yes”}>p_{“no”} given the exemplary orientation of qubit 12.

Representation of qubit 12 in Bloch sphere 10 brings out an additional and very useful aspect to the study, namely a more intuitive polar representation. This representation will also make it easier to point out several important aspects of quantum mechanical states that will be pertinent to the present invention.

FIG. 1D illustrates qubit 12 by deploying polar angle θ and azimuthal angle φ routinely used to parameterize the surface of a sphere in [symbol] ³. Qubit 12 described by state vector |qb [symbol] _{z} has the property that its vector representation in Bloch sphere 10 intersects the sphere's surface at point 16. That is apparent from the fact that the norm of state vector |qb [symbol] _{z} is equal to one and the radius of Bloch sphere 10 is also one. Still differently put, qubit 12 is represented by quantum state |qb [symbol] _{z} that is pure; i.e., it is considered in isolation from the environment and from any other qubits for the time being. Pure state |qb [symbol] _{z} is represented with polar and azimuth angles θ, φ of the Bloch representation as follows:

$${\vert qb 〉}_{z} = cos \frac{θ}{2} {\vert + 〉}_{z} + {e}^{iφ} sin \frac{θ}{2} {\vert - 〉}_{z} , \qquad Eq . 11$$

where the half-angles are due to the state being a spinor (see definition above). The advantage of this description becomes even more clear in comparing the form of Eq. 11 with Eq. 7. State |qb [symbol] _{z} is insensitive to any overall phase or overall sign thus permitting several alternative formulations.

Additionally, we note that the Bloch representation of qubit 12 also provides an easy parameterization of point 16 in terms of {x,y,z} coordinates directly from polar and azimuth angles θ, φ. In particular, the coordinates of point 16 are just:

{x,y,z}={sin θ cos φ, sin θ sin φ, cos θ}, Eq. 12

in agreement with standard transformation between polar and Cartesian coordinates.

We now return to the question of measurement equipped with some basic tools and a useful representation of qubit 12 as a unit vector terminating at the surface of Bloch sphere 10 at point 16 (whose coordinates {x,y,z} are found from Eq. 12) and pointing in some direction characterized by angles θ, φ. The three Pauli matrices σ₁, σ₂, σ₃ can be seen as associating with measurements along the three orthogonal axes X, Y, Z in real 3-dimensional space [symbol] ³.

A measurement represented by a direction in [symbol] ³ can be constructed from the Pauli matrices. This is done with the aid of a unit vector û pointing along a proposed measurement direction, as shown in FIG. 1D. Using the dot-product rule, we now compose the desired operator σᵤ using unit vector û and the Pauli matrices as follows:

σᵤ=û· σ̅=uₓσ₁+u_{y}σ₂+u_{z}σ₃. Eq. 13

Having thus built up a representation of quantum mechanical state vectors, we are in a position to understand a few facts about the pure state of qubit 12. Namely, an ideal or pure state of qubit 12 is represented by a Bloch vector of unit norm pointing along a well-defined direction. It can also be expressed by Cartesian coordinates {x,y,z} of point 16. Unit vector û defining any desired direction of measurement can also be defined in Cartesian coordinates {x,y,z} of its point of intersection 18 with Bloch sphere 10.

When the direction of measurement coincides with the direction of the state vector of qubit 12, or rather when the Bloch vector is aligned with unit vector û, the result of the quantum measurement will not be probabilistic. In other words, the measurement will yield the result |+ [symbol] ᵤ with certainty (probability equal to 1 as may be confirmed by applying Eq. 10b), where the subscript u here indicates the basis vector along unit vector û. Progressive misalignment between the direction of measurement and qubit 12 will result in an increasing probability of measuring the opposite state, |− [symbol] ᵤ.

The realization that it is possible to predict the value of qubit 12 with certainty under above-mentioned circumstances suggests we ask the opposite question. When do we encounter the least certainty about the outcome of measuring qubit 12? With the aid of FIG. 1E, we see that in the Bloch representation this occurs when we pick a direction of measurement along a unit vector \hat{v} that is in a plane 20 perpendicular to unit vector û after establishing the state |+ [symbol] ᵤ (or the state |− [symbol] ᵤ) by measuring qubit 12 eigenvalue “yes” along û (or “no” opposite to û). Note that establishing a certain state in this manner is frequently called “preparing the state” by those skilled in the art. After preparation in state |+ [symbol] ᵤ or in state |− [symbol] ᵤ, measurement of qubit 12 along vector \hat{v} will produce outcomes |+ [symbol] ᵥ and |− [symbol] ᵥ with equal probabilities (50/50).

Indeed, we see that this same condition holds among all three orthogonal measurements encoded in the Pauli matrices. To wit, preparing a certain measurement along Z by application of matrix σ₃ to qubit 12 makes its subsequent measurement along X or Y axes maximally uncertain (see also plane 14 in FIG. 1B). This suggests some underlying relationship between Pauli matrices σ₁, σ₂, σ₃ that encodes for this indeterminacy. Even based on standard linear algebra we expect that since the order of application of matrix operations usually matters (since any two matrices A and B typically do not commute) the lack of commutation between Pauli matrices could be signaling a fundamental limit to the simultaneous observation of multiple orthogonal components of spin or, by extension, of qubit 12.

In fact, we find that the commutation relations for the Pauli matrices, here explicitly rewritten with the x,y,z indices rather than 1, 2, 3, are as follows:

[σₓ,σ_{y}]=iσ_{z};[σ_{y},σ_{z}]=iσₓ;[σ_{z},σₓ]=iσ_{y}. Eq. 14

The square brackets denote the traditional commutator defined between any two matrices A, B as [A,B]=AB−BA. When actual quantities rather than qubits are under study, this relationship leads directly to the famous Heisenberg Uncertainty Principle. This fundamental limitation on the emergence of elements of reality prevents the simultaneous measurement of incompatible observables and places a bound related to Planck's constant h (and more precisely to the reduced Planck's constant ) on the commutator. This happens because matrices encoding real observables bring in a factor of Planck's constant and the commutator thus acquires this familiar bound.

The above finding is general and extends beyond the commutation relations between Pauli matrices. According to quantum mechanics, the measurement of two or more incompatible observables is always associated with matrices that do not commute. Another way to understand this new limitation on our ability to simultaneously discern separate elements of reality, is to note that the matrices for incompatible elements of reality cannot be simultaneously diagonalized. Differently still, matrices for incompatible elements of reality do not share the same eigenvectors. Given this fact of nature, it is clear why modern day applications strive to classify quantum systems with as many commuting observables as possible up to the famous Complete Set of Commuting Observables (CSCO).

Whenever the matrices used in the quantum description of a system do commute, then they correspond to physical quantities of the system that are simultaneously measurable. A particularly important example is the matrix that corresponds to the total energy of the system known as the Hamiltonian H. When an observable is described by a matrix M that commutes with Hamiltonian H, and the system is not subject to varying external conditions, (i.e., there is no explicit time dependence) then that physical quantity that corresponds to operator M is a constant of motion.

4. A Basic Measurement Arrangement

In practice, pure states are rare due to interactions between individual qubits as well as their coupling to the environment. All such interactions lead to a loss of quantum state coherency, also referred to as decoherence, and the consequent emergence of “classical” statistics. Thus, many additional tools have been devised for practical applications of quantum models under typical conditions. However, under conditions where the experimenter has access to entities exhibiting relatively pure quantum states many aspects of the quantum mechanical description can be recovered from appropriately devised measurements.

To recover the desired quantum state information it is important to start with collections of states that are large. This situation is illustrated by FIG. 1F, where an experimental apparatus 22 is set up to perform a measurement of spin along the Z axis. Apparatus 22 has two magnets 24A, 24B for separating a stream of quantum systems 26 (e.g., electrons) according to spin. The spin states of systems 26 are treated as qubits 12a, 12b, . . . , 12n for the purposes of the experiment. The eigenvectors and eigenvalues are as before, but the subscript “z” that was there to remind us of the z-basis decomposition, which is now implicitly assumed, has been dropped.

Apparatus 22 has detectors 28A, 28B that intercept systems 26 after separation to measure and amplify the readings. It is important to realize that the act of measurement is performed during the interaction between the field created between magnets 24A, 24B and systems 26. Therefore, detectors 28A, 28B are merely providing the ability to record and amplify the measurements for human use. These operations remain consistent with the original result of quantum measurements. Hence, their operation can be treated classically. (The careful reader will discover a more in-depth explanation of how measurement can be understood as entanglement that preserves consistency between measured events given an already completed micro-level measurement. By contrast, the naïve interpretation allowing amplification to lead to macro-level superpositions and quantum interference is incompatible with the consistency requirement. A detailed analysis of these fine points is found in any of the previously mentioned foundational texts on quantum mechanics.)

For systems 26 prepared in various pure states that are unknown to the experimenter, the measurements along Z will not be sufficient to deduce these original states. Consider that each system 26 is described by Eq. 7. Thus, each system 26 passing through apparatus 22 will be deflected according to its own distinct probabilities p_{|+} [symbol] =α*α (or p_{“yes”}) and p_{|-} [symbol] =β*β (or p_{“no”}). Hence, other than knowing the state of each system 26 with certainty after its measurement, general information about the preparation of systems 26 prior to measurement will be very difficult to deduce.

FIG. 1G shows the more common situation, where systems 26 are all prepared in the same, albeit unknown pure state (for “state preparation” see section 3 above). Under these circumstances, apparatus 22 can be used to deduce more about the original pure state that is unknown to the experimenter. In particular, a large number of measurements of |+ [symbol] (“yes”) and |− [symbol] (“no”) outcomes, for example N such measurements assuming all qubits 12a through 12n are properly measured, can be analyzed probabilistically. Thus, the number n_{|+} [symbol] of |+ [symbol] measurements divided by the total number of qubits 12 that were measured, namely N, has to equal α*α. Similarly, the number n_{|-} [symbol] of |− [symbol] measurements divided by N has to equal β*β. From this information the experimenter can recover the projection of the unknown pure state onto the Z axis. In FIG. 1G this projection 26′ is shown as an orbit on which the state vector can be surmised to lie. Without any additional measurements, this is all the information that can be easily gleaned from a pure Z axis measurement with apparatus 22.

5. Range of Validity of Quantum Field Theories—A General Overview

By now it will have become apparent to the reader that the quantum mechanical underpinnings of qubits are considerably more complicated than the physics of regular bits. Regular bits can be treated in a manner that is completely divorced from their physicality. A computer scientist dealing with a bit does not need to known what the physical system embodying the bit happens to be, as long as it satisfies the typical criteria of performance (e.g., low probability of bit errors and containment of other failure modes). Unfortunately, as already remarked and further based on the reviews found in U.S. patent application Ser. Nos. 14/182,281, 14/224,041 and 14/324,127 the same is not true for qubits.

Over and above the issues and insights discussed in these three filings, it is important to understand the limits on the range of validity of quantum mechanical models. Appreciation for this fundamental problem is best developed by studying the nature of coupling constants that mediate interactions as described by the Hamiltonian or Lagrangian formulation of the Quantum Field Theory (QFT) under consideration. This path of inquiry commences with postulating a value for the parameter (typically referred to as a coupling constant in particle physics) of the QFT in question. In the case of Electricity and Magnetism or Quantum Electrodynamics (QED) the coupling constant of interest is the fine structure constant α (commonly absorbed into the value of fundamental charge q of the electron). Next, by postulating the coupling constant to have certain properties the mathematical tools for series expansions and perturbation-based treatment of the coupling constant are invoked. Since the coupling constant results in a measurable physical quantity the results from the successive orders of the perturbation expansion can be cross-checked with measurement. Thus, values for the “bare charge” and shielded or screened charge can be derived in the case of QED.

In the process of studying the coupling constant in this manner the question of scale at which the QFT of interest is probed and valid arises naturally. When this scale, conventionally referred to as Λ and expressed in terms of energy, momentum or length (i.e. Λ⁻¹) is set at large values of energy a problem arises. Namely, the short-distance structure associated with high energy of any Lorentz invariant QFT turns out to be highly non-trivial. That is because the number of possible intermediate states that are permitted by the QFT grows as length scale Λ⁻¹ decreases. This growth in “the number of ways that processes can happen” at ever smaller distance scale Λ⁻¹ (or larger values of energy, i.e., larger energy scale Λ) leads to divergences in the perturbation series used to expand and study the QFT. This problem has been referred to as the ultraviolet (UV) catastrophe of infinities that arise in attempts to derive physical coupling values by including contributions from processes at ever shorter wavelengths or higher energies.

Persons skilled in the art have spent many decades struggling with this scale-dependence problem and taming divergences, frequently by offsetting them against each other. The resulting field is aptly called renormalization. It encompasses the study of structures at different scales using scale transformations and examination of self-similar structures. The mathematical formalism deployed in these studies is called the renormalization group. In any particular case, the results will depend on the specific QFT under investigation.

Simplifying and leaving out a number of details, the solution often involves imposing a cut-off in the scale Λ to which a QFT may be applied when computing the processes that it supports. A more thorough discussion of the nature of divergences encountered in the study of renormalization and application of the renormalization group are beyond the scope of the present background section.

To appreciate the theory and the practical consequences of renormalization in statistical physics the reader is referred to the pioneering work of Kenneth G. Wilson, who received the Nobel Prize for showing how proper application of renormalization explained phase transition phenomena in statistical physics such as the melting ice or the emergence of magnetization (see, e.g., Wilson, Kenneth, “Renormalization Group and Critical Phenomena. I. Renormalization Group and the Kadanoff Scaling Picture”, 1971, Physical Review B 4 (9) 3174; Wilson, Kenneth, “Renormalization Group and Critical Phenomena. II. Phase-Space Cell Analysis of Critical Behavior”, 1971, Physical Review B 4 (9) 3184.). For a formal introduction to the treatment of renormalization in QFT and related topics the reader is referred to textbooks on Quantum Field Theory. The many excellent references include popular standards such as: Peskin, M. E. and Schroeder, D. V., “An Introduction to Quantum Field Theory”, Perseus Books Publishing, Reading, Mass., 1995; Weinberg, S. “The Quantum Theory of Fields”, Cambridge University Press, Third Printing, 2009 and many other references including Srednicki, M., “Quantum Field Theory”, University of California, Santa Barbara, 2006 found online at: http://www.physics.ucsb.edu/˜mark/qft.html. For a short overview of renormalization the reader is directed to Delamotte, Bertrand, “A hint of renormalization”, American Journal of Physics 72 (2004), pp. 170-184.

In the following we will briefly touch on just a few renormalization concepts that are important to the present invention. The QFT we turn to for support in constructing the necessary examples is QED. It governs interactions between the electron e⁻ and the photon γ whose coupling probability is based on the value of the fine-structure constant α.

We commence with a simplified Feynman diagram as shown in FIG. 1H. Here we see a field quantum or photon γ travelling along the null ray (on the light cone; not shown). The null ray indicates the separation between the space-time region in which events are in causal connection, namely the time-like region within the light cone, and the region where events cannot be causally related to events taking place within the light cone, namely events in the space-like region. Photons γ arise due to second quantization of the field at all permissible space-time points with a certain probability. Second quantization may be viewed as the act of distributing harmonic oscillators representing field excitations by photons γ over the permissible space-time points. Once created, a photon γ always travels along a null ray. Differently, put, a photon γ always travels at the speed of light c. In the present diagram, the scale relationship between time coordinate t and space coordinate q was chosen such that the speed of light c corresponds to a slope of 1 or a line at 45° (as indicated by the dashed and dotted null ray separating the time-like and space-like regions).

Given that photons γ are confined to propagate along null rays it is easy to see that they cannot even in principle behave in the same manner as common particles that are bound to move at velocities v smaller than c. Massive particles, taking electron e⁻ as an example in the Feynman diagram of FIG. 1H, move inside the time-like region or within light cones bounded by null rays. In the time-like region four-vector velocities of such mass-bound entities transform under the well-known Lorentz transformation. The latter ensures that a rest frame can be found for any particle within the light cone. This is impossible for photons γ. They cannot be brought to rest in any frame (no rest-frame).

We now consider an interaction between photon γ and electron e⁻. Specifically, we are interested in the probability of electron e⁻ absorbing photon γ at space coordinate qₒ and time coordinate t₁. Since we are not computing a formal vertex we will use a simplified interaction model for this transition. The initial state is described by the ket vector “unexcited electron and photon enter”. The final state is described by the bra vector “excited electron exits”. The “matrix for interaction via coupling constant C” connecting these initial and final states contains appropriate terms to account for the probability of absorption of photon γ by electron e⁻ given all the other relevant factors (e.g., the spin of the electron and the polarization state of the photon). In general, the sum of all non-zero matrix elements for the ways in which an event can happen will yield the probability of the event. Here, the transition probability is just for the absorption event to take place.

From renormalization of QED we know that by cutting off scale Λ so as to avoid the ultraviolet divergence we obtain the generally observed value of coupling constant C that mediates the interactions between field quanta γ and electrons e⁻. Of course, coupling constant C is nothing but the fine-structure constant α given our choice of QED as the exemplary QFT, is approximately equal to 1/137. In natural units it assumes the form α=e²/4π (where e is the fundamental electric charge unit (equal to the charge of an electron e⁻), and where the permittivity of free space εₒ, Planck's reduced constant and the speed of light c are all set equal to one).

Now we turn to FIG. 1I to better understand the conditions under which we can take coupling constant C to be the fine-structure constant α. FIG. 1I is en enlarged view of a space-time neighborhood 36 around the vertex designated at time t₁ and space coordinate qₒ in FIG. 1H. A lower cut-off scale Λ⁻¹ expressed in terms of length (sometimes referred to as ε by those skilled in the art) is illustratively drawn around the vertex. The reader is cautioned that the purpose of this is explanatory as the diagram obviously includes time and space dimensions.

At scales smaller than cut-off length Λ⁻¹ higher energy processes are permitted. The energies of these processes can be readily derived from the same expression as the Compton wavelength of the electron, which is /mₑc². Here the mass mₑ is that of the electron. When applying this relationship below cut-off length Λ⁻¹, however, mc² corresponds to a much higher energy (much heavier particle of mass m>>mₑ that can be created at such high energies). FIG. 1I illustrates with exploded views three exemplary high energy processes occurring below the cut-off length Λ⁻¹ selected here for explanatory purposes.

In the first exploded view of in-coming photon γ, we see the formation of a loop 37. Loop 37 corresponds to the creation of an electron-positron pair. The electron moves forward (lower arrow) and the positron moving backward (upper arrow) about loop 37 after which the pair annihilates. This effect is called vacuum polarization and is responsible for the charge screening effect that clearly affects the value of coupling constant C examined at these length scales.

In the second exploded view of out-going electron e⁻ we find the latter emitting and re-absorbing a (virtual) photon thus creating loop 38. Loop 38 is called the self-energy loop and clearly contributes to the electromagnetic mass of electron e⁻. Once again, this mass correction reflected in the value of coupling constant C.

In the third exploded view around the vertex we see a more complicated interaction process 39. This process includes a number of sub-processes, such as an electron-positron loop 39a and a number of photon emission and absorption events 39b. The existence of such complex events and loops causes more complicated corrections to the coupling constant C.

When accounting for all possible processes with correspondent Feynman diagrams, of which the above three are merely exemplary, we recognize that three different parameters of QED require renormalization. The three corresponding adjustments involve corrections to the values of the field, the mass and the charge. As the length scale decreases these corrections do not converge; they actually diverge instead. Consequently, the coupling constant C goes to infinity. The point at which the coupling constant C of any QFT under study becomes infinite is referred to as its Landau pole. QED clearly has a Landau pole.

Because of the Landau pole in QED, it is important to work within a scale range that is bounded from below. This avoids running into infinities that yield nonsensical values for the coupling constant C making it increase with decreasing distance (also referred to as running constants by those skilled in the art). The correct bound to use should be close to the energies and momenta actually exchanged in the interactions under study; these will dictate the setting of the appropriate ultra-violet (UV) cut-off length Λ⁻¹. In the present illustrative example, the cut-off length Λ⁻¹ is pictorially indicated by the smallest radius of relevance to the interactions under study.

There is a further complication resulting from taking QED in the other direction to larger and larger distance scales. This produces a second class of divergences associated with decreasing energies. These correspond to increasing wavelengths and are hence often called infra-red (IR) divergences. As the diligent reader has likely found out by now in referring to the work of Kenneth G. Wilson, that IR divergences in a QFT associate to second order phase transitions. A commonly known second-order phase transition is responsible for the demagnetization effect in a spin system above the critical temperature (Curie temperature T_{c}). Another well-studied second-order phase transition occurs at the critical temperature for a liquid-gas system where self-similar patterns of gas and liquid droplets are observed at vastly disparate scales at the transition point.

Again, renormalization solves the problem of a coupling constant C running in the IR direction by bounding the scale of interest (i.e., energy, momentum or length) from above/below with respect to length/energy. In the present illustrative example, the cut-off length from above is just the radius of space-time neighborhood 36 (not explicitly shown). Thus, in the present illustration the value of coupling constant C can be taken to equal the fine-structure constant a (C=α) within hatched region 36′. We shall refer to this region as the validity range of the QFT of interest. In our example the QFT of interest is QED. Thus, validity range 36′ corresponds to the range in scale Λ where we can use the fine-structure constant α in computing all quantum electrodynamic processes of interest. It is duly noted that the illustration in FIG. 1I should not be used to obtain guidance as to the actual real or validity range for QED, as it is merely a pedagogical tool.

We should further remark for reasons of completeness of the present broad sketch of renormalization, that some QFTs exhibit coupling constants that do not run and instead tend to approach fixed values. In cases where a given physical coupling constant C approaches a fixed lower value with increasing energy scale the situation is renormalizable. The limiting lower value of such coupling constant C is called an ultraviolet fixed point. Similarly, in cases where a given physical coupling constant C approaches a fixed value with decreasing energy are renormalizable and the limiting upper value of coupling constant C is called an infrared fixed point. Furthermore, in cases where the fixed point is zero, the constants are referred to as asymptotically free. Theories with QFTs that possess asymptotic freedom are well-behaved across scales and lend themselves well to the application of the tools of renormalization (mainly renormalization group) as the sums at successive orders in their perturbative expansions converge.

6. Regularization and Lattice Models

Having thus reviewed in broad strokes the very basic quantum rules and renormalization-based validity ranges for QFT models, we turn our attention to practical applications. Many quantum-based models work in regularized spatial coordinates q where precipitation of the measurable or observable quantity takes place on nodes or lattice vertices. The advantage of these models from the point of view of renormalization is that lattice geometry and in particular lattice spacings introduce automatic scale limitations on the smallest possible loops and linear distances. Thus, determination of the appropriate scale cut-offs, and especially of the high-energy or UV cut-off (equivalently, the lowest distance scale cut-off), becomes simplified and running coupling constants in the UV direction are avoided.

This simplification applies even in complicated structures such as spin-glasses or other systems with quenched disorder in which the application of renormalization defies simple models but a lower bound on spacing can be ascertained. As expected, however, the most considerable advantages accrue in the use of regular lattices encountered in crystals and other highly ordered systems. In such systems the running coupling in the UV direction is arrested with an easily determined automatic UV cutoff from the smallest lattice spacing and the smallest available lattice loop.

The simplest lattice models subdivide space into regular intervals or discrete points. FIG. 1J shows a rudimentary cubic lattice 40 postulated in real three-dimensional space [symbol] ³. This space may be parameterized by a Cartesian coordinate system 30. Alternatively, it may be simply parameterized within lattice 40 itself without reference to external coordinates. Quantum entities 32a, 32b, . . . , 32z are placed at vertices 42a, 42b, . . . , 42z of lattice 40. Since the observable of interest is usually just the separable spin aspect, all wave functions of entities 32 are designated with lower-case ψ's rather than upper-case Ψ's that commonly refer to full wave functions. To indicate the spin, entities 32 are therefore described by wave functions ψₐ(σ), ψ_{b}(σ), . . . , ψ_{z}(σ).

Note that some vertices 42 may remain unfilled whereas some vertices may accommodate more than one entity 32 (e.g., two entities 32), depending on the type of lattice model. In some models the occupation of vertices 42 is further subject to change due to lattice hopping by entities 32. Typically, hopping is permitted between adjacent vertices 42 and it is accounted for by a kinetic term in the lattice Hamiltonian Ĥ operator.

Common tools for handling entities 32 in lattice models (e.g., in the Hubbard model) are the ‘fermion’ creation and annihilation operators ĉ^{†}, ĉ (where “†” denotes the Hermitian conjugate and the “hats” denote operators). These operators conveniently account for entities 32 precipitating on discrete and disjoint space coordinates q instantiated by vertices 42 of lattice 40. The reason these operators are ‘fermionic’ is that they obey the Pauli Exclusion Principle, as most common entities 32 populating lattice 40 in practical models are electrons. Hence, the action of creation and annihilation operators ĉ^{†}, ĉ is summarized by their anti-commutation relations:

{ĉ_{j,σ},ĉ_{k,σ}^{†}}=δ_{j,k}δ_{σ,σ},

{ĉ_{j,σ}^{†},ĉ_{k,σ}^{†}}=0

{ĉ_{j,σ},ĉ_{k,σ}}=0 Eq. 15

where, in contrast to the commutator [A,B], the anti-commutator {A,B} of two operators is defined as {A,B}=AB+BA. The first subscripts refer here to the lattice site or vertex 42 and the second subscripts refer to the spin σ.

FIG. 1J in fact depicts the j-th and k-th vertices, i.e., vertices 42j, 42k both occupied by entities 32j, 32k. According to the anti-commutation relations, only one entity 32 with a given spin can be accommodated on either vertex 42j, 42k. In general, for two entities to co-exist on a single vertex 42, they would have to have opposite spins (i.e., up and down along any chosen direction û in the representation using Bloch sphere 10) in agreement with Pauli's Exclusion Principle. Meanwhile, the creation and annihilation operators â^{†}, â for the bosonic photons γ obey standard commutation relations and resemble those used for generating quanta in a harmonic oscillator.

Of course, entities 32 on vertices 42 of lattice 40 can be considered to be the underlying physical embodiments for qubits |qb [symbol] . In FIG. 1J lattice site 42k is enlarged to reveal entity 32k in its representation as qubit |qbₖ [symbol] . In any case, the standard tools for computing the dynamics on lattice 40 involve the introduction of the appropriate lattice Hamiltonian Ĥ. The Hamiltonian assigns an energy term to all aspects of motions and interactions of entities 32 on lattice 40. Simple Hamiltonians assume vertices 42 to be fixed (no lattice vibrations) and accommodate at most two entities 32 per vertex 42 (one with spin up and one with spin down). In this sense, one can imagine each vertex 42 to be a type of simplified atom with just one energy level.

In a solid, such as a crystal, entities 32 can stand for electrons that are mobile. They interact with electrons that are not on the same vertex 42 by a screened Coulomb interaction. Of course, by far the largest interaction is due to entities 32 sitting on the same vertex 42. Interactions with entities 32 that are further away from each other disappear quickly due to the Coulomb screening effect. Therefore, in the simplest lattice models interactions between entities 32 that are further away than one site or even those that are just one site away may be disregarded. On the other hand, a certain interaction energy value U is assigned to any vertex 42 that has two entities 32.

The kinetic energy term in the lattice Hamiltonian Ĥ is due to hopping of entities 32 between neighboring vertices 42. Taking entities 32j, 32k as an example, the energy scale governing the hopping is based on the overlap of the spatial argument of wave functions ψⱼ(rⱼ;σ_{y}), ψₖ(rₖ;σ_{z}). In accordance with typical solutions to these wave functions their drop-off away from the point of precipitation on spatial coordinate q, i.e., away from vertex 42 in question, is exponential. Hence, in most lattice models it is safe to assume that hopping can take place only between neighboring vertices 42.

Finally, a third energy term in a typical lattice Hamiltonian Ĥ is related to the filling of lattice 40 by entities 32. This term is sometimes referred to as the chemical potential μ. The chemical potential is usually negative and predisposes lattice 40 to certain more preferential filling orders as well as clustering effects.

Hamiltonians with some or all of the above-described terms, as well as any additional terms have provided many valuable insights to practitioners of solid state physics. Corresponding lattice models have been studied under various types of lattice filling conditions, including sparse filling, half-filled and essentially or completely filled. Both bosonic and fermionic entities have been included in these studies. As a result, effects such as insulating gaps, anti-ferromagnetic order, phase transitions (e.g., second-order phase transitions mentioned above in section 5), super-conductivity and many others have been explained in detail with lattice models and their relatives.

7. Prior Art Applications of Quantum Theory to Subject States

Since the advent of quantum mechanics, many have realized that some of its non-classical features may better reflect the state of affairs at the human grade of existence. In particular, the fact that state vectors inherently encode incompatible measurement outcomes and the probabilistic nature of measurement do seem quite intuitive upon contemplation. Thus, many of the fathers of quantum mechanics did speculate on the meaning and applicability of quantum mechanics to human existence. Of course, the fact that rampant quantum decoherence above microscopic levels tends to destroy any underlying traces of coherent quantum states was never helpful. Based on the conclusion of the prior section, one can immediately surmise that such extension of quantum mechanical models in a rigorous manner during the early days of quantum mechanics could not even be legitimately contemplated.

Nevertheless, among the more notable early attempts at applying quantum techniques to characterize human states are those of C. G. Jung and Wolfgang Pauli. Although they did not meet with success, their bold move to export quantum formalisms to large scale realms without too much concern for justifying such procedures paved the way others. More recently, the textbook by physicist David Bohm, “Quantum Theory”, Prentice Hall, 1979 ISBN 0-486-65969-0, pp. 169-172 also indicates a motivation for exporting quantum mechanical concepts to applications on human subjects. More specifically, Bohm speculates about employing aspects of the quantum description to characterize human thoughts and feelings.

In a review article published online by J. Summers, “Thought and the Uncertainty Principle”, http://www.jasonsummers.org/thought-and-the-uncertainty-principle/, 2013 the author suggests that a number of close analogies between quantum processes and our inner experience and through processes could be more than mere coincidence. The author shows that this suggestion is in line with certain thoughts on the subject expressed by Niels Bohr, one of the fathers of quantum mechanics. Bohr's suggestion involves the idea that certain key points controlling the mechanism in the brain are so sensitive and delicately balanced that they must be described in an essentially quantum-mechanical way. Still, Summers recognizes that the absence of any experimental data on these issues prevents the establishment of any formal mapping between quantum mechanics and human subject states.

The early attempts at lifting quantum mechanics from their micro-scale realm to describe human states cast new light on the already known problem with standard classical logic, typically expressed by Bayesian models. In particular, it had long been known that Bayesian models are not sufficient or even incompatible with properties observed in human decision-making. The mathematical nature of these properties, which are quite different from Bayesian probabilities, were later investigated in quantum information science by Vedral, V., “Introduction to quantum information science”, New York: Oxford University Press 2006.

Taking the early attempts and more recent related motivations into account, it is perhaps not surprising that an increasing number of authors argue that the basic framework of quantum theory can be somehow extrapolated from the micro-domain to find useful applications in the cognitive domain. Some of the most notable contributions are found in: Aerts, D., Czachor, M., & D'Hooghe, B. (2005), “Do we think and communicate in quantum ways? On the presence of quantum structures in language”, In N. Gontier, J. P. V. Bendegem, & D. Aerts (Eds.), Evolutionary epistemology, language and culture. Studies in language, companion series. Amsterdam: John Benjamins Publishing Company; Atmanspacher, H., Roemer, H., & Walach, H. (2002), “Weak quantum theory: Complementarity and entanglement in physics and beyond”, Foundations of Physics, 32, pp. 379-406; Blutner, R. (2009), “Concepts and bounded rationality: An application of Niestegge's approach to conditional quantum probabilities”, In Accardi, L. et al. (Eds.), Foundations of probability and physics-5, American institute of physics conference proceedings, New York (pp. 302-310); Busemeyer, J. R., Wang, Z., & Townsend, J. T. (2006), “Quantum dynamics of human decision-making”, Journal of Mathematical Psychology, 50, pp. 220-241; Franco, R. (2007), “Quantum mechanics and rational ignorance”, Arxiv preprint physics/0702163; Khrennikov, A. Y., “Quantum-like formalism for cognitive measurements”, BioSystems, 2003, Vol. 70, pp. 211-233; Pothos, E. M., & Busemeyer, J. R. (2009), “A quantum probability explanation for violations of ‘rational’ decision theory”, Proceedings of the Royal Society B: Biological Sciences, 276. Recently, Gabora, L., Rosch, E., & Aerts, D. (2008), “Toward an ecological theory of concepts”, Ecological Psychology, 20, pp. 84-116 have even demonstrated how this framework can account for the creative, context-sensitive manner in which concepts are used, and they have discussed empirical data supporting their view.

An exciting direction for the application of quantum theory to the modeling of inner states of subjects was provided by the paper of R. Blutner and E. Hochnadel, “Two qubits for C. G. Jung's theory of personality”, Cognitive Systems Research, Elsevier, Vol. 11, 2010, pp. 243-259. The authors propose a formalization of C. G. Jung's theory of personality using a four-dimensional Hilbert space for representation of two qubits. This approach makes a certain assumption about the relationship of the first qubit assigned to psychological functions (Thinking, Feeling, Sensing and iNtuiting) and the second qubit representing the two perspectives (Introversion and Extroversion). The mapping of the psychological functions and perspectives presumes certain relationships between incompatible observables as well as the state of entanglement between the qubits that does not appear to be borne out in practice, as admitted by the authors. Despite this insufficiency, the paper is of great value and marks an important contribution to techniques for mapping problems regarding the behaviors and states of human subjects to qubits using standard tools and models afforded by quantum mechanics.

Thus, attempts at applying quantum mechanics to phenomena involving subjects at macro-levels have been mostly unsuccessful. A main and admitted source of problems lies in the translation of quantum mechanical models to human situations. More precisely, it is not at all clear how and under what conditions to map subject states as well as subject actions or reactions to quantum states. It is not even apparent in what realms the mappings may be valid.

Finally, the prior art does not provide for a quantum informed approach to gathering data. Instead, the state of the art for development of predictive personality models based on “big data” collected on the web is ostensibly limited to classical data collection and classification approaches. Some of the most representative descriptions of these are provided by: D. Markvikj et al., “Mining Facebook Data for Predictive Personality Modeling”, Association for the Advancement of Artificial Intelligence, www.aaai.org, 2013; G. Chittaranjan et al., “Who's Who with Big-Five: Analyzing and Classifying Personality Traits with Smartphones”, Idiap Research Institute, 2011, pp. 1-8; B. Verhoeven et al., “Ensemble Methods for Personality Recognition”, CLiPS, University of Antwerp, Association for the Advancement of Artificial Intelligence, Technical Report WS-13-01, www.aaai.org, 2013; M. Komisin et al., “Identifying Personality Types Using Document Classification Methods”, Dept. of Computer Science, Proceedings of the Twenty-Fifth International Florida Artificial Intelligence Research Society Conference, 2012, pp. 232-237.

### OBJECTS AND ADVANTAGES

In view of the shortcomings of the prior art, it is an object of the present invention to provide computer implemented methods and computer systems for testing ranges of validity in applications of quantum representations to subject states. The methods and systems are to address test subject states obtained under different contextualizations of underlying propositions about objects, other subjects and experiences. More specifically still, it is an object of the invention to provide for renormalization-related approaches and strategies for ascertaining validity ranges of quantum representations of contextualizations by test subjects and of the measurable indications of such contextualizations.

These and other objects and advantages of the invention will become apparent upon reading the detailed specification and reviewing the accompanying drawing figures.

### SUMMARY OF THE INVENTION

The present invention relates to computer implemented methods and computer systems that track the behaviors of test subjects, and more precisely the measurable indications resulting from such behaviors. The test subjects are confronted by underlying propositions that they are free to apprehend, perceive, understand or value in different and personal ways. In general, the confrontation of any test subject by the underlying proposition and that test subject's choice about what value to use in making sense of the underlying proposition will be referred to herein as a contextualization of the underlying proposition by that test subject. Many different contextualizations of the same underlying proposition are available to any one of the test subjects. Some of the available contextualizations are incompatible. These are represented by non-commuting quantum mechanical operators. Some other available contextualizations are compatible. These, on the other hand, are represented by commuting quantum mechanical operators.

The methods and systems of invention use a real scale parameter W that is established by a scaling module to classify the test subjects. In particular, a renormalization module is used to compute scale values Wᵢ on the scale parameter W associated with the test subjects Sᵢ, where i=1, 2, . . . , m, and where m is the number of test subjects.

The quantum representation is applied by an assignment module in situations where a range ΔW of scales values Wᵢ describing test subjects Sᵢ resides within a range of validity of the chosen quantum representation. The postulation of ranges of validity for quantum representations as applied herein to test subjects Sᵢ is related to renormalization as understood in modern physics. Specifically, renormalization in standard Quantum Field Theories (QFTs) shows that most QFTs have a range of validity defined between an upper cut-off (IR cut-off) and a lower cut-off (UV cut-off) defined on a real scaling parameter typically referred to as Λ. Thus, we associate such range of validity with the present quantum representation as well.

Further, we compute with the aid of a renormalization module an n-point correlation function between the test subjects. Preferably different orders of the n-point correlation function are used, starting with 2-point correlations between different pairs of test subjects. When the n-point correlation function does not drop off to zero with increasing separation between test subjects and/or shows self-similar correlation patterns at different n values the application of the quantum representation is suspended. This type of behavior of the n-point correlation function is an indicator of a second order phase transition. In fact, any known tool for testing for second order phase transition properties among the test subjects can be deployed in the methods and systems of the invention.

A classical representation is applied to the contextualizations by the assignment module under certain circumstances. These include four conditions. First, when the contextualizations have been observed or measured within a time period that is significantly less than a decoherence time associated with the quantum represenatation. Second, when the contextualizations are mostly observed or measured in a single eigenvector basis thus indicating that all test subjects are contextualizing the underlying proposition in the same way. Third, when the test subjects do not exhibit any appreciable entanglement effects amongst themselves or with the environment. (Persons skilled in the art will recognize that many tools have been developed in modern physics to ascertain entanglement and any of them can be applied herein as required.) Fourth, when there is no noticeable indication of a first order phase transition or a second order phase transition among the test subjects.

In accordance with the invention, a view of the contextualizations, whether using a quantum representation of a classical representation, can be presented to an observer. Prior to showing such a view, the renormalization module computes an observer scale value Wₒ associated with the observer. When observer scale value Wₒ resides within range ΔW then the view is presented to the observer in an unmodified form. On the other hand, when observer scale value Wₒ is outside range ΔW then the view is presented to the observer in a modified form. This is necessary because the observer does not himself/herself reside within the range of validity of the quantum representation and thus cannot be expected to personally understand the contextualizations experienced by the test subjects.

In general, when the assignment module deploys a classical representation of the contextualizations it should collect a statistically significant number of measurable indications of the contextualizations in incompatible eigenvector bases; preferably in at least two incompatible bases. In presenting the output of the classical representation a confusion of the measureable indications collected in incompatible bases should be constructed.

Borrowing from the quantum formalism, when viewing a classical representation of a “particle” one is actually looking at a confusion of a large number of measurements in the “position basis” and a large number of measurements in the “momentum basis” under the presumption that these two types of measurements co-exist. We refer to this type of presentation or view as a confusion since the concepts of position and momentum do not co-exist. More strongly put, position and momentum (velocity) have no simultaneous reality according to the rules of quantum mechanics. However, the confusion of these incompatible contextualizations produces a useful view of a localized particle with a defined momentum or velocity. This confused view holds for Newtonian mechanics and in the realm of daily human experience. Of course, a closer inspection or proper quantum representation uncovers the confusion of a distributed wavepacket in position space and a distributed wavepacket in momentum space. The measurements yielding the wavepackets were precluded by physical law from being performed simultaneously (due to Heisenberg's Uncertainty Principle). In fact, as well known to those skilled in the art, the relationship between the position-space and momentum-space wavepackets for a typical free particle is that of a Fourier Transform; this relationship being another way to understand the contents of the Heisenberg Uncertainty Principle.

In the quantum representation of the contextualizations implemented by the assignment module one should also strive to obtain measurable indications in at least two different eigenvector bases or in two different contextualizations. The test subject states |Sᵢ [symbol] forming the quantum representation of test subjects Sᵢ modulo the underlying proposition can be expressed in either contextualization. This is ensured by the spectral decomposition theorem. Conveniently, the different bases are expressed with corresponding value matrices PRⱼ that represent quantum mechanical operators (Hermitian matrices). Value matrices PRⱼ can act on or be applied to the test subject states |Sᵢ [symbol] to yield eigenvalues λₖ associated with measurable indications modulo the underlying proposition exhibited by test subjects Sᵢ. The two different eigenvector bases can be selected to be orthogonal such that the corresponding quantum mechanical operators, i.e., the value matrices PRⱼ in our quantum mechanical representation as applied to subjects, are non-commuting. In this sense, the measurable indications acquire the quality of being mutually exclusive. In other words, they cannot have simultaneous reality or, equivalently, they cannot be measured/observed in a test subjects at the same time. The reasons have already been elucidated above in addressing the construction of a confusion of incompatible measurable indications (also referred to as observables by those skilled in the art) to yield a classical representation.

Selection of real scale parameter W by the scaling module is important, since it pertains to the classification or ordering of all test subjects Sᵢ and also of any observer O. As the name already implies, real scale parameter W should be real-valued (i.e., not imaginary). Over and above that, real scale parameter W should correspond to a classically stable quantity that exists independently of the contextualizations experienced by the test subjects. This requirement closely parallels the one in renormalization where the scaling parameter Λ is not presumed to be an emergent property either within or anywhere near the range of validity of the Quantum Field Theory (QFT). Hence, when the UV cut-off or IR cut-off is set for any QFT in terms of say a length scale Λ⁻¹, there is no question that length itself, i.e., the linear spatial dimension, is a real parameter.

In the case of quantum representations involving test subjects that include sentient beings and even more specifically human beings, the type and definition of a classically stable quantity is considerably reformulated. Here, such quantity can be a social measure accepted by the test subjects. A non-exhaustive list of exemplary social measures includes social influence, social trust, social power, social status, social significance, religious influence, academic standing, demographic status and economic influence. Alternatively, the classically stable quantity can be more physical or even a physical measure including, for example, age, a physical ability, a physical attribute and/or any other physical measure of social significance, value or demarcation (e.g., having the status of a distinguishing characteristic).

The nature of the underlying proposition is that it is always “about something”. It is that “something that it's about” that leads to the contextualizations of the underlying proposition by the test subjects according to their frames of mind, context rules or values. In accordance with the invention, the “something that it's about” is generally one or more items that are either physical or non-physical. Exemplary items are thus commonly perceived objects or commonly perceived subjects. For example, the item can be one of the very test subject or even an observer from the point of view of a test subject. Still other type of items includes commonly perceived experiences, e.g., watching a movie or driving a car. These items need to be commonly perceived by the test subjects, where commonly specifically does not mean that they are contextualized in the same context by all test subjects. Instead, commonly as used herein means that at least in principle all test subjects are capable of apprehending the underlying proposition about the item in question. For example, if the item is the experience of driving then it is a commonly perceived item for virtually all test subjects that live in developed countries.

In tracking most contextualizations made by test subjects it will be difficult to know a priori all the available contextualizations. This will be true even when the computer system is given the underlying proposition and the item(s) that it is about. Consequently, the space of possible contextualizations, which in the quantum representation corresponds to a Hilbert space of square-integrable functions, is preferably explored before commencing any tracking of contextualizations. This is preferably done regardless of whether the tracking is practiced for the purposes of predicting, simulating or any other purposes that tracking of the contextualizations may serve. The exploration, which may be considered a calibration, calls for the deployment of a statistics module for estimating a degree of incompatibility between the contextualizations. This exploration can be assisted by an expert curator that understands the space of possible contextualizations (e.g., the curator is a test subject who has practiced many contextualizations themselves in the past). Alternatively, the exploration can be entirely data-driven and mechanical. Most preferably, a combination of these two approaches is employed. Furthermore, it is most useful to quantify the degree of incompatibility (or, alternatively and in principle equivalently) the degree of compatibility between contextualizations with the aid of commutator algebra, which is a well-known tool in the art.

Another important step in practicing the invention involves determining with a mapping module a subset of the test subjects that belong to a community. Operationally, the attribute of belonging to a community is judged based on sharing of a community values space modulo the underlying proposition. Sharing such a value space does not imply that its test subject members contextualize in the same way. It means that test subjects in that community are aware of each others' contextualizations. In other words, members of a community are cognizant of the different contextualizations that are practiced by members of their community when confronted by the underlying proposition in question. In the quantum representation the community values space is represented by a community state space [symbol] ^{(C)}, which is a subset of Hilbert space. Also, the assignment module is preferably used to determine a set of eigenvector bases, and even better a set of value matrices that encode the eigenvector bases, that are deployed by test subjects of the community in state space [symbol] ^{(C)} modulo the underlying proposition.

Appropriate computer systems capable of applying a quantum representation of contextualizations as defined above are equipped with an assignment module, a scaling module and a renormalization module. The assignment module is configured to determine the eigenvector bases corresponding to the contextualizations (i.e., finding the context matrices). It is also tasked with representing test subject states |Sᵢ [symbol] correctly, i.e., in accordance with the quantum representation. This means, among other, that test subject states |Sᵢ [symbol] can be presented in decompositions over any one of the chosen eigenvector bases. The scaling module is in charge of establishing the real scale parameter W. The renormalization module is set up for computing scale values Wᵢ associated with the test subjects. The assignment module applies the quantum representation when range ΔW of the scale values Wᵢ within the range of validity of the quantum representation that was chosen.

The present invention, including the preferred embodiment, will now be described in detail in the below detailed description with reference to the attached drawing figures.

### BRIEF DESCRIPTION OF THE DRAWING FIGURES

FIG. 1A (Prior Art) is a diagram illustrating the basic aspects of a quantum bit or qubit.

FIG. 1B (Prior Art) is a diagram illustrating the set of orthogonal basis vectors in the complex plane of the qubit shown in FIG. 1A.

FIG. 1C (Prior Art) is a diagram illustrating the qubit of FIG. 1A in more detail and the three Pauli matrices associated with measurements.

FIG. 1D (Prior Art) is a diagram illustrating the polar representation of the qubit of FIG. 1A.

FIG. 1E (Prior Art) is a diagram illustrating the plane orthogonal to a state vector in an eigenstate along the u-axis (indicated by unit vector û).

FIG. 1F (Prior Art) is a diagram illustrating a simple measuring apparatus for measuring two-state quantum systems such as electron spins (spinors).

FIG. 1G (Prior Art) is a diagram illustrating the fundamental limitations to finding the state vector of an identically prepared ensemble of spinors with single-axis measurements.

FIG. 1H (Prior Art) is a simplified Feynman diagram showing a field quantum or photon γ travelling along the null ray.

FIG. 1I (Prior Art) is an enlarged view of a space-time neighborhood around a vertex showing in the simplified Feynman diagram of FIG. 1H.

FIG. 1J (Prior Art) shows a rudimentary cubic lattice postulated in real three-dimensional space.

FIG. 2 is a diagram illustrating the most important parts and modules of a computer system according to the invention in a basic configuration.

FIG. 3A is a diagram showing in more detail the mapping module of the computer system from FIG. 2 and the inventory store of relevant items.

FIG. 3B is a flow diagram of several initial steps performed by the mapping module to generate a quantum representation.

FIG. 3C is a diagram using perspective distortion to illustrate the positing and organizing of subjects along real scale parameter W as performed by the scaling and renormalization modules of the computer system of FIG. 2.

FIG. 3D is a diagram visualizing the operation of the assignment module in formally assigning quantum states |Sᵢ [symbol] to subjects Sᵢ qualifying for quantum representation based on renormalization-related considerations.

FIG. 3E is illustrates the derivation of value matrices PR for three specific values used in contextualizations by test subjects qualified under renormalization-related considerations for tracking in the quantum representation.

FIG. 3F is a diagram using perspective distortion to illustrate the renormalization-related ordering of test subjects and an observer on scale parameter W with a contextualization expressed by value matrix PRᵥ as shown in FIG. 3E being applied to subjects within the range of validity of the quantum representation.

FIG. 3G is a diagram using perspective distortion to illustrate a re-ordering of test subjects within range of validity of the quantum representation in accordance with their expectation values under value matrix PRᵥ.

FIG. 4A is a diagram using perspective distortion to illustrate the process of collecting samples for a quantum and/or classical representation and analysis.

FIG. 4B is a diagram illustrating the differences between classical and quantum analysis of samples collected as shown in FIG. 4A and elucidates why classical analysis is not appropriate for certain samples.

### DETAILED DESCRIPTION

The drawing figures and the following description relate to preferred embodiments of the present invention by way of illustration only. It should be noted that from the following discussion, alternative embodiments of the methods and systems disclosed herein will be readily recognized as viable options that may be employed without straying from the principles of the claimed invention. Likewise, the figures depict embodiments of the present invention for purposes of illustration only.

Prior to describing the embodiments of the apparatus or computer systems and methods of the present invention it is important to articulate what this invention is not attempting to imply or teach. This invention does not take any ideological positions on the nature of the human mind or the mind of any subject that may qualify as a sentient subject or being, thus falling within the meaning of the term test subject or observer as used in the present invention. This invention also does not try to answer any philosophical questions related to epistemology or ontology. The instant invention does not attempt, nor does it presume to be able to follow up on the suggestions of Niels Bohr and actually find which particular processes or mechanisms in the brain of a subject need or should be modeled with the tools of quantum mechanics. This work is also not a formalization of the theory of personality based on a correspondent quantum representation. Such formalization may someday follow, but would require a full formal motivation of the transition from Bayesian probability models to quantum mechanical ones. Formal arguments would also require a justification of the mapping between non-classical portions of subject/human emotional and thought spaces/processes and their quantum representation. The latter would include a description of the correspondent Hilbert space, including a proper basis, support, rules for unitary evolution, formal commutation and anti-commutation relations between observables as well as explanation of which aspects are subject to entanglement with each other and the environment (decoherence).

Instead, the present invention takes a highly data-driven approach to tracking select subject, which are herein referred to as test subjects. The quantum states will be assigned to these test subjects modulo or with respect to underlying propositions using pragmatic state vector assignments. In some implementations, the state vectors can be represented by quantum bits or qubits.

The availability of “big data” that documents online life, and in particular online as well as real-life responses of subjects to various propositions including simple “yes/no” type questions, has made extremely large amounts of subject data ubiquitous. The test subjects can thus be isolated out of the large numbers of potentially available subjects based on measured data. Now, quantum mechanical tests require large numbers of identically or at least similarly prepared states to examine in order to ascertain any quantum effects. For the first time, these practical developments in “big data” and the capture of massive numbers of measurements permit one to apply the tools of quantum mechanics to uncover such quantum aspects of test subject behaviors or measureable indications as they manifest when confronted by underlying propositions, i.e., as a result of contextualizations. Specifically, it is finally feasible to set up a quantum mechanical model of test subject states and check for signs of quantum mechanical relationships and quantum mechanical statistics in the context of certain propositions that the test subjects perceive.

Thus, rather than postulating any a priori relationships between different states, e.g., the Jungian categories, we only assume that self-reported or otherwise obtained/derived data about test subjects and their contextualizations of underlying propositions of interest is reasonably accurate. In particular, we rely on the data to be sufficiently accurate to permit the assignment of state vectors or qubits to the test subjects. We also assume that the states suffer relatively limited perturbation and that they do not evolve quickly enough over time-frames of measurement(s) (long decoherence time) to affect the model. Additional qualifications as to the regimes or realms of validity of the model will be presented below with reference to renormalization-related considerations.

No a priori relationships between different state vectors or qubits representing test subjects and their contextualizations of propositions is presumed. Thus, the assignment of state vectors or qubits in the present invention is performed in the most agnostic manner possible. This is done prior to testing for any complicated relationships. Preferably, the subject state assignments with respect to the underlying proposition are first tested empirically based on historical data available for the subjects. In this manner the correct set of test subjects can be isolated. Curation of relevant metrics is performed to aid in the process of discovering quantum mechanical relationships in the data. The curation step preferably includes a final review by human experts or expert curators that may have direct experience of relevant state(s) as well as well as experience(s) when confronted by the underlying propositions under investigation. Specifically, the human curator should have a “personal understanding” of the various ways in which the underlying proposition may be contextualized by the different test subjects that are being selected for tracking in accordance with the invention.

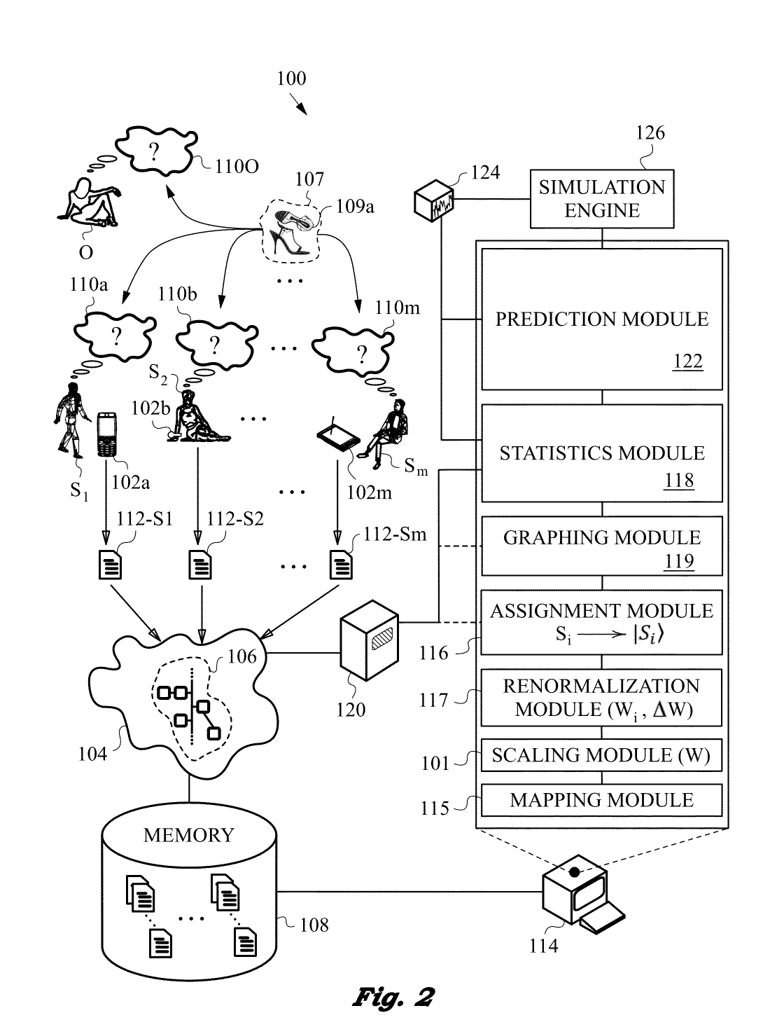

The main parts and modules of an apparatus embodied by a computer system 100 designed for tracking the behaviors of test subjects is illustrated in FIG. 2. Computer system 100 is designed around a number of test subjects S₁, S₂, . . . , Sₘ. For convenience, test subjects S₁, S₂, . . . , Sₘ will be enumerated with the aid of index i thus referring to test subjects Sᵢ, where i=1, 2, . . . , m and m is the total number of test subjects. A certain special subject is designated as observer O. Observer O is the subject from whose perspective or viewpoint the tracking performed by system 100 will be viewed.

All test subjects Sᵢ and observer O in the present embodiment are human beings. They may be selected here from a much larger group of many subjects that are not expressly shown. In the subsequent description some of these additional subjects that were not chosen as test subjects will be introduced separately. In principle, test subjects Sᵢ and observer O can embody any sentient beings other than humans, e.g., animals. However, the efficacy in applying the methods of invention will usually be highest when dealing with human subjects.

Test subject S₁ has a networked device 102a, here embodied by a smartphone, to enable him or her to communicate data about them in a way that can be captured and processed. In this embodiment, smartphone 102a is connected to a network 104 that is highly efficient at capturing, classifying, sorting, and storing data as well as making it highly available. Thus, although test subject S₁ could be known from their actions observed and reported in regular life, in the present case test subject S₁ is known from their online presence and communications as documented on network 104.

Similarly, test subject S₂ has a networked device 102b, embodied by a smart watch. Smart watch 102b enables test subject S₂ to share personal data just like test subject S₁. For this reason, watch 102b is also connected to network 104 to capture the data generated by test subject S₂. Other test subjects are similarly provisioned, with the last or m-th test subject Sₘ shown here deploying a tablet computer with a stylus as his networked device 102m. Tablet computer 102m is also connected to network 104 that captures data from subjects. The average practitioner will realize that any networked device can share some aspect of the subject's personal data. In fact, devices on the internet of things, including simple networked sensors that are carried, worn or otherwise coupled to some aspect of the subject's personal data (e.g., movement, state of health, or other physical or emotional parameter that is measurable by the networked sensor) are contemplated to belong to networked devices in the sense of the present invention.

Network 104 can be the Internet, the World Wide Web or any other wide area network (WAN) or local area network (LAN) that is private or public. Furthermore, some or all test subjects Sᵢ may be members of a social group 106 that is hosted on network 104. Social group or social network 106 can include any online community such as Facebook, LinkedIn, Google+, MySpace, Instagram, Tumblr, YouTube or any number of other groups or networks in which test subjects Sᵢ are active or passive participants. Additionally, documented online presence of test subjects Sᵢ includes relationships with product sites such as Amazon.com, Walmart.com, bestbuy.com as well as affinity groups such as Groupon.com and even with shopping sites specialized by media type and purchasing behavior, such as Netflix.com, iTunes, Pandora and Spotify. Relationships from network 106 that is erected around an explicit social graph or friend/follower model are preferred due to the richness of relationship data that augments documented online presence of test subjects Sᵢ.

Computer system 100 has a memory 108 for storing measurable indications a, b that correspond to state vectors or just simply states |Sᵢ [symbol] in internal spaces 110a, 110b, . . . , 110j of test subjects Sᵢ defined modulo an underlying proposition 107. In accordance with the present invention, measurable indications a, b are preferably chosen to be mutually exclusive indications. Mutually exclusive indications are actions, responses or still other indications that test subjects Sᵢ cannot manifest simultaneously. For example, measurable indications a, b are mutually exclusive when they correspond to “YES”/“NO” type responses, choices, actions or any other measurable indications of which test subjects Sᵢ can manifest just one at a time with respect to underlying proposition 107. Test subjects Sᵢ also preferably report, either directly or indirectly (in indirect terms contained in their on-line communications) their measurable indications via their networked devices 102a, 102b, . . . , 102j.

It should be duly noted that it is not a limitation of the quantum representation adopted herein to require that measurable indications come in pairs, such as measurable indications a, b in the present example. Measurable indications can span many values, as any person skilled in the art will recognize. It is also not a limitation that the values of such pairs exhibit discrete precipitation type; they may instead cover a continuous range. The reader is referred to the teachings contained in U.S. patent application Ser. No. 14/324,127 to review why the choice of measurable indications that precipitate as pairs of discrete values, and in particular as mutually exclusive pairs is advantageous.

In the first example, underlying proposition 107 is associated with an item that is instantiated by a specific object 109a. It is noted that specific object 109a is selected here in order to ground the rather intricate quantum-mechanical explanation to follow in a very concrete setting for purposes of better understanding and more practical teaching of the invention. Thus, underlying proposition 107 revolves around object 109a being a pair of shoes that test subjects Sᵢ have been exposed to on their home log-in pages to network 104. For example, the log-in page could have been Yahoo News and shoes 109a were presented next to typical items such as Khardashians or Snookies.

The nature of any underlying proposition in the sense of the invention is that it is “about something”. It is that “something that it's about” that leads to the contextualizations of the underlying proposition by test subjects Sᵢ according to their frames of mind, context rule(s) or, most generally put, their values. The “something that it's about” is generally one or more items that are either physical or non-physical. In the present example the item is instantiated by an object, namely shoes 109a. However, items can be any commonly perceived objects or even commonly perceived subjects.

For example, a legitimate item can be one of test subjects Sᵢ or even observer O from the point of view of any test subject. Still another permissible type or category of items includes non-physical or experiential goods such as commonly perceived experiences. The experience of watching a movie, flying a kite, meeting a subject, driving a car and so on are therefore legitimate items. It is important, however, that qualifying items be commonly perceived by test subjects Sᵢ.

By commonly perceived we specifically do not mean that they are contextualized according to the same value by all test subjects Sᵢ. Instead, commonly as used herein means that at least in principle all test subjects Sᵢ are capable of apprehending the underlying proposition about the item in question. For example, if the item is the experiential good of driving a car, then it is a commonly perceived item for virtually all test subjects Sᵢ that live in developed countries. On the other hand, if the experiential good is a religious conversion to a specific deity then, most likely, only test subjects Sᵢ that belong to that religious group commonly perceive that item. It is on this common perceptual basis that inclusion of just any subjects in general for the purpose of tracking is usually not productive. For this reason, it is advantageous to carefully select nor vet test subjects Sᵢ that are known to commonly perceive the item(s) that are used in formulating the underlying proposition(s) before commencing any tracking.

The term contextualiation will be used herein to denote a process. It is the process that commences with a subject being exposed to or confronted with an underlying proposition. The subject is free to apprehend, perceive, understand, evaluate and/or value in any of the number of personal ways that the subject can select. This confrontation of any subject including the test subjects we are interested in by the underlying proposition as well as that test subject's choice about how or in accordance with what value to make sense of the underlying proposition will be referred to herein as a contextualization of the underlying proposition by that test subject.

Typically, many different contextualizations of the same underlying proposition are available to any one of test subjects Sᵢ. Some of the available contextualizations are incompatible. These will later be represented by non-commuting quantum mechanical operators introduced by the quantum representation according to the invention. Some other available contextualizations are compatible. These, on the other hand, will later be represented by commuting quantum mechanical operators.

One of the main aspects of the present invention relates to enabling computer system 100 to track the behaviors of test subjects Sᵢ generated in response to contextualizations. We are interested in behaviors generated irrespective of the type of contextualizations actually experienced by test subjects. More precisely still, system 100 is designed to track measurable indications a, b that include any type of behavior, action, response or any other indication that can be measured or reported within the framework set up by computer system 100. From the point of view of the quantum representation, measurable indications are measurements. Measurements are the real-valued results that manifest or emerge as fact in response to quantum measurement. The nature of measurable indications generated as a result of contextualizations of underlying proposition 107 by test subjects Sᵢ will be discussed in much more detail below.

In the present embodiment, measurable indications a, b are captured in data files 112-S1, 112-S2, . . . , 112-Sm that are generated by test subjects Sᵢ respectively. Conveniently, following socially acceptable standards, data files 112-S1, 112-S2, . . . , 112-Sm are shared by test subjects Sᵢ with network 104 by transmission via their respective networked devices 102a, 102b, . . . , 102m. Network 104 either delivers data files 112-S1, 112-S2, . . . , 112-Sm to any authorized network requestor or channels it to memory 108 for archiving and/or later use. Memory 108 can be a mass storage device for archiving all activities on network 104, or a dedicated device of smaller capacity for tracking just the activities of some subjects of which test subjects Sᵢ are a subset.

It should be pointed out that in principle any method or manner of obtaining the chosen measurable indications, i.e., either a or b, from test subjects Sᵢ is acceptable. Thus, the measurable indications can be produced in response to direct questions posed to test subjects Sᵢ, a “push” of prompting message(s), or externally unprovoked self-reports that are conscious or even unconscious (e.g., when deploying a personal sensor as the networked device that reports on some body parameter such as, for example, heartbeat). Preferably, however, the measurable indications are delivered in data files 112-S1, 112-S2, . . . , 112-Sm generated by test subjects Sᵢ. This mode enables efficient collection, classification, sorting as well as reliable storage and retrieval from memory 108 of computer system 100. The advantage of the modern connected world is that large quantities of self-reported measurable indications of states |Sᵢ [symbol] in internal spaces 110a, 110b, . . . , 110j are generated by test subjects Sᵢ and shared, frequently even in real time, with network 104. This represents a massive improvement in terms of data collection time, data freshness and, of course, sheer quantity of reported data.

Test subjects Sᵢ can either be aware or not aware of their respective measurable indications. For example, data files 112-S1, 112-S2, . . . , 112-Sm of test subjects Sᵢ reporting of their responses, actions or other indications can be shared among subjects Sᵢ such that everyone is informed. This may happen upon request, e.g., because test subjects Sᵢ are fiends in social network 106 and may have elected to be appraised of their friends' responses, actions and other indications such as parameters of their well-being (e.g., those measured by personal sensors mentioned above), or it may be unsolicited. The nature of the communications broadcasting the choices can be one-to-one, one-to-many or many-to-many.

In principle, any mode of communication between test subjects Sᵢ is permissible including blind, one-directional transmission. For this reason, in the present situation any given subject can be referred to as the transmitting subject and another subject can be referred to as the receiving subject to more clearly indicate the direction of communication in any particular case. Note that broadcasts of responses, actions or other indications from the subjects need not be carried via network 104 at all. They may occur via any medium, e.g., during a physical encounter between transmitting and receiving test subjects or by the mere act of one subject observing the chosen response, action or other indication of another subject. Indeed, as mentioned above, the method of the invention can be practiced in situations where no inter-subject communications take place at all and all test subjects Sᵢ merely report their measurable indications via network 104.

When inter-subject communications takes place, the exposure of receiving subjects to broadcasts of transmitting subjects carrying any type of information about the transmitter's choice of measurable indication vis-à-vis underlying proposition 107 may take place online or offline (e.g., in real life). Preferably, however, all broadcasts are carried via network 104 or even within social network 106, if all transmitting and receiving test subjects Sᵢ are members of network 106.

Computer system 100 is equipped with a separate computer or processor 114 for making a number of crucial assignments based on measurable indications a, b contained in data files 112-S1, 112-S2, . . . , 112-Sm of test subjects Sᵢ. For this reason, computer 114 is either connected to network 104 directly, or, preferably, it is connected to memory 108 from where it can retrieve data files 112-S1, 112-S2, . . . , 112-Sm at its own convenience. It is noted that the quantum representation underlying the present invention will perform best when large amounts of data are available. Therefore, it is preferred that computer 114 leave the task of storing and organizing data files 112-S1, 112-S2, . . . , 112-Sm as well as any relevant data files from other subjects to the resources of network 104 and memory 108, rather than deploying its own resources for this job.

Computer 114 has a mapping module 115 for finding an internal space or a values space that is shared by test subjects Sᵢ. Module 115 can be embodied by a simple non-quantum unit that compares records from network 104 and or social network 106 to ascertain that test subjects Sᵢ are friends or otherwise in some relationship to one another. Based on this relationship and/or just propositions over which test subjects Sᵢ have interacted in the past, mapping module 115 can find the shared or common internal space that will henceforth be referred to herein as community values space. It is important that mapping module 115 confirm that the community values space is shared modulo underlying proposition 107 in particular.

The community values space corresponds to a regime or realm of shared excitements, interests, proclivities, beliefs, likes, dislikes and/or opinions over various items represented, among other, by objects, subjects or experiences (e.g., activities). For the sake of a simple example, all test subjects Sᵢ that are candidates for the subset which can be considered as a community can be interested in shoes, sports, coffee, car racing, movies, dating and making money. In most practical applications, however, it will be sufficient to confirm that test subjects Sᵢ are aware of the same items. This means that they perceive these items in the community values space common to the subset/community of test subjects Sᵢ. Of course, that certainly does not mean that all test subjects Sᵢ will or are even likely to contextualize the underlying propositions about the items of which they are all aware in the same way. The meaning of this last statement will be explained in much more detail below.

Computer 114 has a scaling module 101 connected to mapping module 115. Scaling module 101 is configured to receive the output of mapping module 115, namely the selection of test subjects Sᵢ that share a common values space. The task of scaling module 101 is to establish a real scale parameter W that will be used to classify or organize test subjects Sᵢ. It is important that the choice of real scale parameter W by scaling module 101 be based on a commonly accepted metric that is accepted or agreed upon by all or virtually all test subjects Sᵢ. Unlike item(s) forming underlying propositions, real scale parameter W should not provoke contextualizations by test subjects Sᵢ. In other words, scale parameter W should be a metric that is commonly accepted by test subjects Sᵢ irrespective of their likes and dislikes and not subject to value judgment. Thus, real scale parameter W should be an unquestionable, classically stable quantity or stable parameter not subject to re-evaluation by test subjects Sᵢ in their community values space.

More precisely yet, real scale parameter W is a renormalization-related parameter inspired by scale parameter Λ (see Background Section). In contrast to scale parameter Λ as employed in QFT, however, quantum representations involving test subjects that include sentient beings and even more specifically human beings, induce a reformulation. The reformulation is due to the nature of the mapping of the quantum representation onto subjects and their contextualizations. Under these conditions, scale parameter W is preferably a social measure accepted by test subjects Sᵢ. A non-exhaustive list of exemplary social measures includes social influence, social trust, social power, social status, social significance, religious influence (including all types of cults and other groups based on the cult-of-personality), academic standing, demographic status and economic influence.

Alternatively, the classically stable quantity qualifying as real scale parameter W can be a more physical measure or even an actual physical measure. The best physical measures are those by which all test subjects Sᵢ can be classified in an unambiguous manner that all would recognize as valid. In typical human societies such measures include age, a physical ability, a physical attribute and/or any other physical measure of social significance, value or demarcation (e.g., having the status of a distinguishing characteristic). Excellent example metrics are those used by governments and institutions to classify populations of subjects. In most cases these include age, height, weight, sex, affiliations, family status, occupational status, income level, provenance. Several exemplary scale parameters W derived from a social measure accepted by test subjects Sᵢ or physical measures will be reviewed below in association with embodiments of the apparatus and methods of the invention.

Computer 114 is equipped with a renormalization module 117 that is connected to scaling module 101. Renormalization module 117 is designed for positing the selected subset of test subjects Sᵢ that belong to the community by virtue of sharing a community values space modulo proposition 107. The action of positing is connected with the quantum mechanical action associated with the application of creation operators. Also, annihilation operators are used for un-positing or removing of test subjects Sᵢ from consideration.

The creation and annihilation aspects of the operation of renormalization module 117 are required for formal positing of the state vectors corresponding to quantized entities. These steps depend on whether the entity obeys the Fermi-Dirac anti-consensus statistics (F-D statistics) or the Bose-Einstein consensus statistics (B-E statistics) as well as several other considerations due to the quantum mechanical representation. All of these aspects have been previously described in detail in U.S. patent application Ser. No. 14/324,127. They will only be touched upon as required to contextualize the present invention. Meanwhile, the renormalization aspect of the operation of renormalization module 117 will be discussed in detail below.

Renormalization module 117 is used to compute scale values Wᵢ associated to test subjects Sᵢ in terms of scale parameter W that was selected by scaling module 101. Typically, scale values Wᵢ will exhibit a certain spread or range ΔW. That is because a typical group of test subjects Sᵢ that qualifies as a community based on a shared values space is not at all expected to all have the same scale value. In fact, range ΔW of scale values Wᵢ may even be relatively large in some embodiments. For example, when scale parameter W selected by scaling module 101 is economic influence in terms of yearly earnings denominated in currency, such as dollars, range ΔW may be on the order of $100's, $1,000's, $10,000's or even $100,000's.

Further, computer 114 has an assignment module 116 that is connected to renormalization module 117. Assignment module 116 is designed for the task of making certain assignments based on the quantum representations adopted by the instant invention. More precisely, assignment module is tasked with assigning to each one of the selected test subjects Sᵢ discovered by mapping module 115 and posited by renormalization module 117 a test subject state |Sᵢ [symbol] . All assigned test subject states |Sᵢ [symbol] reside in a community state space [symbol] ^{(C)}, which is the Hilbert space associated with the community values space.

The quantum representation adopted herein requires that each test subject state |Sᵢ [symbol] be a quantum state and that the community state space [symbol] ^{(C)} be a Hilbert space. Further, assignment module 116 extends the quantum representation by assigning an observer state |O [symbol] in an observer state space [symbol] ^{(O)} that is associated with an internal state of observer O and is related to the contextualization of underlying proposition 107 by observer O. The details of the quantum representation leading to these assignments are discussed below.

Assignment module 116 is indicated as residing in computer 114, but in many embodiments it can be located in a separate processing unit altogether. This is mainly due to the nature of the assignments being made and the processing required. More precisely, assignments related to quantum mechanical representations are very computationally intensive for central processing units (CPUs) of regular computers. In many cases, units with graphic processing units (GPUs) are more suitable for implementing the linear algebra instructions associated with assignments dictated by the quantum model that assignment module 116 has to effectuate.

In accordance with the concepts inspired by renormalization in QFT, it is expected that there is a range of validity to the quantum representation. This means that range ΔW of scale values Wᵢ describing test subjects Sᵢ has to reside within a range of validity of the chosen quantum representation in order to justify its application by assignment module 116. The postulation of ranges of validity for quantum representations as applied herein to test subjects Sᵢ is related to renormalization as understood in modern physics. Specifically, renormalization in standard Quantum Field Theories (QFTs) shows that some QFTs have a range of validity defined between an upper cut-off (IR cut-off) and a lower cut-off (UV cut-off) defined on a real scaling parameter typically referred to as Λ.

According to the invention, we associate a range of validity to any chosen quantum representation of test subjects Sᵢ and their contextualizations. The range of validity is postulated to have a lower cut-off and an upper cut-off expressed by corresponding values of real scale parameter W. In QFT systems ranges of validity can be studied exhaustively in terms of cut-offs, critical exponents and universality classes. The definitions of upper and lower cut-offs on scale parameter W are not presumed to be strict in the quantum representations adopted herein. Instead, these cut-offs are expected to be more qualitative in nature. They are to be set based purely on experimental data collected from subjects Sᵢ by system 100. In fact, the present invention should also be considered as providing the exploratory tools and motivation for finding the cut-offs. In practice, it will be sufficient to ensure that range ΔW of scale values Wᵢ describing test subjects Sᵢ reside within the range of validity. The examples below will provide more guidance on this point.

Computer system 100 has a graphing module 119 connected to assignment module 116. Computer 114 deploys graphing module 119 for placing test subject states |Sᵢ [symbol] , as assigned by assignment module 116, on a graph or any construct that encodes the interconnections that exist between test subjects Sᵢ. In addition, graphing module can also place observer state |O [symbol] , as assigned to observer O by assignment module 116. In cases where the interconnections are tenuous, uncertain or even unknown, graphing module 119 may place test subject states |Sᵢ [symbol] in a disconnected context (i.e., on nodes/vertices without any connecting edges). Lack of interconnections indicates no inter-subject communications. However, all subject states |Sᵢ [symbol] are still organized at least along scale parameter W by their scale values Wᵢ.

In cases where interconnections are known, e.g., from a social graph that interconnects test subjects Sᵢ, graphing module 119 places test subject states |Sᵢ [symbol] of test subject states Sᵢ at the corresponded nodes or vertices of the social graph. In general, however, the mapping as understood herein reaches beyond the concept of one subject per vertex in a social graph setting—in this larger context the mapping is understood to be a surjective mapping. In other words, the mapping is onto the graph but not typically one-to-one. Graphs as defined herein include any type of structures that include interconnections, e.g., links or edges, between entities that may be related to one or more vertices, nodes or points. For example, the graph may be a social graph, a tree graph, a general interconnected diagram or chart (also see graph theory and category theory). In some embodiments described herein the chosen graph corresponds to a physical system, such as a lattice or other less-organized structures such as spin-glass. Various aspects of the graphing or mapping process including adjustments and simplifications (e.g., pruning) have been previously discussed in U.S. patent application Ser. No. 14/324,127. Therefore, only the aspects of graphing most relevant to the present invention and the below examples will be discussed herein.

Computer 114 also has a statistics module 118 connected to graphing module 119. Statistics module 118 is designed for estimating various fundamental quantum parameters of the graph model that lead to classical probabilities and/or large-scale phenomena and behaviors. In some embodiments statistics module 118 also estimates or computes classical probabilities. Most importantly, however, statistics module 118 estimates a degree of incompatibility between the values according to which test subjects Sᵢ contextualize underlying propositions of interest in the social values space or rather in its quantum equivalent—community state space [symbol] ^{(C)}. In any specific case, the estimate is also important in determining how underlying proposition 107 about item 109a is contextualized by community subjects Sᵢ versus how observer O contextualizes underlying proposition 107. Knowing this difference will be relevant to how a view of the results will be presented.

Computer 114 is further provisioned with a prediction module 122 that is in turn connected to statistics module 118. The quantum interactions between the various quantum states |Sᵢ [symbol] and potentially |O [symbol] thus imported onto the graph by graphing module 119 are used by prediction module 122 for predicting subject states |Sᵢ [symbol] about underlying proposition 107. Prediction module 122 is connected to statistics module 118 in order to receive the estimated probabilities and value information. Of course, it also receives as input the data generated and prepared by the previous modules, including data about the graph generated by graphing module 119 based on still prior inputs from assignment module 116, renormalization module 117, scaling module 101 and mapping module 115.

Prediction module 122 can reside in computer 114, as shown in this embodiment or it can be a separate unit. For reasons analogous to those affecting assignment module 116, prediction module 122 can benefit from being implemented in a GPU with associated hardware well known to those skilled in the art.

Computer system 100 has a network behavior monitoring unit 120. Unit 120 monitors and tracks at the very least the network behaviors and communications of test subjects Sᵢ in the identified community and, potentially also of observer O, especially if the latter is also a subject on network 104. Network behavior monitoring unit 120 preferably monitors entire network 104 including members of specific social groups 106. When specific test subjects Sᵢ and observer O are selected for tracking and for any subsequent model, simulation and/or prediction, they thus fall into a subset of all subjects tracked by behavior monitoring unit 120. To be effective, unit 120 is preferably equipped with wire-rate data interception capabilities for rapid ingestion and processing. This enables unit 120 to capture and process data from data files 112 of large numbers of subjects connected to network 104 and discern large-scale patterns in nearly real-time.

Statistics module 118 is connected to network behavior monitoring unit 120 to obtain from it information for maintaining up-to-date its classical event probabilities as well as quantum parameters, especially including subject contextualizations. It is duly noted, that computer 104 can gather relevant information about the subjects on its own from archived data files 112 in memory 108. This approach is not preferred, however, due to concerns about data freshness and the additional computational burden placed on computer 104.

Computer system 100 has a random event mechanism 124 connected to both statistics module 118 and prediction module 122. From those modules, random event mechanism can be seeded with certain estimated quantum parameters as well as other statistical information, including classical probabilities to randomly generate events on the graph in accordance with those probabilities and statistical information. Advantageously, random event mechanism 124 is further connected to a simulation engine 126 to supply it with input data. In the present embodiment simulation engine 126 is also connected to prediction module 122 to be properly initialized in advance of any simulation runs. The output of simulation engine 126 can be delivered to other useful apparatus where it can serve as input to secondary applications such as large-scale tracking, modeling, simulation and/or prediction mechanisms for social or commercial purposes or to market analysis tools and online sales engines. Furthermore, simulation engine 126 is also connected to network behavior monitoring unit 120 in this embodiment in order to aid unit 120 in its task in discerning patterns affecting test subjects Sᵢ and observer O (as well as other subjects, as may be required) based on data passing through network 104.

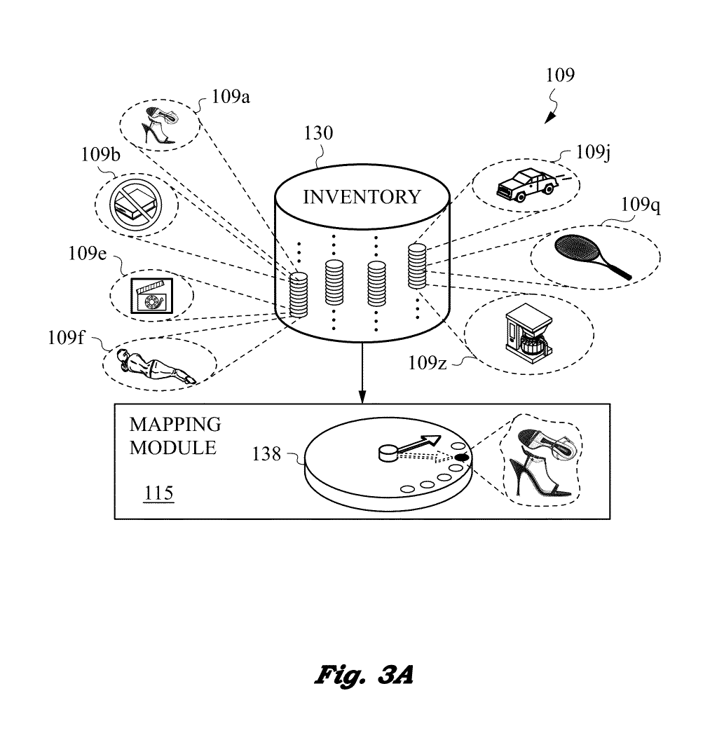

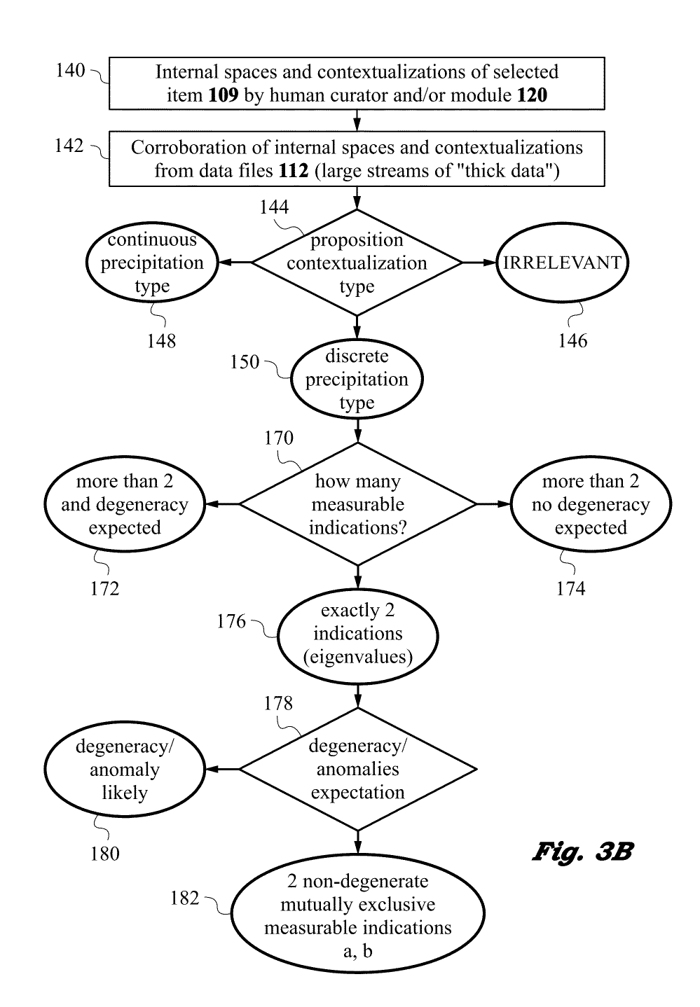

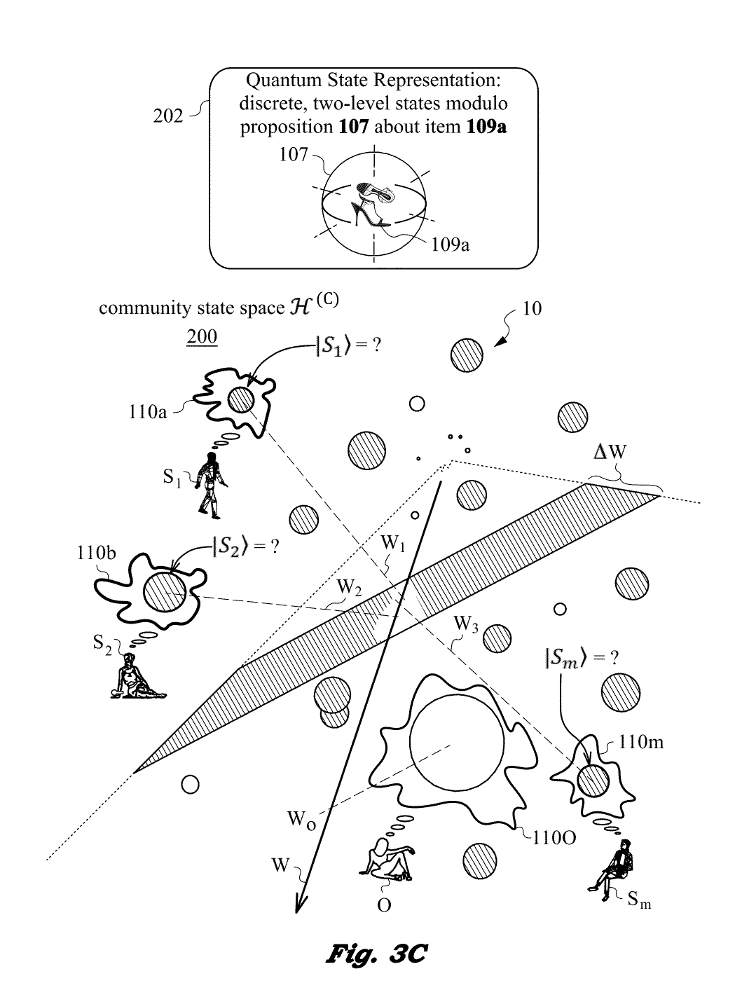

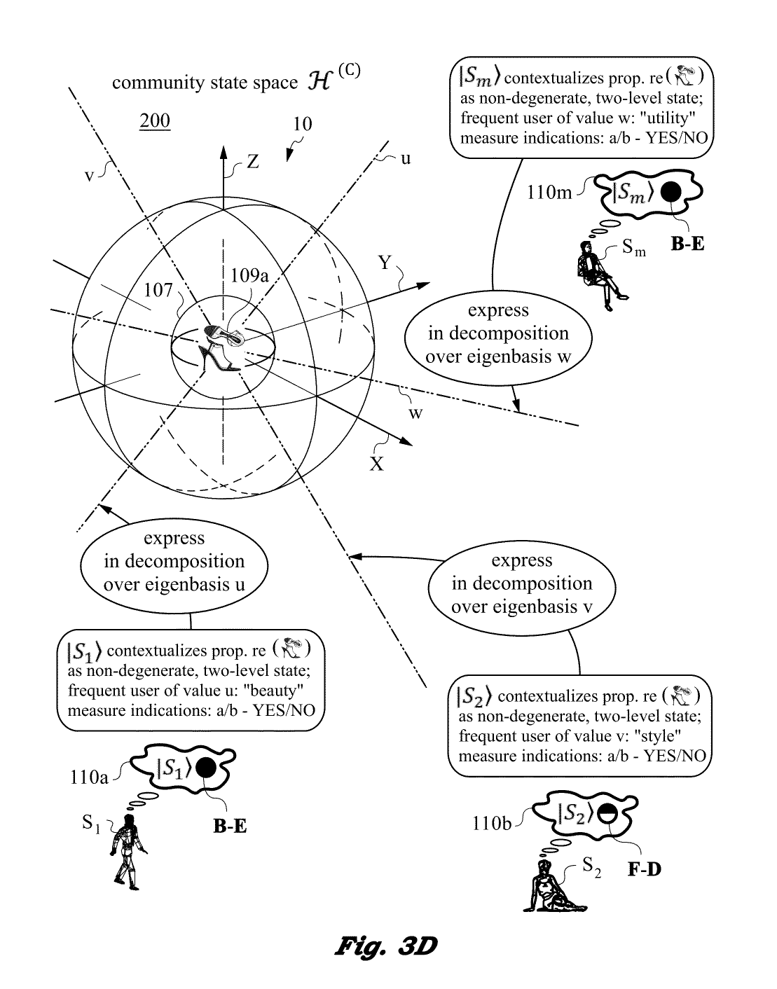

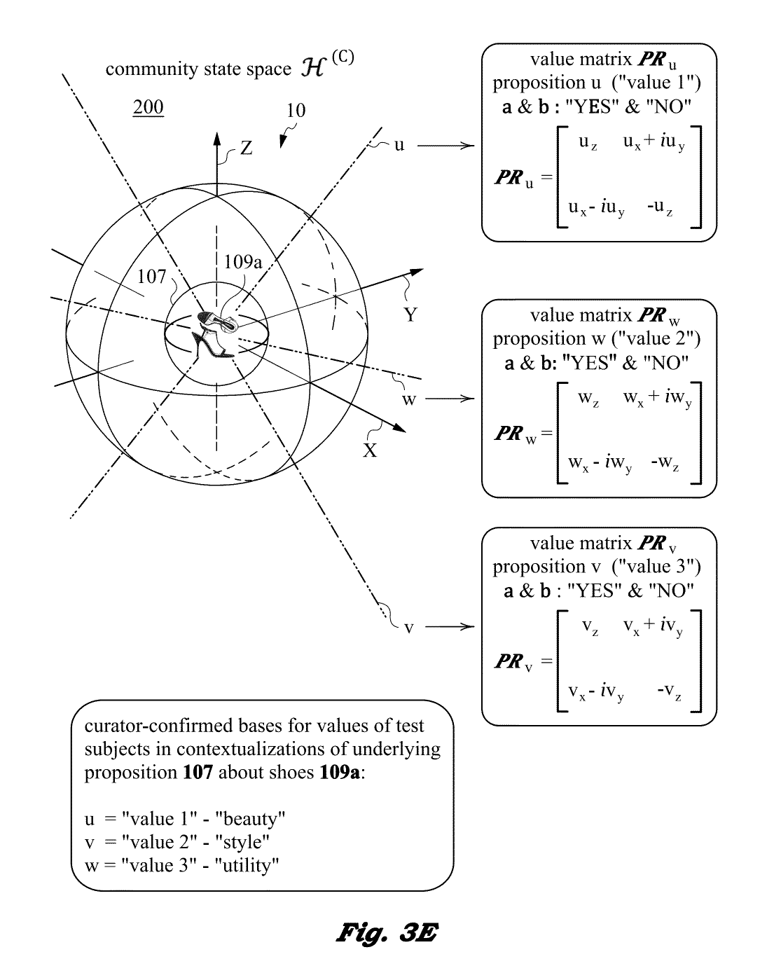

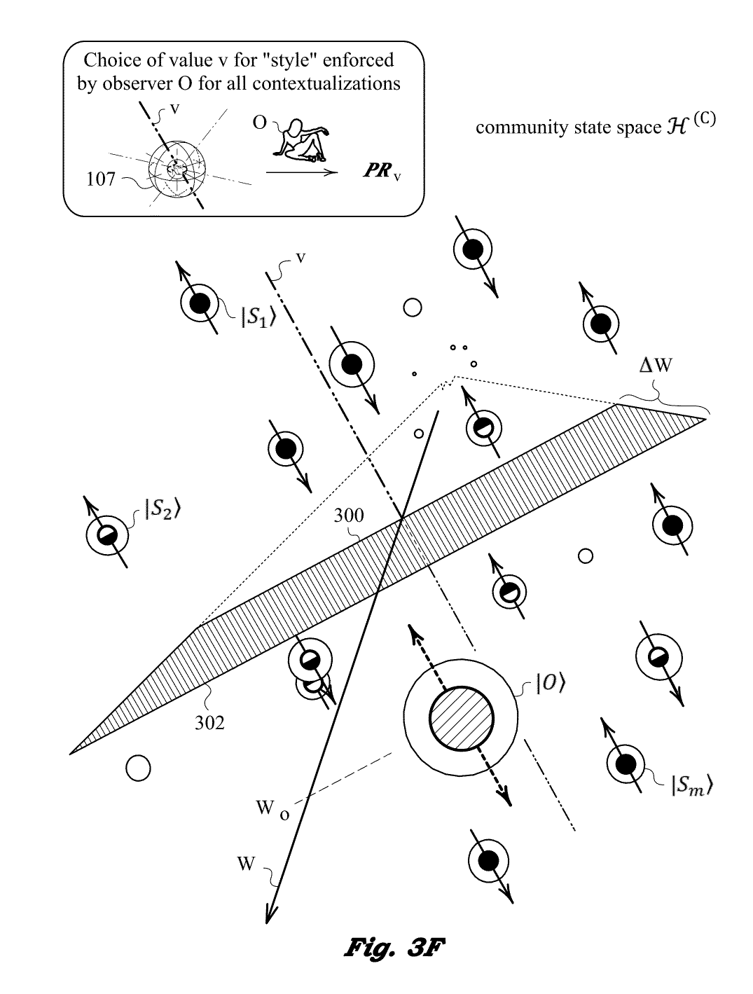

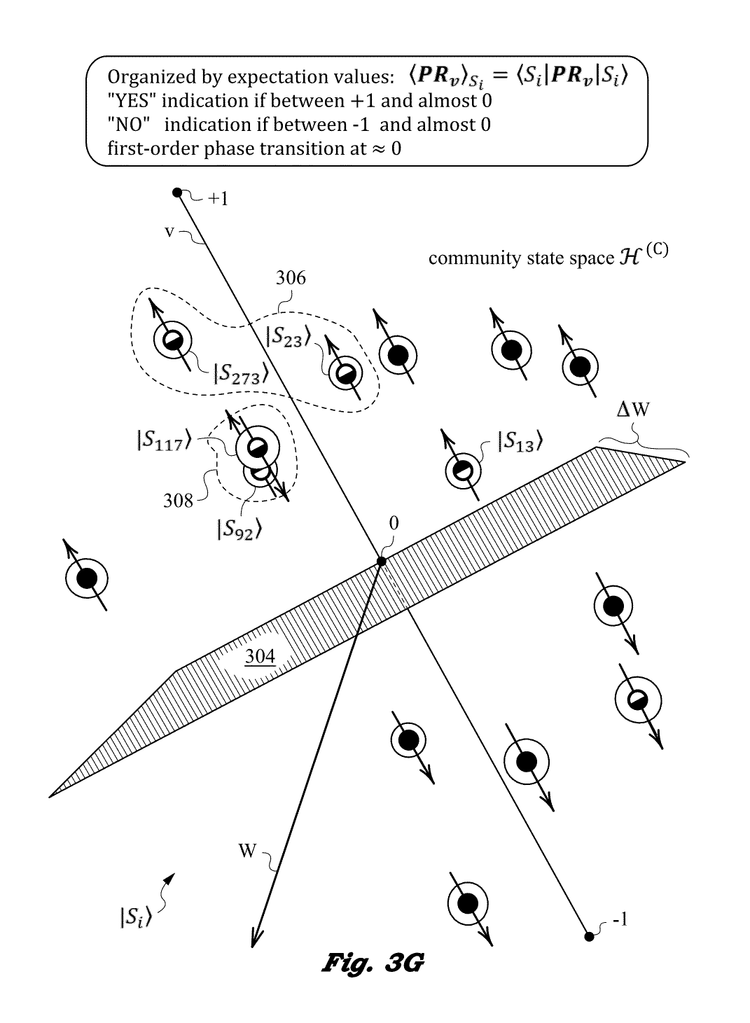

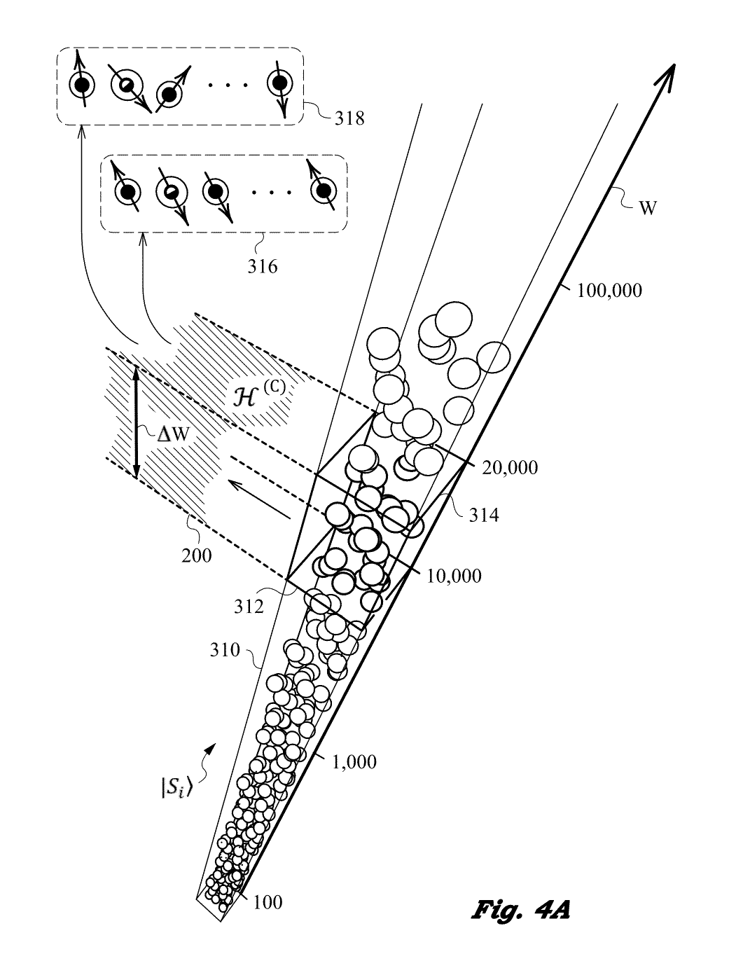

We will now examine the operation of computer system 100 in incremental steps guided by the functions performed by the modules introduced in FIG. 2 and any requisite secondary resources. Our starting point is mapping module 115 in conjunction with an inventory store 130 to which it is connected as shown in FIG. 3A. Computer system 100 is designed to test many underlying propositions 107 about different items 109. In other words, item 109a that is an object instantiated by the pair of shoes depicted in FIG. 2 is merely one exemplary object that is used for the purpose of a more clear and practical explanation of the present invention.

Meanwhile, inventory store 130 contains a large number of eligible items. As understood herein, items 109 include objects, subjects, experiences (aka experiential goods) and any other items that test subjects Sᵢ and observer O can contextualize in their minds to yield underlying proposition 107. Preferably, a human curator familiar with human experience and specifically with the lives and cognitive expectations of subjects under consideration should review the final inventory of items 109. The curator should not include among items 109 any that do not register any response, i.e., those generating a null response among the subjects. Responses obtained in a context that is not of interest may be considered as mis-contextualized and the item that provokes them should be left out if their consideration is outside the scope of tracking. All null responses and mis-contextualizations should preferably be confirmed by prior encounters with the potentially irrelevant item by test subjects Sᵢ and observer O. The curator may be able to further understand the reasons for irrelevance and mis-contextualization to thus rule out the specific item from inventory store 130.

For example, a specific item 109b embodied by a book about ordinary and partial differential equations is shown as being deselected in FIG. 3A. The elimination of book 109b is affirmed by the human curator, who understands the human reasons for the book's lack of appeal. In the case at hand, all subjects reporting on network 104 are members of a group that does not consider the language of mathematics relevant to their lives. Thus, most of the time that book 109b is encountered by the subjects it evokes a null response as they are unlikely to register its existence. The possible exception is in the case of unanticipated contextualization, e.g., as a “heavy object” for purposes of “weighing something down”. If the prediction does not want to take into account such mis-contextualization then book 109b should be left out. If, on the other hand, contextualization of textbooks as heavy objects were of interest in tracking, then book 109b should be kept in inventory store 130.

It is also possible to supplement or, under some circumstances even replace the vetting of items 109 by a human curator with a cross-check deploying network behavior monitoring unit 120. That is because monitoring unit 120 is in charge of reviewing all data files 112 to track and monitor communications and behaviors of all subjects on network 104. Hence, it possesses the necessary information to at the very least supplement human insights about reactions to items 109 and their most common contextualizations. For example, despite the intuition of the human curator book 109b could have provoked a reaction and anticipated contextualization, e.g., as a study resource, by at least a few subjects. Such findings would be discovered by network behavior monitoring unit 120 in reviewing data files 112. These findings should override the human curator's judgment in a purely data-driven approach to tracking. Such pragmatism is indeed recommended in the preferred embodiments of the present invention to ensure discovery of quantum effects and derivation of correspondent practical benefits from these findings.

After vetting by the human curator and corroboration by network behavior monitoring unit 120, inventory store 130 will contain all items of interest to the subjects and presenting to them in contextualizations that are within the scope of tracking. For example, items 109a, 109q and 109z from store 130 all fall into the category of objects embodied here by shoes, a tennis racket and a coffee maker. A subject 109f embodied by a possible romantic interest to one or more test subjects Sᵢ and observer O to be confronted by proposition 107 is also shown. Further, store 130 contains many experiential goods of which two are shown. These are experiences 109e, 109j embodied by watching a movie and taking a ride in a sports car, respectively. Numerous other objects, subjects and experiences are kept within store 130 for building different types of underlying propositions 107.

In order to follow the next steps with reference to a concrete example to help ground the explanation, we consider shoes 109a that were chosen by mapping module 115 from among all vetted items 109 in inventory store 130. To make the choice module 115 has a selection mechanism 138. Mechanism 138 is any suitable apparatus for performing the selection among items 109 in store 130. It is noted that selection mechanism 138 can either be fully computer-implemented for picking items 109 in accordance with a computerized schedule or it can include an input mechanism that responds to human input. In other words, mechanism 138 can support automatic or human-initiated selection of items 109 for tracking of contextualizations under the quantum representation of the present invention.

FIG. 3B illustrates the steps performed by mapping module 115 in further examining the internal spaces 110a, 110b, . . . , 110m of subjects Sᵢ and their contextualizations. More precisely, mapping module 115 takes the first formal steps to treating these concepts in accordance with a quantum representation as adopted herein. Any specific quantum representation will apply in the community values space postulated to exist between test subjects Sᵢ and potentially also observer O. It should be remarked here that all steps performed to arrive at a quantum representation of test subjects Sᵢ in their contextualizations of the underlying propositions about the item also apply to obtaining a quantum representation of observer O. Hence, in the consequent description we may sometimes omit direct reference to observer O and their quantum representation.

In a first step 140, mapping module 115 selects item 109 and presumes that item 109 registers in the community values space. The observed contextualizations of item 109 as found by network behavior monitoring module 120 and/or the human curator are also imported by mapping module 115. Obtaining a large amount of data at this pre-tracking or calibration stage is very advantageous.

In a second step 142, mapping module 115 corroborates the existence of the overall internal space, namely community values space and of the contextualizations by cross-checking data files 112. In performing step 142, mapping module 115 typically accesses memory 108 and archived data files 112. This allows mapping module 115 to look over “thick data”, i.e., data files 112 that present a historically large stream of information that relates to item 109. In this manner the relevance of item 109 and hence its registration specifically in internal spaces 110a, 110b, . . . , 110m belonging to the select test subjects Sᵢ forming the presumptive community can be further ascertained and more carefully quantified. For example, a number of occurrences of a response, a reference to or an action involving item 109 over time is counted. At this point, if item 109 has an ephemeral existence in the minds of the subjects then mapping module 115 could provide that information to the human user. Should prediction of fads not be of interest for the prediction or simulation, then the human user of computer system 100 could stop the process and induce the choice of a different item 109.

Assuming that item 109 remains of interest, then mapping module 115 proceeds to step three 144. Step 144 is important from the point of view of the quantum representation as it relates to the type of contextualization of underlying proposition 107 about item 109 by subjects Sᵢ. We consider two precipitation types and a null result or “IRRELEVANT” designated by 146. Of course, the careful reader will have noticed that items 109 that induce a null response encoded here by “IRRELEVANT” 146 were previously eliminated. However, since step 144 determines the precipitation for each subject concerned, and some of the subjects may not register item 109 despite the fact that a large number of their peers do, it is necessary to retain the option of null outcome 146 in step 144.

The first precipitation type being considered herein is a continuous precipitation type 148. The second type is a discrete precipitation type 150. Although continuous precipitation type 148 certainly admits of a quantum representation and has been discussed in more detail in U.S. patent application Ser. No. 14/324,127 we will focus on discrete precipitation type 150 in the present discussion. That is because despite the fact that continuous precipitation type 148 can be used in apparatus and methods of the invention, it is more difficult to model it with graphs. Furthermore, such continuous precipitation type 148 does not typically yield clearly discernible, mutually exclusive responses by subjects in their contextualizations (e.g., modulo underlying proposition 107 about shoes 109a in the present example). In other words, in the case of shoes 109a as an example, continuous precipitation type 148 in the contextualization of say “LIKE” could yield a wide spread in the degree of liking of shoes 109a for a multitude of reasons and considerations. A skilled artisan will be able to adopt the present teachings to continuous cases using standard tools known in the art.

In preferred embodiments of the invention we seek simple precipitation types corresponding to simple contextualizations of underlying proposition 107. In other words, we seek to confirm the community of test subjects Sᵢ in whose minds or internal spaces 110a, 110b, . . . , 110m proposition 107 about shoes 109a induces discrete precipitation type 150. This precipitation type should apply individually to each community subject making up such a community. Of course, subjects embedded in their normal lives cannot be tested for precipitation type entirely outside the context they inhabit. Some error may thus be present in the assessment of precipitation type for each subject. To the extent possible, such error can be kept low by reviewing previous precipitation types the subject under review exhibited with respect to similar propositions and ideally similar propositions about the same item. Further, a review of precipitation type by the human curator is advantageous to corroborate precipitation type.

It is further preferred that the contextualization be just in terms of a few mutually exclusive states and correspondent mutually exclusive responses or, more generally measurable indications that the subject can exhibit. Most preferably, the contextualization of underlying proposition 107 corresponds to discrete precipitation type 150 that manifests only two orthogonal internal states and associated mutually exclusive responses such as “YES” and “NO”. In fact, for most of the present application we will be concerned with exactly such cases for reasons of clarity of explanation. Once again, review by the human curator is highly desirable in estimating the number of internal states.

Additionally, discrete precipitation type 150 into just two orthogonal states associated with two distinct eigenvalues corresponds to the physical example of spinors that we have already explored in the background section. Many mathematical and applied physics tools have been developed over the past decades to handle these entities. Thus, although more complex precipitation types and numerous orthogonal states can certainly be handled by the tools available to those skilled in the art (see, e.g., references on working in the energy or Hamiltonian eigen-basis of general systems), cases where subjects' internal states are mapped to two-level quantum systems are by far the most efficient. Also, two-level systems tend to keep the computational burden on computer system 100 within a reasonable range and do not require excessively large amounts of data files 112 to set up in practice.

For the above reasons we now continue with the case of discrete precipitation type 150 modulo proposition 107 about shoes 109a admitting of only discrete and orthogonal eigenstates. In other words, internal states |Sᵢ [symbol] residing in internal spaces 110a, 110b, . . . , 110m decompose into superpositions of these few discrete and orthogonal eigenstates.

In this most preferred case, discrete precipitation type 150 induces test subjects Sᵢ to contextualize underlying proposition 107 about shoes 109a in terms of just two mutually exclusive states manifesting in mutually exclusive responses such as “YES” and “NO”. Thus, the manner in which subjects Sᵢ contextualizes proposition 107 in this preferred two-level form can be mapped to quantum-mechanically well-understood entities such as simple spinors or qubits. However, before proceeding to the next step performed by mapping module 115 with test subjects Sᵢ that do fall into the above preferred discrete precipitation type 150 with two eigenstates and two eigenvalues, it is important to ensure proper quantum behavior of the assigned states |Sᵢ [symbol] in common values space replaced at this point by community state space [symbol] ^{(C)}, as will be appreciated by one skilled in the art.

We now turn our attention to step 170 in which mapping module 115 confirms the number of measurable indications or eigenvalues associated with discrete precipitation type 150 to be two (2), as selected for the most preferred case. We should briefly remark on the other possibilities that we are not discussing in detail. In case 172 more than two eigenvalues are expected and some of them are associated with different state vectors. This is a classic case of a quantum mechanical system with degeneracy. In other words, the system has several linearly independent state vectors that have the same eigenvalues or measurable indications. Those skilled in the art will recognize that this typical situation is encountered often when working in the “energy-basis” dictated by the Hamiltonian.

In case 174 more than two eigenvalues are expected and all of them are associated with different state vectors. Such systems can correspond to more complicated quantum entities including spin systems with more than two possible projections along the axis on which they precipitate (e.g., total spin 1 systems). Quantum mechanical systems that are more than two-level but non-degenerate are normally easier to track than systems with degeneracy. Those skilled in the art will recognize that cases 172 and 174 can be treated with available tools.

In the preferred embodiment of the instant invention, however, we concentrate on case 176 selected in step 170 in which there are only two eigenvalues or two measurable indications. In other words, we prefer to base the apparatus and methods of invention on the two-level system. As mentioned above, it is desirable for the human curator that understands test subjects Sᵢ to review these findings to limit possible errors due to misjudgment of whether the precipitation is non-degenerate and really two-level. This is preferably done by reviewing historical data of subject responses, actions and any indications available (e.g., from data files 112 archived in memory 108) that are used by mapping module 115 in making the determinations. We thus arrive at a corroborated selection of test subjects Sᵢ that apparently form a community and exhibit discrete precipitation with just two eigenvalues and whose states |Sᵢ [symbol] in internal spaces 110a, 110b, . . . , 110m can therefore be assigned to two-level wave functions.

A final two-level system review step 178 may optionally be performed by mapping module 115. This step should only be undertaken when subjects Sᵢ can be considered based on all available data and, in the human curator's opinion, as largely independent of their social group and the overall environment. In other words, the level of quantum entanglement of subject states |Sᵢ [symbol] with the environment and with each other is low as determined with standard tools. The reader is here referred to U.S. patent application Ser. No. 14/182,281, the references cited therein and further standard references discussing Bell's Inequality, Bell single-channel and multi-channel tests.

In human terms, low levels of entanglement are likely to apply to subjects that are extremely individualistic and formulate their own opinions without apparent influence by others within their community or outside of it. When such radically individualistic subjects are found, their further examination is advantageous to bound potential error in assignments of state vectors |Sᵢ [symbol] and/or in the case of more rigorous procedures, any errors in the estimation of states |Sᵢ [symbol] .

Preferably, mapping module 115 should divide case 176 into sub-group 180 and sub-group 182. Sub-group 180 is reserved for subjects Sᵢ that despite having passed previous selections exhibit some anomalies or couplings. These are potentially due to inter test subject entanglement and/or test subject to environment entanglement. Test subjects Sᵢ with states |Sᵢ [symbol] manifesting substantial levels of entanglement and/or other anomalies that may cause degeneracy or other unforeseen issues should be put in sub-group 180. These subjects should be eliminated from being used in further prediction or simulation.

Meanwhile, sub-group 182 is reserved for confirmed well-behaved subjects Sᵢ whose states |Sᵢ [symbol] reliably manifest in two-level, non-degenerate, measurable indications a and b modulo underlying proposition 107 about the chosen item 109 (or an item very similar to item 109) as confirmed by historical data. These subjects will be assigned two-level state vectors |Sᵢ [symbol] by assignment module 116 as explained in more detail below. At this point the reader may again refer to U.S. patent application Ser. No. 14/182,281 that explains qubit-type state vector assignments in situations that center on individual subjects divorced from community effects.

In addition to selecting test subjects Sᵢ that can be assigned to two-level states |Sᵢ [symbol] , mapping module 115 also examines the community values space. In other words, module 115 also confirms that all test subjects Sᵢ that have been qualified in the prior steps (found to exhibit the desired discrete, non-degenerate, two-level precipitation type with respect to proposition 107 about item 109a) really inhabit a community values space that can be represented by a single community state space [symbol] ^{(C)}. More information about this process, tensor product spaces and the requisite tools is found in U.S. patent application Ser. No. 14/324,127. For the remaining portion of the present teachings, it will be assumed that all test subjects Sᵢ are indeed found to be in sub-group 182 and thus justify assignment of state vectors or states |Sᵢ [symbol] in community state space [symbol] ^{(C)}.

FIG. 3C uses a perspective view to illustrate how test subjects Sᵢ are posited along scale parameter W. The drawing figure focuses in particular on three selected test subjects S₁, S₂ and Sₘ with their respective internal spaces 110a, 110b, and 110m posited in community values space 200 as represented quantum mechanically by community state space [symbol] ^{(C)}. An overall context 202 for the quantum representation is included at the top of FIG. 3C. Context 202 reminds us that in their quantum mechanical representation states |Sᵢ [symbol] of all test subjects Sᵢ behave as discrete, two-level systems. Each of those can be conveniently represented with the aid of Bloch sphere 10 as already introduced in the background section.

Scaling module 101 and renormalization module 117 perform the actual operations. Scaling module 101 selects real scale parameter W according to the proposition at hand and the expected types of contextualizations. Renormalization module 117 computes scale values W₁, W₂, Wₘ that associate with test subjects S₁, S₂, Sₘ in the chosen scale parameter W. Scale values W₁, W₂, Wₘ are then used to organize test subjects S₁, S₂, Sₘ along scale parameter W based on their numerical value. Of course, the same is repeated for all test subjects Sᵢ to obtain all scale values Wᵢ, but only the select three are called out in particular for reasons of clarity in the visualization and explanation.

Selection of real scale parameter W by scaling module 101 pertains to the classification or ordering of all test subjects Sᵢ and also of observer O. Since scale parameter W is a real-valued quantity and not an emergent part of the quantum representation per se, we can draw it in at this early stage. In other words, we can organize the expected quantum states for all test subjects prior to assigning the actual state vectors. This is shown explicitly for still unassigned states |S₁ [symbol] , |S₂ [symbol] , |Sₘ [symbol] in internal spaces 110a, 110b, 110m of three select subjects S₁, S₂, Sₘ. The fact that the actual state vectors remain unassigned at this stage is indicted visually by the question marks.

As already stated above, scale parameter W corresponds to a classically stable quantity that exists independently of the contextualizations of underlying proposition 107 experienced by test subjects Sᵢ. This requirement closely parallels the one in renormalization where the scaling parameter Λ is not presumed to be an emergent property either within or anywhere near the range of validity of the Quantum Field Theory (QFT). Hence, when the UV cut-off or IR cut-off is set for any QFT in terms of say a length scale Λ⁻¹, there is no question that length itself, i.e., the linear spatial dimension, is a real parameter. One should not immediately dismiss this insight as trivial, given that such assumptions about space are suspect when dealing with quantum gravity and any physics approaching the Planck scale.

In the present example, scale parameter W is chosen to be economic influence. More precisely still, since underlying proposition 107 is about shoes 109a that can in principle be bought or sold, scale parameter W is chosen to be economic influence. The choice made here is the subject's yearly disposable income in dollars. Therefore scale parameter W is denominated in dollars of yearly disposable income. The establishment of scaling parameter W by scaling module 101 is thus directly related to proposition 107 about item 109. If the underlying proposition were about playing basketball or playing tennis with the item being a basketball or a tennis racket (see e.g., item 109q in inventory 130 shown in FIG. 3A) then scaling module 101 should select a different scale parameter W relevant to the expected contextualizations. For example, scale parameter W could be the physical parameter of height for basketball and hand-to-eye coordination for tennis. A person skilled in the art will see that correct choice of scale parameter W reflects some underlying fundamental constraint that is related to the underlying proposition but is beyond being affected by the contextualizations experienced by test subjects Sᵢ.

In the present case of shoes 109a proposition 107 about them scales with price. Let us assume that shoes 109a cost $1,000 in 2014 dollars. Then, with respect to actually considering shoes 109a with the potential of acting out a measurable indication such as “YES” for “buy shoes 109a” in the contextualization that a test subject Sᵢ is free to adopt modulo proposition 107 money is clearly a driving factor or consideration. Hence, economic influence is a good choice of scale parameter W. Note that scale parameter W in FIG. 3C is plotted using a logarithmic scale to accommodate the large span of possible values of W for all subjects Sᵢ.

A yearly disposable income of about $100,000 certainly puts shoes 109a within the reach of a subject with such large disposable income. In fact, about $100,000 is the disposable income W₂ of subject S₂. Test subjects whose yearly disposable income is $20,000 can also consider shoes 109a as an item they can buy. That is the case of subject Sₘ whose disposable income Wₘ is about $20,000. However, test subjects with less than $1,000 in yearly disposable income cannot seriously consider shoes 109a in contexts that might involve purchasing them. In the case of subject Sᵢ their disposable income W₁ is about $10,000 and they are thus still in the category of subjects Sᵢ that can consider purchasing and/or transacting over shoes 109a.

In FIG. 3C all subjects Sᵢ not expressly called out but falling below the $1,000 mark along yearly disposable income scale W are small (due to the perspective view). The Bloch spheres 10 standing in for them are unfilled. All subjects Sᵢ that have between $1,000 and $250,000 in yearly disposable income have much larger Bloch spheres 10 and are also hatched. Demonstration subjects S₁, S₂, Sₘ belong to this latter group of subjects and their Bloch spheres 10 are thus hatched. Subjects that belong to the community that can legitimately interact over shoes 109a in a similar manner yet use their own values naturally form their group. In accordance with the invention, subjects with disposable incomes Wᵢ falling within range ΔW indicated by a hatched regime along W between $1,000 and $250,000 are grouped based on renormalization-related grounds. In other words, range ΔW is taken to lie within a range of validity of the quantum representation used to track the contextualizations of these subjects.

Subjects Sᵢ that do not fall into range ΔW cannot be presumed to admit of quantum representation under the same quantum state assignment rules. This is becomes clear for subjects Sᵢ that have yearly disposable incomes Wᵢ below $1,000 (some of the subjects indicated in FIG. 3C have yearly disposable incomes even below $1). These subjects are below the lower cut-off of range ΔW. It would be nonsensical (unless we were modeling criminal behavior) to treat these subjects with the same quantum representation with respect to proposition 107 about shoes 109a that cost $1,000. In terms of the renormalization inspired approach, these subjects are below the lower cut-off.

At the other extreme, subjects such as observer O are outside range ΔW as well. Our specific subject, namely observer O is above the upper cutoff of $250,000. Observer O has about $10,000,000 in yearly disposable income Wₒ and is thus well beyond or outside the realm of validity of the quantum representation used for subjects residing within range ΔW. In terms of the renormalization inspired approach adopted herein, observer O is considered above the upper cut-off. In human terms, it is intuitive that subjects with disposable yearly incomes in the range of millions or tens of millions of dollars live in realms where even the concept of shopping for shoes 109a may not apply. Actions such as shopping may be performed by support staff. Thus, subjects above upper cut-off may not even perceive proposition 107 involving shoes 109a that are so relatively inexpensive. In many ways, this is similar to subjects below lower cut-off who cannot experience contextualizations that subjects within range ΔW do experience.

The renormalization-related classification carries over to the placement of states |Sᵢ [symbol] of subjects Sᵢ found within range ΔW in community state space [symbol] ^{(C)}. Namely, common values space 200 represented by community state space [symbol] ^{(C)} is presumed to only be available to states |Sᵢ [symbol] of subjects Sᵢ found within range ΔW and thus falling within the range of validity of the overall quantum representation. It is important to note that at least initially range ΔW will be an unknown prior to tracking subject contextualizations in the context of any particular underlying proposition about selected item(s).

The present invention provides tools for calibration and tracking of subjects. Calibration runs and review of prior data along with the expert curator that vets the conclusions should be used to ascertain any initially proposed range ΔW. Further, continuous testing of range ΔW to ensure that it falls within the actual range of validity of the given quantum representation is also recommended. This can be accomplished by collecting and analyzing contextualization data during the tracking of actual contextualizations found across large groups of subjects spanning a wide range of scale parameter W beyond just the chosen range ΔW. This empirical and pragmatic approach will help in refining and tuning the proper range. It will also be apparent to the reader that subjects that may belong to the same community in the context of one proposition may not belong to the same community in the context of a different proposition and that given a different scale parameter W their classification is subject to change.

Renormalization module 117 also formally posits or creates the selected subset of test subjects Sᵢ that belong to the community by virtue of sharing a community values space 200 modulo proposition 107. The action of positing is connected with the quantum mechanical action associated with the application of creation operators. Also, annihilation operators are used for un-positing or removing quantum states |Sᵢ [symbol] of test subjects Sᵢ from consideration. Just to recall the physics assumptions being used herein when creating and annihilating states, it is important to know what type of state is being created or annihilated. Symmetric wave functions are associated with elementary (gauge) and composite bosons. Bosons have a tendency to occupy the same quantum state under suitable conditions (e.g., low enough temperature and appropriate confinement parameters). The operators used to create and annihilate bosons are specific to them. Meanwhile, fermions do not occupy the same quantum state under any conditions and give rise to the Pauli Exclusion Principle. The operators used to create and annihilate fermions are specific to them as well.

Again, it may be difficult to discern such competitive dynamic modulo the proposition 107 about the same pair of shoes 109a or the need for an anti-symmetric joint state from data files 112 and communications found in traffic propagating via network 104 and within social network 106. This is why creation module 117 has to review data files 112 as well as communications of test subjects Sᵢ containing indications exhibited in situations where both were present and were confronted by propositions as close as possible to proposition 107 about shoes 109a. The prevalence of “big data” as well as “thick data” that subjects produce in self-reports is again very helpful. The human curator that understands the lives of test subjects Sᵢ should preferably exercise their intuition in reviewing and approving the proposed F-D anti-consensus statistic or B-E consensus statistic based on data from pairs of subjects Sᵢ modulo proposition 107 about shoes 109a.

Once all subjects Sᵢ have their statistics determined to be either B-E consensus or F-D anti-consensus renormalization module 117 can properly posit them in community values space 200 as proper quantum states |Sᵢ [symbol] . All subject states |Sᵢ [symbol] corresponding to subjects Sᵢ exhibiting B-E consensus statistic are created by bosonic creation operator â^{†}. All subject states |Cₖ [symbol] corresponding to subjects Sᵢ exhibiting F-D anti-consensus statistic are created by fermionic creation operator ĉ^{†}. As already indicated above, all subjects states |Sᵢ [symbol] irrespective of statistics are posited in their shared community values space 200 represented by community state space [symbol] ^{(C)}.

At this stage, assignment module 116 can deploy to finalize the quantum assignments and complete the quantum translation of the tracking task. A person skilled in the art will note that, depending on the embodiment, the distribution of functions between modules 115, 101, 117 and 116 and potentially behavior monitoring unit 120 can be adjusted. Irrespective of the division of tasks, these modules need to share information to ensure that the most accurate possible quantum representation is achieved.

FIG. 3D illustrates the operation of assignment module 116 that formally applies the quantum representation to all subjects Sᵢ whose scale value Wᵢ, in this case their yearly disposable income expressed in dollars, are within range ΔW. Assignment module 116 passes over all subjects Sᵢ and observer O that register scale values Wᵢ outside range ΔW, as these are likely not within the empirically established range of validity of the quantum representation. Meanwhile, the qualified test subjects Sᵢ within the derived community sharing community values space 200 are assigned to two-level quantum states.

In the present drawing figure we see subject S₁ with internal state 110a already assigned to a two-level quantum state vector or simply state |S₁ [symbol] with a B-E marking. The latter serves to remind us that subject S₁ exhibits B-E consensus statistic with respect to other subjects S₁ when contextualizing proposition 107. Furthermore, based on historical data in data files 112-S1 stored in memory 108, mapping module 115 has determined that the most likely value applied by test subject S₁ in contextualization of proposition 107 about item 109, i.e., shoes 109a in the present example, concerns their “beauty”. Since the precipitation type of community subject state |S₁ [symbol] is two-level the two possible measurable indications a, b map to a “YES” indication and a “NO” indication.

Given all this information about subject S₁, assignment module 116 estimates and expresses state |S₁ [symbol] in a decomposition in the u-basis which corresponds to value “beauty”. Of course, if available assignment module 116 used the most recent measurement. State “UP” along u is taken as the eigenstate in which subject S₁ finds shoes 109a beautiful with the associated eigenvalue or measurable indication being “YES”. State “DOWN” along u is taken as the eigenstate in which subject S₁ finds shoes 109a not beautiful with the associated eigenvalue or measurable indication being “NO”. The measurable indications a, b in this case are two mutually exclusive responses “YES” and “NO”.

In general, measurable indications a, b transcend the set of just mutually exclusive responses that can be articulated in data files 112-S1 or otherwise transmitted by a medium carrying any communications generated by subject S₁. Such indications can include actions, choices between non-communicable internal responses, as well as any other choices that subject S₁ can make but is unable to communicate about externally. Because such “internal” choices are difficult to track, unless community subject S₁ is under direct observation by another human that understands them, they may not be of practical use in the present invention.

On the other hand, mutually exclusive responses that can be easily articulated by subject S₁ are suitable in the context of the present invention. The actual decomposition into the corresponding eigenvectors or eigenstates and eigenvalues correspond to the measurable indications a, b, as well as the associated complex coefficients, probabilities and other aspects of the well-known quantum formalism will not be discussed herein. These aspects have been previously explained in great detail in U.S. patent application Ser. No. 14/324,127 to which the reader is referred for corresponding information.

It is important to realize that the assignment by assignment module 116 of state |S₁ [symbol] to first community subject S₁ will most often be an estimate. Of course, it is not an estimate in the case of confirmed measurement. Measurement occurs when subject S₁ has just yielded one of the measurable indications, which corresponds to an eigenvalue λᵢ that associates with an eigenvector in that eigenbasis. At that point assignment module 116 simply sets state |S₁ [symbol] equal to that eigenvector. The estimate of state |S₁ [symbol] is valid for underlying proposition 107 about shoes 109a. The estimate reflects the contextualization by subject S₁ at a certain time and is subject to change as the state of subject S₁ evolves with time. The same is true for the measured state.

Updates to the estimates and prior measurements of all quantum states are preferably derived from contextualizations that have been actually measured within a time period substantially shorter than or less than a decoherence time. Since no contextualizations are identical, even if only due to temporal evolution of the state, similar contextualizations should be used in estimating states whenever available. In other words, estimates based on propositions about items that are similar to proposition 107 about shoes 109a should be used. This strategy allows assignment module 116 to always have access to an up-to-date estimated or measured state vector.

Quantum states modulo certain propositions may exhibit very slow evolution on human time scales, e.g., on the order of months, years or even decades. States with very long decoherence times are advantageous because they do not require frequent updates after obtaining a good first estimate. For states that evolve more quickly, frequent updates will be required to continuously maintain fresh states. Contextualizations modulo some propositions may evolve so rapidly on human time scales that keeping up-to-date estimates or measurements may be challenging. For example the change in state from “fight” to “flight” modulo an underlying proposition 107 about item 109 instantiated by a wild tiger (or item 109b instantiated by the book covering ordinary and partial differential equations) can evolve on the order of split seconds. Therefore, in considering any particular proposition data and estimated state freshness may be crucial for some tracking activities while barely at all for others. A review of estimates, measurements and their freshness by the human curator is thus recommended before commencing any tracking processes and even more so before attempting any prediction or simulation runs.

In the present example, the contextualization of proposition 107 about shoes 109a by test subject S₁ at the time of interest is from the point of view of an admirer who judges shoes 109a according to their own concept of “beauty”. Possibly, subject S₁ is a connoisseur of shoes (professionally or as a hobby). The estimated state |S₁ [symbol] in the u-basis of “beauty” is reflective of this contextualization by subject S₁.

Meanwhile, subject S₂ with internal state 110b is also assigned their discrete, two-level estimated of measured state |S₂ [symbol] with an F-D marking. The latter serves to remind us that subject S₂ exhibits F-D anti-consensus statistic with respect to other subjects Sᵢ when contextualizing proposition 107. In this case, mapping module 115 has determined that the most common value applied by subject S₂ in contextualizing proposition 107 about shoes 109a (or any sufficiently similar contextualization, as noted above) concerns their “style”. Thus, in any measurement the a or “YES” indication indicates that subject S₂ judges shoes 109a to be stylish. The corresponding eigenstate is taken “UP” along v. The b or “NO” indication indicates that subject S₂ judges shoes 109a to not be stylish. The corresponding eigenstate is taken “DOWN” along v.

Of course, state |S₂ [symbol] estimated for subject S₂ by assignment module 116 is posited to also reside in the same Hilbert space as state |S₁ [symbol] of subject S₁, namely in community state space [symbol] ^{(C)}. Belonging to the same values space can be confirmed in finding evidence from contemporaneous and historical data files 112-S1, 112-S2 of subjects S₁ and S₂ (see FIG. 2). Mentions or even discussion of items similar as well as specifically item 109a is an indication of contextualizing in shared values space 200. Remaining community subjects are treated in the same manner by mapping module 115 regarding community subject states and community state space [symbol] ^{(C)} that represents community values space 200.

Subject Sₘ with internal state 110m is also assigned their discrete, two-level estimated or measured state |Sₘ [symbol] with a B-E marking designating consensus statistic with respect to other subjects Sᵢ when contextualizing proposition 107. In the case of subject Sₘ, mapping module 115 has determined that the most common value applied by subject Sₘ in contextualizing proposition 107 about shoes 109a (or any sufficiently similar contextualization, as noted above) concerns their “utility”. Thus, in any measurement the a or “YES” indication indicates that subject Sₘ judges shoes 109a to be useful. The corresponding eigenstate is taken “UP” along w. The b or “NO” indication indicates that subject Sₘ judges shoes 109a to not be useful. The corresponding eigenstate is taken “DOWN” along w. Thus decomposed in the w-eigenbasis state |Sₘ [symbol] of subject Sₘ is processed and finally placed in community state space [symbol] ^{(C)}.

Proceeding in this manner, assignment module 116 assigns community subject states |Sᵢ [symbol] that are posited in community state space [symbol] ^{(C)} to each one of subjects Sᵢ. This is done based on the best available and most recent information from data files 112 as well as communications gleaned from network 104. To ensure data freshness, assignment module 116 is preferably connected to network behavior monitoring unit 120. The latter can provide most up-to-date information about subjects Sᵢ to allow assignment module 116 to assign the best possible estimates of states |Sᵢ [symbol] based on measurements of similar propositions or even to assign the measured states if recent measurement of the proposition at hand is available for the given subjects. This should always be done as part of pre-calibration at the start of a tracking run or else a prediction or simulation run. A person skilled in the art may consider the actions of assignment module 116 to represent assignment of estimates and may indicate this by an additional notational convenience. In some cases a “hat” or an “over-bar” are used. In order to avoid undue notational rigor we will not use such notation herein and simply caution the practitioner that the assigned state vectors as well as matrix operators we will derive below from the already introduced eigenbases are estimates.

It should be noted that network behavior monitoring unit 120 can curate what we will consider herein to be estimated quantum probabilities pₐ, p_{b} for the corresponding measurable indications a, b of all quantum states |Sᵢ [symbol] . Of course, a human expert curator or other agent informed about the human meaning of the information available in network 104 about subjects Sᵢ should be involved in setting the parameters on unit 120. The expert human curator should also verify the measurement in case the derivation of measurable indications actually generated is elusive or not clear from data files 112-Si. Such review by an expert human curator will ensure proper derivation of estimated quantum probabilities pₐ, p_{b}. Appropriate human experts may include psychiatrists, psychologists, counselors and social workers with relevant experience.

In some embodiments assignment module 116 may itself be connected to network 104 such that it has access to documented online presence and all data generated by test subjects Sᵢ in real time. Assignment module 116 can then monitor the state and online actions of test subjects Sᵢ without having to rely on archived data from memory 108. Of course, when assignment module 116 resides in a typical local device such as computer 114, this may only be practicable for tracking a few very specific test subjects or when tracking subjects that are members of a relatively small social group 106 or other small subgroups of subjects of known affiliations.

In the present example, contextualization of proposition 107 about shoes 109a by any one of subjects Sᵢ that exhibits the two-level, non-degenerate precipitation type is taken to exhibit two of the most typical opposite responses, namely “YES” and “NO”. In general, however, mutually exclusive measurable indications or responses can also be opposites such as “high” and “low”, “left” and “right”, “buy” and “sell”, “near” and “far”, and so on. Proposition 107 may evoke actions or feelings that cannot be manifested simultaneously, such as liking and disliking the same item at the same time, or performing and not performing some physical action, such as buying and not buying an item at the same time. Frequently, situations in which two or more mutually exclusive responses are considered to simultaneously exist lead to nonsensical or paradoxical conclusions. Thus, in a more general sense mutually exclusive responses in the sense of the invention are such that the postulation of their contemporaneous existence would lead to logical inconsistencies and/or disagreements with fact. This does not mean that any one of subject Sᵢ may not internally experience such conflicts, but it does mean that they cannot act them out in practice (i.e., you can't buy and not buy shoes 109a at the exact same time).

Sometimes, after exposure to proposition 107 any one of subjects Sᵢ reacts in an unanticipated way and no legitimate response can be obtained in the contextualization of proposition 107. The quality of tracking will be affected by such “non-results”. Under these circumstances devoting resources to assigning and monitoring of subject state |Sᵢ [symbol] and monitoring of their expectation value becomes an unnecessary expenditure. Such non-response can be accounted for by classical null response probability pₙᵤₗₗ, and as also indicated in prior teachings (see U.S. patent application Ser. Nos. 14/182,281 and 14/224,041).

In preferred embodiments of computer system 100 and methods of the present invention, it is preferable to remove non-responsive subjects Sᵢ after a certain amount of time corroborated by the human curator. The amount of time should be long in comparison with the decoherence time. Therefore, any subject observed to generate “non-results” for a comparatively long time is removed from community state space [symbol] ^{(C)} by action with a corresponding annihilation operator. This is tantamount to removing the subject from tracking. This action is also referred to as annihilation in the field of quantum field theory. It is here executed in analogy to its action in a field theory by the application of fermionic or bosonic annihilation operator ĉ or â. The type of annihilation operator depends on whether subject state exhibited B-E consensus or F-D anti-consensus statistic during its original creation.

FIG. 3E illustrates another important function performed by assignment module 116. This function is to convert into quantum representation the subject values (not to be confused with numeric values—here we mean human values or judgment criteria) that subjects Sᵢ qualified under the renormalization-related considerations laid out above apply in their contextualizations. FIG. 3E continues with the same example, namely the one focused on subjects S₁, S₂ and Sₘ. Instead of reviewing the quantum states, however, assignment module 116 now trains on the eigenvectors that make up the u-, v- and w-eigenbases. These eigenbases are associated with contextualizations of the underlying proposition using the values of “beauty”, “style” and “utility”, respectively.

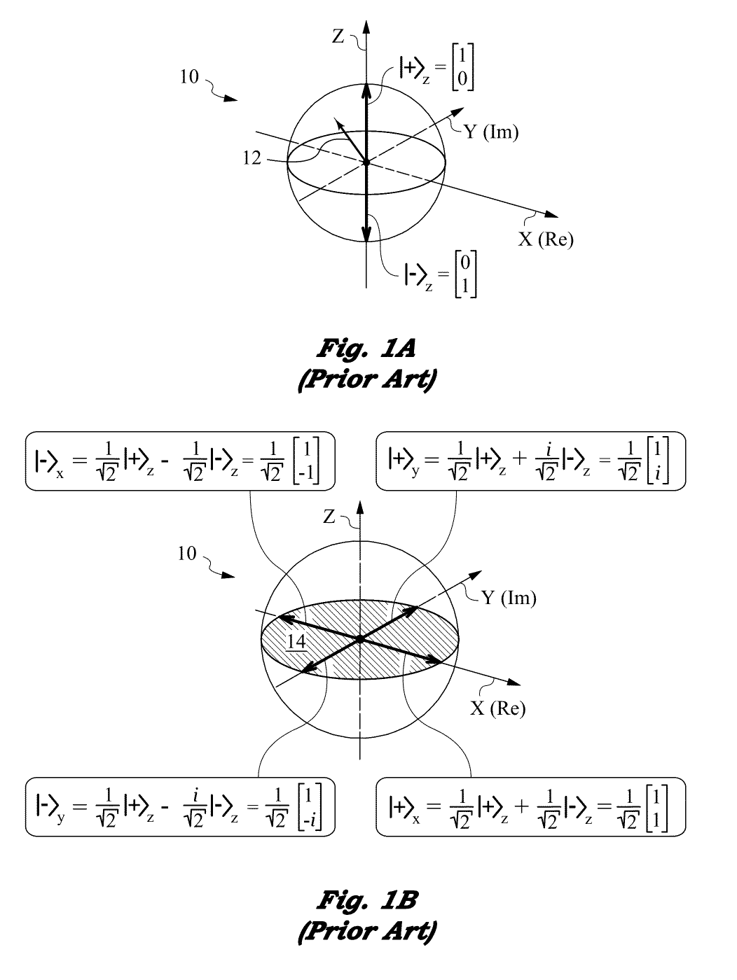

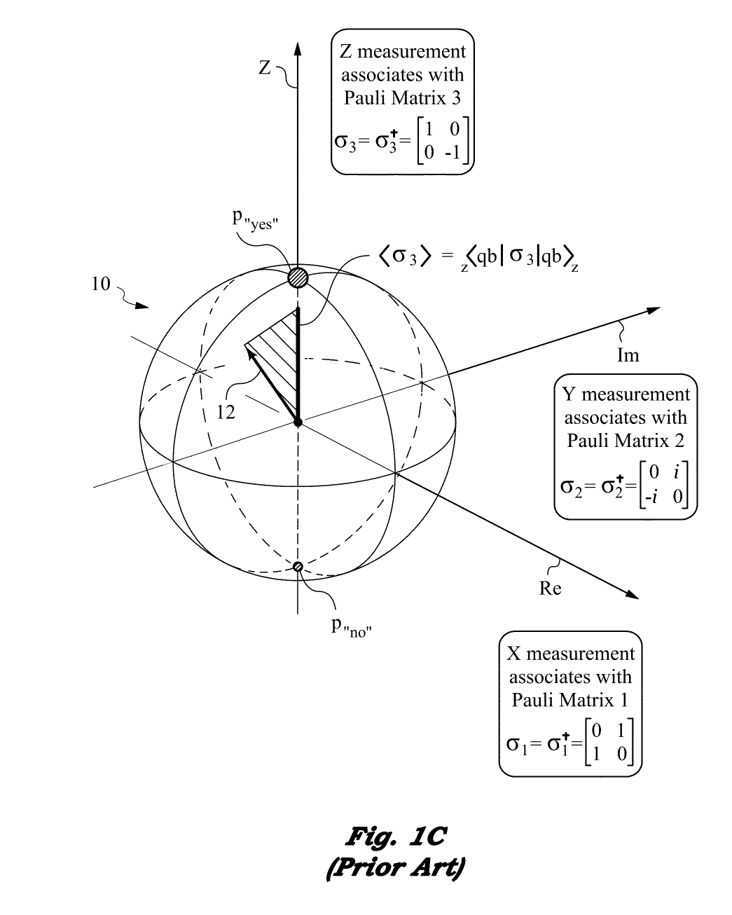

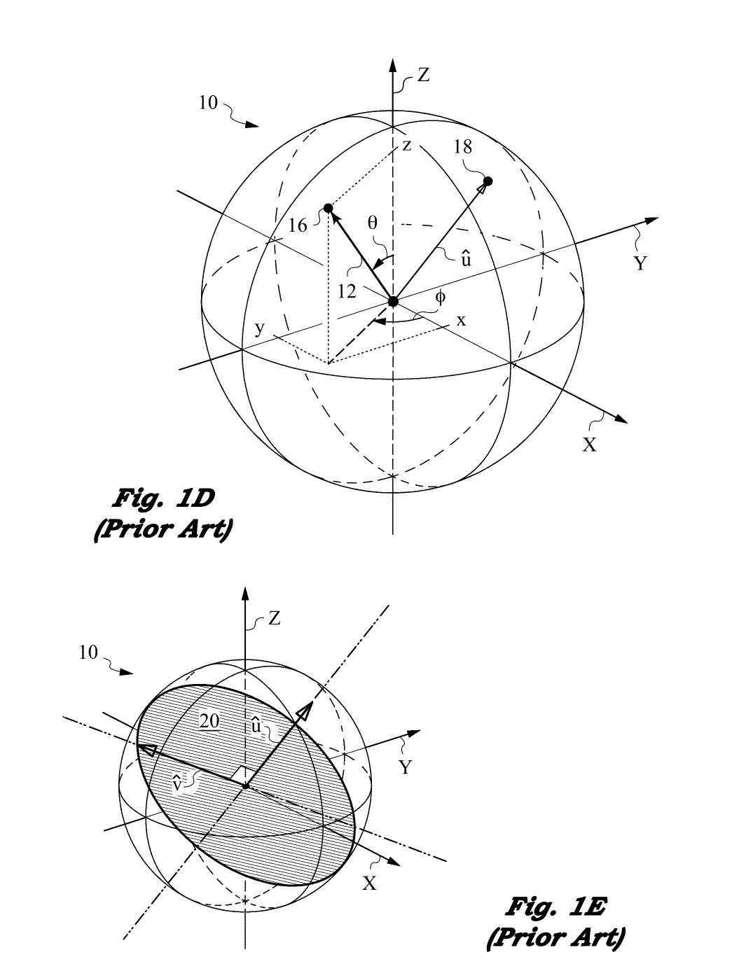

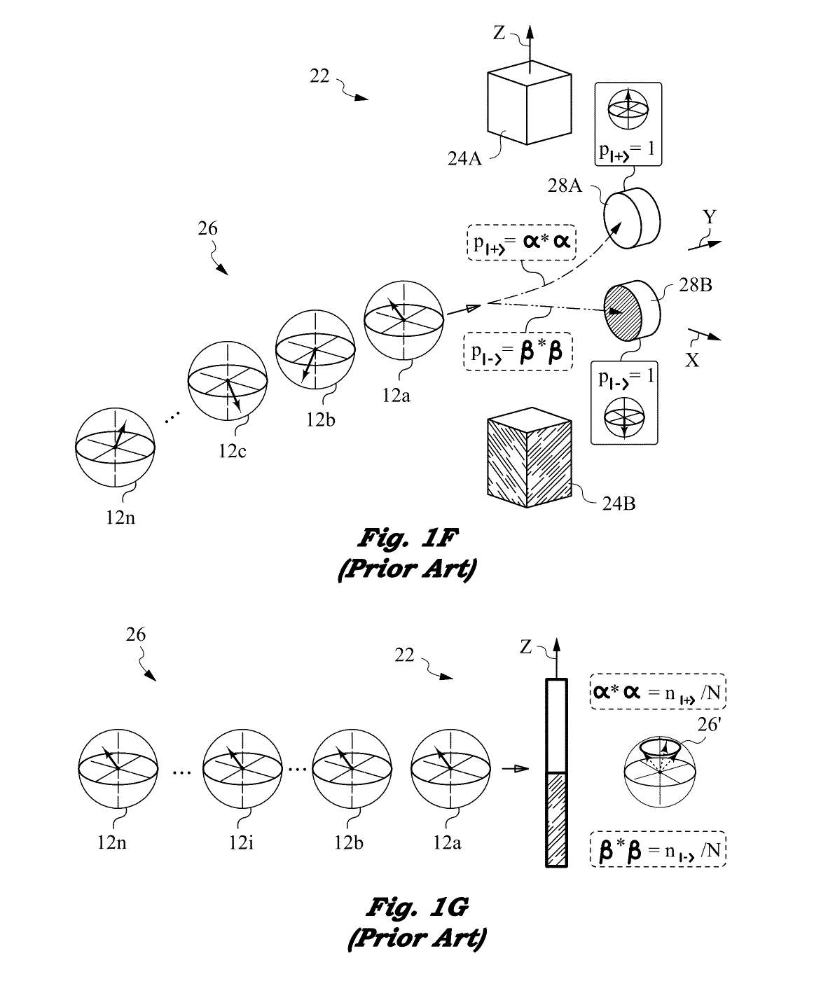

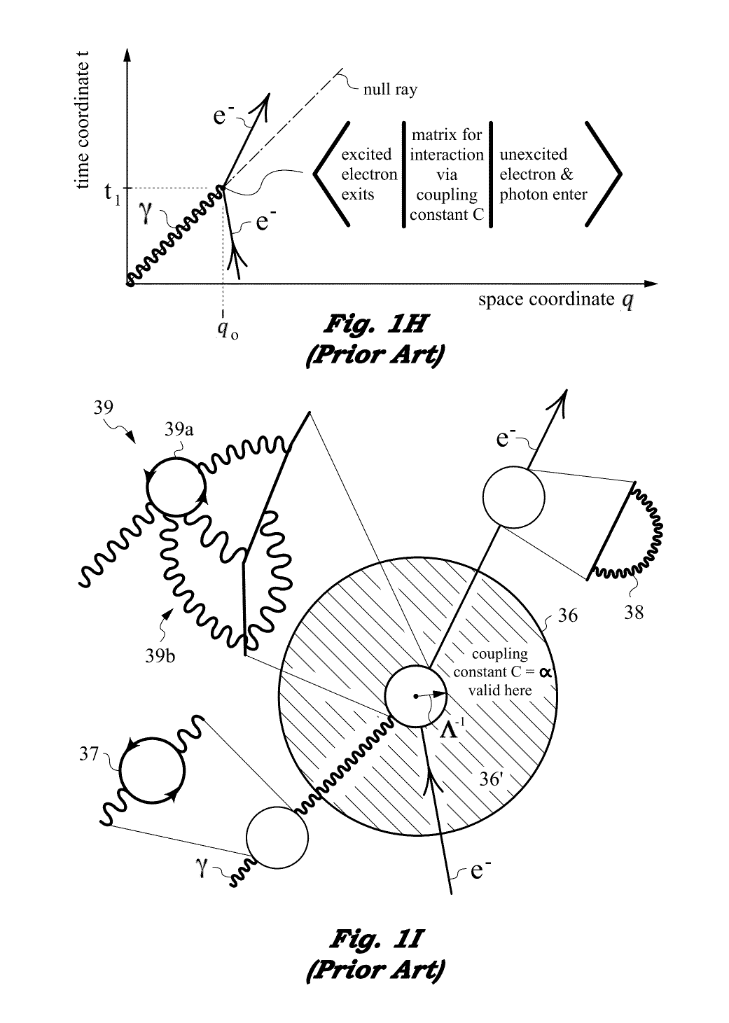

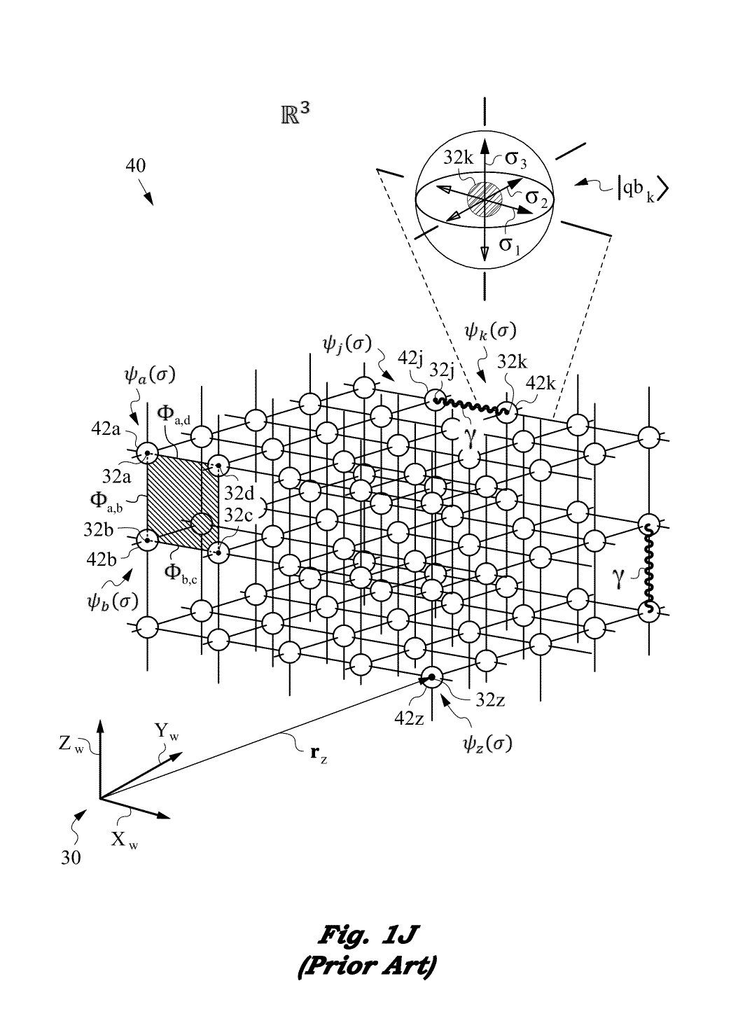

As we know from standard quantum mechanics, since states |Sᵢ [symbol] are two-level they can be spectrally decomposed in bases with two eigenvectors. The spectral decompositions of states |S₁ [symbol] , |S₂ [symbol] , |Sₘ [symbol] belonging to subjects S₁, S₂ and Sₘ as shown in FIG. 3D has already introduced the u-, v- and w-eigenbases. Each of these three eigenbases has two eigenvectors that are not explicitly drawn here (see, e.g., FIGS. 1A & 1B and corresponding description in the background section). In other words, the eigenvectors in this example come in pairs. There is one “UP” and one “DOWN” eigenvector in each of the three eigenbases. Equivalently put, we have eigenvectors that are parallel and anti-parallel with the u, v and w rays shown in FIGS. 3D & 3E.

By convention we have already introduced above, we take “UP” eigenvectors to mean that the subject is experiencing a state of positive judgment in that value (contextualization yields positive value judgment). Therefore, the “UP” eigenvector is associated with the first eigenvalue λ₁ that we take to stand for the “YES” measurable indication a. The “DOWN” eigenvectors mean the state of negative judgment in that value. Hence, the second eigenvalue λ₂ that goes with the “DOWN” eigenvector is taken to stand for “NO” measurable indication b.

In the quantum representation of contextualizations as implemented by assignment module 116 the eigenvector pairs describe the different values that subjects may deploy. Test subjects Sᵢ can contextualize proposition 107 with any chosen value described by the eigenvector pairs but they can only choose one at a time. In fact, in many applications of the present apparatus and methods it is advantageous to obtain measurable indications a, b (or eigenvalues λ₁, λ₂) from many subjects Sᵢ in at least two different eigenvector bases or, equivalently, in two different contextualizations.

Based on the rules of linear algebra, test subject states |Sᵢ [symbol] forming the quantum representation of test subjects Sᵢ modulo underlying proposition 107 can be expressed in any contextualization or using any of the available values. This is ensured by the spectral decomposition theorem. We have already used this theorem above in FIG. 3D for subject state decompositions in terms of eigenvectors. To wit, we have expressed subject state |S₁ [symbol] of subject S₁ in the u-basis, subject state |S₂ [symbol] of subject S₂ in the v-basis, and subject state |Sₘ [symbol] of subject Sₘ in the w-basis.

In FIG. 3E we proceed further and introduce value matrices PRⱼ whose eigenvectors are the very eigenvectors we have already deployed. Conveniently, we thus express the different bases or eigenbases with corresponding value matrices PRⱼ that have these eigenvectors in their eigenbases. Value matrices PRⱼ represent quantum mechanical operators (Hermitian matrices). In the case of our two-level systems are related to the Pauli matrices already introduced in the Background section.

The quantum mechanical prescription for deriving the proper operator or “beauty” value matrix PRᵤ is based on knowledge of the unit vector û along ray u. The derivation has already been presented in the background section in Eq. 13. To accomplish this task, we decompose unit vector û into its x-, y- and z-components. We also deploy the three Pauli matrices σ₁, σ₂, σ₃. By standard procedure, we then derive value matrix PRᵤ as follows:

PRᵤ=û· σ̅=uₓσ₁+u_{y}σ₂+u_{z}σ₃. Eq. 16a

The same procedure yields the two remaining value matrices PRᵥ, PR_{w} that, in our quantum representation, stand for contextualizations using the values of “style” and “beauty”, respectively. Once the decompositions of unit vectors \hat{v}, ŵ along rays v, w are known, these are expressed as follows:

PRᵥ=\hat{v}· σ̅=vₓσ₁+v_{y}σ₂+v_{z}σ₃, and Eq. 16b

PR_{w}=ŵ· σ̅=wₓσ₁+w_{y}σ₂+w_{z}σ₃. Eq. 16c

All three value matrices PRᵤ, PRᵥ, PR_{w} obtained from these equations are shown in FIG. 3E in association with their corresponding rays u, v and w.

Per standard rules of quantum mechanics, we take value matrices PRⱼ to act on or be applied to test subject states |Sᵢ [symbol] to yield eigenvalues λₖ associated with measurable indications modulo underlying proposition 107 exhibited by test subjects Sᵢ. The eigenvalues, of course, stand for the “YES” and “NO” measurable indications. The practitioner is here reminded that prior to the application of the corresponding value matrix the subject state should be expressed in the eigenbasis of that value matrix. In the case of values represented with value matrices PRᵤ, PRᵥ, PR_{w} we are clearly not dealing with eigenvector bases that are completely orthogonal (see FIG. 1E and discussion of the Uncertainty Principle in the Background section). Thus, contextualizations with these values are not completely incompatible. However, they are far from compatible, since u-, v- and w-produce clearly different unit vectors.

In some embodiments it will be advantageous to select two or more different eigenvector bases (depending on dimensionality of state space [symbol] ^{(C)}) represented by two or more value matrices PRⱼ that are non-commuting and thus subject to the Heisenberg Uncertainty relation. Measurements obtained over test subjects Sᵢ contextualizing with incompatible values as encoded by such non-commuting value matrices PRⱼ will be useful in further explorations and in constructing views for classical representations. The measurable indications obtained when contextualizing with such non-commuting value matrices PRⱼ cannot have simultaneous reality. In other words, they cannot be measured/observed in any one of test subjects Sᵢ at the same time.

Armed with the quantum mechanical representation thus mapped, many computations and estimations can be undertaken. The reader is referred to the co-pending application Ser. Nos. 14/182,281; 14/224,041 and Ser. No. 14/324,127 for further teachings about the extension of the present quantum representation to simple measurements. Those teachings also encompass computation of outcome probabilities in various bases with respect to different propositions typically presented to just one or two subjects. The teachings partly rely on trying to minimize the effects from interactions between the environment and the state that stands in for the subject of interest. The present teachings, however, will now depart from the directions charted in the aforementioned co-pending applications.

FIG. 3F uses perspective as an aid to show a renormalization-related ordering along scale parameter W of quantum states |Sᵢ [symbol] standing in for test subjects Sᵢ already introduced above. All test subjects Sᵢ with scale values Wᵢ falling within range ΔW have been formally assigned quantum states |Sᵢ [symbol] by assignment module 116 in the manner described above. Only test subjects S₁, S₂ and Sₘ are explicitly called out in FIG. 3F by their respective quantum states |S₁ [symbol] , |S₂ [symbol] , |Sₘ [symbol] for reasons of clarity. Since states |Sᵢ [symbol] formally stand in for subjects Sᵢ in the quantum representation adopted herein we may refer to them as either |Sᵢ [symbol] or Sᵢ in the subsequent discussion. The explicit marking denoting B-E consensus and F-D anti-consensus type have been dropped in favor of the corresponding visual designations (see FIG. 3D). Test subjects Sᵢ below a lower cut-off 300 are passed over.

Observer O with a scale value Wₒ much above an upper cut-off 302 has also been placed along scale parameter W. An observer quantum state |O [symbol] standing in for observer O is indicated in FIG. 3F. Of course, observer O falls beyond or outside the presumptive range of validity of the quantum representation that applies to states |Sᵢ [symbol] of test subjects Sᵢ whose scale values Wᵢ fall within range ΔW and hence are expected to definitely be within the range of validity. It is not presumed that observer state |O [symbol] contextualizes proposition 107 using any of the values that are adopted by subjects Sᵢ within range ΔW. More formally, this means that value matrices PRᵤ, PRᵥ, PR_{w} computed above (see Eqs. 16a-c) and applicable to subject states |Sᵢ [symbol] within range ΔW are not applicable to observer state |O [symbol] . Still differently put, observer state |O [symbol] is not expected to manifest a “collapse” or measurement when any of the three value matrices PRᵤ, PRᵥ, PR_{w} are applied to it.

According to the renormalization-related interpretation adopted herein, observer state |O [symbol] exists in a realm or range of scale parameter W where different rules apply. We interpret observer O to be beyond a phase transition. Thus, the phase that is valid within range ΔW does not apply to observer O. The phase transition may be interpreted as a second-order phase transition. Given the qualitative nature of the renormalization-related interpretation used herein, upper cut-off 302 is not strictly treated as the critical point. Rather, we presume that in the general vicinity of upper cut-off 302 there exists the second-order phase transition. Furthermore, given the nature of the present teachings and their application as tools, the location of any phase transition can be better localized by deploying the very quantum representation adopted herein.

The next important aspect of the situation depicted in FIG. 3F is the application of the value encoded by value matrix PRᵥ derived above. In general, subjects |Sᵢ [symbol] within range of validity of the quantum representation (i.e., within range ΔW) are free to contextualize underlying proposition 107 using any values they choose. This could be any one of the three value matrices PRᵤ, PRᵥ, PR_{w} already computed, or still some other value expressed with its correspondent value matrix. However, in the example of FIG. 3F subjects |Sᵢ [symbol] are limited by the environment or otherwise forced to contextualize proposition 107 using only value matrix PRᵥ. In practice, since v-basis stands for “style”, this means that subjects |Sᵢ [symbol] are forced to generate “YES” or “NO” measurable indications by contextualizing shoes 109a of proposition 107 in terms of “style” alone.

In the present case the choice of value matrix PRᵥ is enforced by observer O. Observer O, by virtue of their economic influence as expressed in dollars at Wₒ=$10,000,000 on scale W, is actually the ruler of the real world domain inhabited by subjects |Sᵢ [symbol] . For example, observer O is a despot, oligarch, dictator or some other type of authoritarian or autocratic ruler and the real world domain may be a small country, territory or fiefdom. Now, because observer O is outside the range of validity of the quantum representation for her subjects |Sᵢ [symbol] in range ΔW, she will typically not experience contextualizations of subjects |Sᵢ [symbol] using “style” as the value on which to base their judgment in the same way. In other words, observer O cannot relate or has lost touch with subjects |Sᵢ [symbol] in range ΔW. Still, observer O may always choose to look at propositions 107 about shoes 109a from a point of view that is analogous or reminiscent of “style” as understood by subjects |Sᵢ [symbol] in range ΔW. Observer O in their function as a ruler can now prescribe the value of “style” as understood by subjects |Sᵢ [symbol] in range ΔW as the de-facto politically correct way to contextualize propositions 107 about shoes 109a. At this point, the conditions for enforcing value matrix PRᵥ on subjects |Sᵢ [symbol] in range ΔW are met.

Enforcement of value matrix PRᵥ on subjects |Sᵢ [symbol] in range ΔW simplifies the quantum representation. We know that observer O is only interested in measurable indications “YES” and “NO” in the v-basis or, equivalently, in forcing the voluntary or involuntary usage of the value “style” expressed with value matrix PRᵥ for contextualizations by all subjects |Sᵢ [symbol] . Thus, rather than assigning estimates, assignment module 116 may proceed directly to assigning measured indications for all subjects |Sᵢ [symbol] picked in accordance with the expectations. This is most conveniently done using the standard expectation value equation for value matrix PRᵥ given the particular subject's state |Sᵢ [symbol] (see Eqs. 10a & 10b in the Background section).

This situation is depicted in FIG. 3G. We only show subjects Sᵢ that are within range ΔW (hence within the range of validity of the quantum representation). All subjects |Sᵢ [symbol] in FIG. 3G have been assigned measured states, which may be considered classical under certain conditions discussed below. These states are only either “UP” or “DOWN” along v, which is the ray we used to derive value matrix PRᵥ for “style”. “UP” states associated with measurable indication “YES”, these are “stylish shoes 109a” are represented by arrows pointing up along ray v. “DOWN” states associated with measurable indication “NO”, these are “not stylish shoes 109a” are represented by arrows pointing down along ray v. Given that observer O herself is not in the same phase as subjects |Sᵢ [symbol] in range ΔW, a broken arrow pointing both up and down along ray v is indicated for her state |O [symbol] .

It is noted that suppression of contextualizations of proposition 107 by subjects |Sᵢ [symbol] wishing to apply incompatible values as represented by quantum operators that do not commute with value matrix PRᵥ creates an unstable situation. The nature of the instability derives from the suppression by observer O of an otherwise permissible choice of value or values by subjects |Sᵢ [symbol] . The pressure that will manifest will tend to want to re-establish all possible values or a “democratic” approach to allowing subjects |Sᵢ [symbol] to adopt whatever value they wish to adopt in their contextualizations.

Meanwhile, to better visualize how the various subjects |Sᵢ [symbol] “align” with the accepted “style” contextualization of shoes 109a, FIG. 3G shows subjects |Sᵢ [symbol] re-arranged in accordance with their expectation value. The expectation value for each subject |Sᵢ [symbol] is computed as follows:

[symbol]

PRᵥ [symbol] _{S}_{ᵢ}= [symbol] Sᵢ|PRᵥ|Sᵢ [symbol] . Eq. 17

Based on standard conventions we normalize the expectation value from Eq. 17 to range between −1 and +1 of a v-axis. An expectation value of −1 stands for completely “NO” for “style” value. The value 0 stands for equal likelihood to choose “NO” or “YES” for “style” value. Finally, the value +1 stands for absolutely “YES” for “style” value.

To simplify, FIG. 3G shows subjects |Sᵢ [symbol] within range ΔW re-organized in accordance with expectation value. Of course, the positions of all subjects along scale parameter W do not change under this re-ordering. This step only applies adjusts the positions of subjects |Sᵢ [symbol] along the v-axis.

Subjects |Sᵢ [symbol] with a negative expectation value are indicated by a “DOWN” arrow denoting the “DOWN” eigenvector associating with “NO” for “style”. Subjects |Sᵢ [symbol] with a positive expectation value are shown by a “UP” arrow denoting the “UP” eigenvector associating with “YES” for “style”. There are no subjects |Sᵢ [symbol] with a zero expectation value. However, subject |S₁₃ [symbol] has a very small positive expectation value. Hence, the Bloch representation of subject |S₁₃ [symbol] is located close to zero along the v-axis.

Being close to zero in expectation value means that the actual quantum state |S₁₃ [symbol] was almost orthogonal to v. In other words, the eigenbasis or value matrix that subject |S₁₃ [symbol] was closest to choosing without coercion was almost entirely non-commuting with value matrix PRᵥ enforced by observer O. On the other hand, the remaining subjects |Sᵢ [symbol] were already more aligned with either the “UP” or “DOWN” eigenvectors of value matrix PRᵥ and are hence distributed further away from plane 304 passing through zero and orthogonal to the v-axis along scale W.

Using another renormalization-related concept, we designate plane 304 as an indication of a first order phase transition. Subjects that are close to plane 304 were assigned quantum states |Sᵢ [symbol] that were close to collapsing onto the other eigenvector and yielding the mutually exclusive measurable indication in contextualizing proposition 107. Clearly, the region close to plane 304 prior to measurement or automatic assignment of measured value according to the simplifying scheme adopted herein for visualization purposes is close to a transition. Thus, the community of test subjects |Sᵢ [symbol] will exhibit a tendency to opinion switching about whether shoes 109a are stylish or not when most are close to plane 304 (although one also needs to consider the formation and stability of domain walls to make any statements that are more than qualitative in nature). On the other hand, when most are far away from plane 304 then the opinions of the community about the stylishness of shoes 109a tend to be well settled.

FIG. 3G helps to visualize another important aspect of the quantum representation having to do with B-E consensus and F-D anti-consensus statistics. In region 306 are located two subjects |S₂₃ [symbol] and |S₂₇₃ [symbol] that are both F-D anti consensus type. They are not close enough to be competing for the same state. In terms of “spin”, this means that the spinors that form the physical underpinning of their quantum representation may be aligned. In fact, they are aligned along v-axis. The term not close enough to compete for the same state is qualitative at this point. If subjects |S₂₃ [symbol] and |S₂₇₃ [symbol] were on a graph (e.g., on the social graph) that were to be adopted in a quantum representation, then this statement would be interpreted to mean that these two subjects are not competing for the same vertex. In a less structured environment such as shown in FIG. 3G it is taken to mean that region 306 is relatively large. Thus, the subjects never approach each other close enough as defined by a convenient distance measure (e.g., mean free separation or other convenient concept from statistical or thermal physics) to be competing for the same state.

On the other hand, in region 308 are located two subjects |S₉₂ [symbol] and |S₁₁₇ [symbol] that are both F-D anti-consensus type that and are competing for the same state. Because of that, they have assumed opposite “spin” alignments. This would be the appropriate solution if region 308 were a vertex of a graph represented, e.g., by a Hubbard model or other convenient lattice. In other words, region 308 is too small for subjects |S₉₂ [symbol] , |S₁₁₇ [symbol] to “ignore” each other.

Under some circumstances a classical representation can be applied to the contextualizations. This representation is most conveninently deployed by assignment module 116 (see FIG. 2). Of course, in order to deploy a classical representation a number of conditions must be fulfilled. In fact, several are met by the example of the coerced contextualization deploying a single value for all subjects. That is because removing the natural degrees of freedom from the much larger realm covered by the quantum representation approaches the “collapsed” or measured representation that inhabits the real world described with real numbers (as opposed to imaginary-valued wave functions or state vectors).

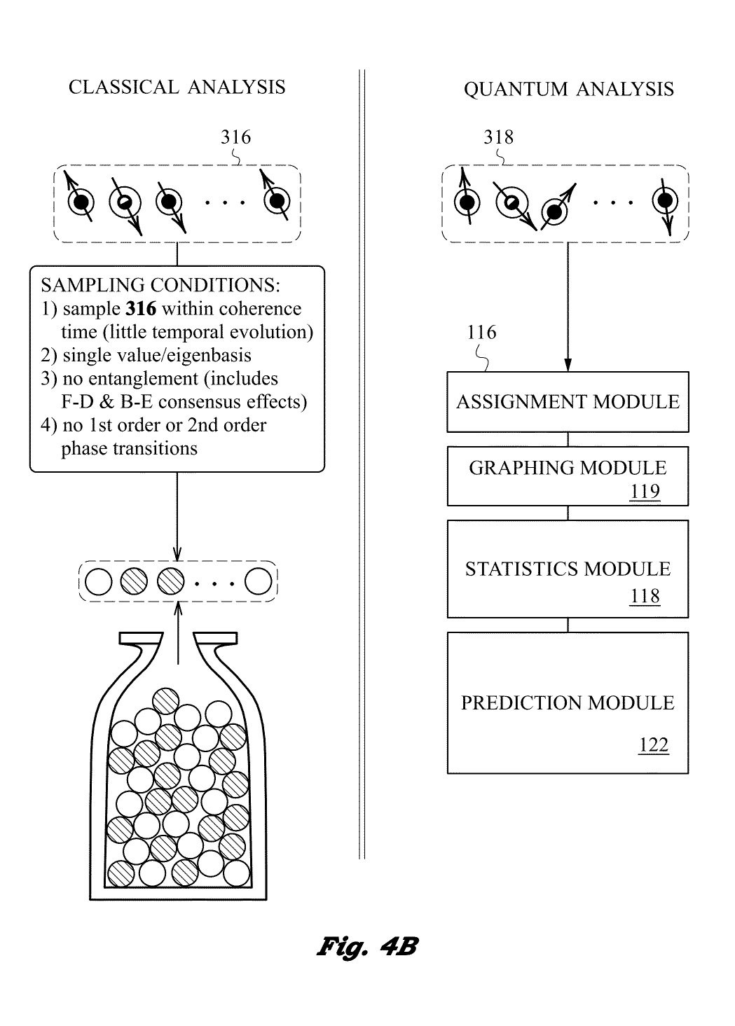

FIG. 4A illustrates a large number of test subjects |Sᵢ [symbol] organized along scale parameter W in a column 310 for purposes of better visualization. A certain number of test subjects |Sᵢ [symbol] are within a range ΔW that admits of a quantum representation according to the present invention. All test subjects |Sᵢ [symbol] that are within range ΔW and inside column 310 form a community. The community is aware of mutually understood contextualizations with respect to an underlying proposition about an item that the community members can readily apprehend. This means that in the context of the proposition they all inhabit the same community values space represented by correspondent quantum community state space [symbol] ^{(C)}.

Scale parameter W is logarithmic and denominated in a physical measure of test subjects |Sᵢ [symbol] selected from age, a physical ability, or a physical attribute. More specifically, W in this case is denominated in hours spent practicing the profession of applied mathematics. Underlying proposition 107 relates to technical book 109b selected from inventory 130 (see FIG. 3A). The values that are typically adopted by test subjects |Sᵢ [symbol] that admit of the quantum representation within its range of validity are: “educational”, “entertaining” and “noteworthy”. Subjects |Sᵢ [symbol] below a lower cut-off 312 equal to W=10,000 hours have insufficient amount of hours to have a worthwhile opinion. Subjects |Sᵢ [symbol] above upper cut-off 314 equal to W=20,000 hours have already formulated their opinions on a select number of books and typically do not review new books. Note the relative scarcity of subjects |Sᵢ [symbol] that have practiced the profession for much more than 75,000 hours due to obvious human lifespan and tolerance limitations.

Two contextualization samples are collected from among subjects |Sᵢ [symbol] in the community. A first sample 316 is collected under a coerced value of “noteworthy”. In other words, subjects |Sᵢ [symbol] in sample 316 are forced by the questionnaire or other means to only value book 109b as “noteworthy” with possible measurable indications of “YES” and “NO”. As a result, subjects |Sᵢ [symbol] in sample 316 shows alignment only corresponding to “YESes” and “NOs” in that value.

A second sample 318 is collected with no coercion. Subjects |Sᵢ [symbol] participating in sample 318 are allowed to adopt any value they choose in their contextualizations. Their measurable indications are contained in professional reviews they are allowed to write about book 109b. The only coercive factor is that they ultimately have to render a YES/NO judgment. As a result, sample 318 shows “YESes” and “NOs” but in many different eigenvalue bases (corresponding to the different value matrices not explicitly computed here). The consequence for sample 318 is the very marked lack of alignment between the different value axes.

We now turn to FIG. 4B to review how samples 316 and 318 are processed and when a classical representation of contextualizations is admissible. In the case of sample 316 a classical representation is allowed under four conditions on the sampling process. First, the contextualizations have to be measured within a time period that is significantly less than a decoherence time associated with the quantum represenatation of subjects |Sᵢ [symbol] . This means that the time period of sample collection is shorter than a typical time during which a normal professional practiced in the art of applied mathematics is observed to change their mind about a technical book, such as book 109b.

Second, the contextualizations are measured with the aid of the design of the questionnaire or collection method that enforces on sample 316 a single eigenvector basis. In the present case the single eigenvector basis that is coerced corresponds to contextualizations according to a single valuation criterion. All test subjects in sample 316 are forced to contextualize underlying proposition 107 about book 109a in the same way using the value “noteworthy”. This allows the “YESes” and “NOs” to be considered as measurable indications that are unambiguous in terms of their meaning to subjects |Sᵢ [symbol] of sample 316.

Third, test subjects |Sᵢ [symbol] do not exhibit any appreciable entanglement amongst themselves or with the environment. This condition means that there are no entangling interactions between subjects |Sᵢ [symbol] or between subjects |Sᵢ [symbol] and still other subjects outside those under consideration. Such entangling effects would affect measurements of subjects |Sᵢ [symbol] in sample 316. Standard tools available to those skilled in the art (e.g., testing for Bell states) should be deployed here to confirm that this third condition holds. It is noted that F-D anti-consensus as well as B-E consensus statistics are considered here as being a contributing factor to possible entanglement effects.

Fourth, when there should be no noticeable indication of a first order phase transition or a second order phase transition among test subjects |Sᵢ [symbol] . Presence of the first order phase transition has been discussed above in reference to FIG. 3G. It can be ascertained from expectation values or by any other methods known to those skilled in the art. Second order phase transition has also been discussed in reference to observer O in FIG. 3C and thereafter. There are also additional tools known to those skilled in the art for testing for the presence of a second order phase transition. Preferably, this task is devolved to renormalization module 117 (see FIG. 2).

In preferred embodiments, renormalization module 117 computes an n-point correlation function between test subjects |Sᵢ [symbol] in sample 316. Such functions are well known to those skilled in the art and they are frequently employed in the field of statistics. To be effective, the size of sample 316 should be large. Then, different orders of the n-point correlation function are used, starting with 2-point correlations between different pairs of test subjects |Sᵢ [symbol] from sample 316. When the n-point correlation function does not drop off to zero with increasing separation between test subjects |Sᵢ [symbol] and/or shows self-similar correlation patterns at different n values the application of the classical representation as well as of the quantum representation should be suspended. That is because this type of behavior of the n-point correlation function is an indicator of a second order phase transition.

It is also noted, that any known tool for testing for second order phase transition properties among the test subjects can be deployed in the methods and systems of the invention. Any tool will work best if there is some metric by which the separation between subjects |Sᵢ [symbol] of sample 316 can be ascertained. Starting with a social graph or some other indication of interconnections between subjects |Sᵢ [symbol] will be very helpful.

FIG. 4B also makes it clear why sample 318 requires a quantum representation and quantum analysis. Even though the measurable indications in sample 318 are also “YESes” and “NOs”, their meanings are different. Thus, reducing sample 318 to the typical sample of stable entities, such as balls of two stable colors representing “YES” and “NO” respectively is nonsensical. Instead, sample 318 has to be subjected to the quantum analysis by modules 116, 119, 118, 122 and others as introduced in FIG. 2 and also described in more detail in U.S. patent application Ser. No. 14/324,127. In the meantime, sample 316 can be processed, assuming that the four conditions hold, by standard machine learning and statistics tools to infer more about the larger community of subject |Sᵢ [symbol] from which sample 316 was drawn. It is duly noted that such classical methods, including inferences based on binomial expansions and the like have severe limitations. They can only teach about the larger community, e.g., the classical “bottle with black and white balls” to the extent that homogeneity and other overall quantum effects can be neglected altogether.

In view of the above we can also address the issue of noise. From the point of view of the quantum representation of the present invention, noise is caused by neglecting the presence of quantum effects while insisting on carrying out the classical analysis. One of the major sources of noise is thus a disregard for the fact that subjects |Sᵢ [symbol] are normally free to contextualize propositions using different values. The other quantum effects of decoherence, entanglement along with F-D and B-E statistics as well as phase transitions compound this problem.

In accordance with the invention, a classical representation, e.g., as presented in FIG. 4B using the concept of the bottle filled with balls having predetermined and unchanging colors, can be presented to an observer. Prior to the presentation, renormalization module 117 should compute an observer scale value Wₒ associated with the observer O that is to see the view. When observer scale value Wₒ is found within range ΔW then the classical representation can be presented to observer O in an unmodified form.

On the other hand, when observer scale value Wₒ is outside range ΔW then the classical representation is presented to the observer in a modified form. This is necessary because the observer does not himself/herself reside within the range of validity of the quantum representation and thus cannot be expected to personally understand the contextualizations experienced by test subjects |Sᵢ [symbol] . For this reason, distinctions between the colors of the balls have to be explained in the modification. This is particularly true when the distinct values experienced during contextualizations and apparent to test subjects |Sᵢ [symbol] are not at all apparent to observer O.

The most productive manner of modifying the classical view starts with collecting a statistically significant number of measurable indications from the contextualizations. In other words, assignment module 116 should work with large samples. This holds no matter if the type of sample collected resembles sample 316 reducible to a simple classical view or sample 318 that has to be treated under a quantum representation. In addition, it is useful to collect these large samples of measurable indications for contextualizations that use incompatible or almost incompatible values. In other words, for values that are represented by non-commuting Hermitian operators. Contextualizations under at least two such non-commuting values should be present in the sample and more for manifestly higher-dimensional situations.

In presenting the output of the classical representation a conflation or confusion of the measureable indications collected in incompatible bases should be constructed. Borrowing from the quantum formalism, when viewing a classical representation of a “particle” one is actually looking at a confusion of a large number of measurements in the “position basis” and a large number of measurements in the “momentum basis” under the presumption that these two types of measurements co-exist. Yet, these measurements correspond to observable effects or measurable indications from contextualizations in two different eigenbases (using two different values). We refer to this type of presentation or view as a confusion because the concepts of position and momentum do not co-exist. More strongly put, position and momentum (velocity) have no simultaneous reality according to the rules of quantum mechanics.

Still, a confusion of incompatible conceptions of position and momentum yields a useful picture or view of a localized particle with a defined momentum or velocity. This confused picture holds for Newtonian mechanics and in the realm of daily human experience. Of course, a closer inspection or proper quantum representation uncovers the confusion of a distributed wavepacket in position space and a distributed wavepacket in momentum space. The measurements yielding the wavepackets were precluded by physical law from being performed simultaneously (due to Heisenberg's Uncertainty Principle). In fact, as well known to those skilled in the art, the relationship between the position-space and momentum-space wavepackets for a typical free particle is that of a Fourier Transform; this relationship being another way to understand the contents of the Heisenberg Uncertainty Principle.

In tracking most contextualizations made by test subjects it will be difficult to know a priori all the available contextualizations. This will be true even when computer system 100 is given underlying proposition 107 and the item(s) 109 that it is about. Consequently, the space of possible contextualizations, which in the quantum representation corresponds to a Hilbert space of square-integrable functions, is preferably explored before commencing any tracking of contextualizations. This is preferably done regardless of whether the tracking is practiced for the purposes of predicting, simulating or any other purposes that tracking of the contextualizations may serve. The most appropriate tools for the exploration involve the use of commutator algebra between the different value matrices that are used during contextualizations by test subjects |Sᵢ [symbol] . Persons skilled in the art will be familiar with the corresponding mathematical conventions.

The exploration of the space of possible values, which may be considered a calibration, is most conveniently performed by statistics module 118. This module can use the commutators to estimate a degree of incompatibility between the contextualizations using different values. Furthermore, the exploration should be assisted and/or supervised by an expert curator. The curator should understand the space of possible contextualizations. In other words, the curator is or was himself/herself a test subject who has practiced many contextualizations and knows the different values. In the most recent example, an expert curator could be a former applied mathematics professor with 10,000 to 20,000 hours of professional work experience and well-versed in the field from attending numerous conferences and keeping in touch with a network of professional colleagues. Alternatively, the exploration can be entirely data-driven and mechanical. Most preferably, a combination of these two approaches is employed.

It will be evident to a person skilled in the art that the present invention admits of various other embodiments. Therefore, its scope should be judged by the claims and their legal equivalents.

1. A computer implemented method for determining when to apply a quantum representation of contextualizations of an underlying proposition by test subjects, said method comprising:
a) establishing by a scaling module a real scale parameter W;
b) computing with a renormalization module scale values Wᵢ associated with said test subjects; and
c) applying said quantum representation by an assignment module when a range ΔW of said scale values W₁ is within a range of validity of said quantum representation.

2. The computer implemented method of claim 1, further comprising:
a) computing with said renormalization module an n-point correlation function between said test subjects;
b) suspending the application of said quantum representation by said assignment module when said n-point correlation function indicates a second order phase transition.

3. The computer implemented method of claim 1, further comprising applying a classical representation to said contextualizations by said assignment module when:
a) said contextualizations have been measured within a period substantially less than a decoherence time;
b) said contextualizations have been measured substantially in a single eigenvector basis;
c) said test subjects exhibit substantially no inter test subject entanglement and substantially no test subject to environment entanglement; and
d) substantially no indication of first order phase transition and substantially no indication of second order phase transition is found among said test subjects.

4. The computer implemented method of claim 1, further comprising presenting a view of said contextualizations to an observer.

5. The computer implemented method of claim 4, further comprising:
a) computing with said renormalization module an observer scale value Wₒ associated with said observer; and
b) presenting said view to said observer unmodified when said observer scale value Wₒ is within said range ΔW.

6. The computer implemented method of claim 4, further comprising:
a) computing with said renormalization module an observer scale value Wₒ associated with said observer; and
b) presenting said view to said observer modified when said observer scale value Wₒ is outside said range ΔW.

7. The computer implemented method of claim 1, further comprising applying a classical representation to said contextualizations by said assignment module by:
a) collecting a statistically significant number of measurable indications of said contextualizations in two incompatible eigenvector bases; and
b) presenting a confusion of said measurable indications in said classical representation.

8. The computer implemented method of claim 1, wherein said contextualizations of said underlying proposition are determined by an assignment module and comprise at least two different eigenvector bases corresponding to at least two of said contextualizations and expressing test subject states |Sᵢ [symbol] modulo said underlying proposition.

9. The computer implemented method of claim 8, wherein said at least two different eigenvector bases are expressed by at least two different value matrices PRⱼ that represent quantum mechanical operators applicable to said test subject states |Sᵢ [symbol] to yield eigenvalues λₖ associated with measurable indications modulo said underlying proposition exhibited by said test subjects.

10. The computer implemented method of claim 9, wherein said at least two different eigenvector bases are selected to be orthogonal such that said quantum mechanical operators are non-commuting and said measurable indications are incompatible.

11. The computer implemented method of claim 1, wherein said real scale parameter W is a classically stable quantity existing independently of said contextualizations of said underlying proposition by said test subjects.

12. The computer implemented method of claim 11, wherein said classically stable quantity is a social measure accepted by said test subjects.

13. The computer implemented method of claim 12, wherein said social measure is selected from the group consisting of social influence, social trust, social power, social status, social significance, religious influence, academic standing, demographic status, economic influence.

14. The computer implemented method of claim 11, wherein said classically stable quantity is a physical measure selected from the group consisting of age, a physical ability, a physical attribute.

15. The computer implemented method of claim 1, wherein said underlying proposition is about one or more items selected from the group consisting of a commonly perceived object, a commonly perceived subject, a commonly perceived experience.

16. The computer implemented method of claim 1, further comprising estimating by a statistics module a degree of incompatibility between said contextualizations.

17. The computer implemented method of claim 1, further comprising the step of determining with a mapping module a subset of said test subjects belonging to a community sharing a community values space modulo said underlying proposition, said community values space being represented in said quantum representation by a community state space [symbol] ^{(C)}.

18. The computer implemented method of claim 17, further comprising determining with said assignment module a set of eigenvector bases deployed by said community in said community state space [symbol] ^{(C)} modulo said underlying proposition.

19. A computer system capable of applying a quantum representation of contextualizations of an underlying proposition as perceived by test subjects, said computer system comprising:
a) an assignment module for determining eigenvector bases corresponding to said contextualizations and for representing test subject states |Sᵢ [symbol] in decompositions over said eigenvector bases;
b) a scaling module for establishing a real scale parameter W;
c) a renormalization module for computing scale values Wᵢ associated with said test subjects;
wherein said assignment module applies said quantum representation when a range ΔW of said scale values is within a range of validity of said quantum representation.

20. The computer system of claim 19, wherein said test subjects are sentient beings.

21. The computer system of claim 20, wherein said real scale parameter W is a physical measure of said test subjects selected from the group consisting of age, a physical ability, a physical attribute.

22. The computer system of claim 20, wherein said real scale parameter W is a social measure accepted by said test subjects.

23. The computer system of claim 22, wherein said social measure is selected from the group consisting of social influence, social trust, social power, social status, social significance, religious influence, demographic, economic influence.
